(19) United States
(12) Patent Application Publication
(10) Pub. No.: US 2026/0138838 A1
(43) Pub. Date: May 21, 2026

(54) SYSTEM FOR CARGO TRANSPORT

(71) Applicant: Trevor Pan, Tempe, AZ (US)

(72) Inventor: Trevor Pan, Tempe, AZ (US)

(21) Appl. No.: 19/037,474

(22) PCT Filed: Jul. 29, 2022
(86) PCT No.: PCT/US2022/038954

§ 371 Date: Feb. 28, 2025

(51) Int. Cl. B65G 63/00; B65G 1/04; B65G 67/04; B65G 67/60

(52) U.S. Cl. CPC B65G 63/004; B65G 1/04; B65G 67/04; B65G 67/603; B65G 2814/0397

(57) ABSTRACT

A system for cargo transport in the field of intermodal logistics aims to solve supply chain-related disruptions experienced during the Covid-19 pandemic. Cargo frame cargo ships (24), cargo frame barges (26), cargo frame docks (20), 3-axis structures, and 3-axis hoists (10) utilize a cargo frame to bundle series 1 freight containers, vehicles, dry-bulk, wet-bulk, and other general cargoes in a stackable, modular manner. Purpose-built 3-axis structures increase the footprint of ports where cargo frames are stacked, stored, and retrieved. Semi-truck queueing towers (22), and freight car transshipment yards (34) allow for timely coordination of cargo transfer at a multi-level port (48), increasing the throughput of intermodal cargoes.

### TECHNICAL FIELD

My present disclosure is directed to a system for cargo transport in the field of intermodal logistics.

### BACKGROUND ART

### Ports:

The current state of cargo transport relies heavily on container shipping for finished and semi-finished goods using purpose-built container ships. Feeder ships, general cargo vessels, tankers, dry-bulk carriers, multi-purpose vessels, reefer ships, and roll-on/roll-off vessels also play vital roles for their respective cargoes.

Ports receiving cargo ships have massive cranes that generally lift containers one or two at a time from the starboard side of a ship. Some of the largest cargo ships have a capacity of 20,000 TEU (twenty-foot long container equivalents).
It takes 3,000 people working three days in shifts around the clock to load and unload a giant ship with capacity for 20,000 containers when it stops at one of the world's biggest ports. (Wall Street Journal, 2018)

Ports receiving tankers, dry-bulk carriers, reefer ships, and roll-on, roll off vessels require special equipment enabling loading and unloading of their respective cargoes.

Though tankers can pump and fill their holds at a rate of 75,000 gallons per minute, they must sit at dock for eight to nine hours. Similarly, dry-bulk carriers use conveyor belts, buckets, and in some cases, lower bulldozers into the hold to move material around. These processes are inherently dangerous as overloading one side or area of the ship causes stress points. Ships have split in two at-dock, as well as capsized due to uneven loading or unloading.

Due to the Covid-19 pandemic and related disruptions, extensive backlogs currently plague the world's busiest ports with scores of ships waiting to be loaded or unloaded.
A typical Panamax containership call requires about 1.7 hectares of yard space, assuming the use of standard rubber-tired gantry cranes, enabling a stacking density of 1,000 TEU per hectare. Larger ports tend to have higher stacking density with equipment such as rail-mounted gantry cranes (1,500-2,000 TEU per hectare), requiring less yard space. Smaller ports have less equipment and lower stacking density levels (500 TEU per hectare or less). (Notteboom, 2022)

What stands out to me during the pandemic is the apparent lack of coordination in the transfer of goods. Yes, products do get to where they are going, but at what cost? If ships carrying billions of dollars of goods sit at sea for three to four weeks, they lose at least one Asian/North American route each time this occurs. That is an unbelievable amount of lost revenue for the shipping lines. This can have no small influence on the inflation the world is experiencing in 2022.

The imbalance of trade also causes insurmountable issues when timely trade routes are considered.
U.S. goods and services trade with China totaled an estimated $615.2 billion in 2020. Exports were $164.9 billion; imports were $450.4 billion. The U.S. goods and services trade deficit with China was $285.5 billion in 2020.” (Office of the United States Trade Representative, 2021)

With a trade deficit of $285.5 billion, one can imagine that there are a lot of empty containers which must be returned to China—and of course, empty containers are not as valuable as filled ones. During the pandemic, ships returned to Asia without empty containers, further causing snags in supply chain deliveries and cost increases.

However, trade deficits are not wholly to blame. The basic design of the United States' ports is flawed. The basic design of the world's ports is flawed. As the Port Economics, Management and Policy book points out above, ports simply cannot hold that many containers, causing them to be held inland where they are not handy when a ship could take them.

As we will see below, not only is the basic design of the world's ports flawed, the means, methods, and apparatus used in conveying freight are flawed as well.

WE have entered an era where the equipment of old will not absorb the pressure of modern commerce.

### Cranes, Barges & Ships:

Cargo container ships have grown to larger and larger sizes over the past seven decades, 80 starting with a modified World War II oil tanker named the “Ideal-X” by Malcom Mclean. The Ideal-X carried 58 containers on its maiden voyage (approximately 116 TEU-Mclean's containers were 35′ long, not 40′ as are modern series 1 freight containers). Compare that to the Ever Ace, built in 2021, which carries 23,992 TEU!

### Astonishing.

The current state of the art utilizes gantry cranes. These cranes are mounted port-side and roll on rails, which enable the crane to reach every spot on a ship. A spreader is lowered down to the ship and can retrieve up to two series 1 freight containers per pick. These are then lowered for a longshoreman to remove twist locks at the base of the containers. This is highly dangerous and repetitive work. The containers may be placed on wheeled carts, trucks, or placed for later retrieval.

Some military cargo ships such as the USNS Shughart (T-AKR-295) have two 110-ton on-board cranes, port, and starboard ramps and a stern ramp. These logistic maneuvers are limited physically to the loading and unloading cycle of the cranes at sea. Certainly, the faster cargoes can be exchanged the greater the chances for survivability of the cargoes and two interchanging ships.

To install and maintain oil rigs and wind turbines, double platform cranes on a barge slink up elongated columns like an inch-worm. This works well for this purpose but is not useful in large cargo transfers at sea.

The roll-on, roll-off features of purpose-built ships require a dock and are limited to the width of the door for vehicles and the speed they may enter or exit the ship. The height of each floor on the ship is generally higher than many of the vehicles and remains inefficient as a transport volume.

What an absolute waste—every trip.

What has grabbed my attention is that the focus of ship design has been primarily on larger ships, engine efficiency, greater carrying capacity, and large port side cranes. It appears very little thought has been placed on loading and removing the containers in an exacting, coordinated manner.

If a ship grows in length, it appears that ports simply add a new crane. Ship designers do not design new ways of loading or unloading cargo. I did find some prior art below which addressed this issue, but from all accounts that I can see, starboard encargoing and decargoing prevails.

Dry-bulk carriers have large hatches, whereby the seal degrades over time. Degraded seals have caused ships to fill with seawater and subsequently sink. Extensive cleaning processes need to be carried out at each stop, further adding to the time a dry-bulk carrier is in port.

Given the cost of these port-side dry-bulk operations, ship owners lose many sea-going hours at port without improving the loading and unloading capabilities (other than to use a “bigger” bucket, a “larger” conveyor belt, and similar efficiency tactics).

Dry-bulk ships have another disadvantage. They mostly return empty.
First, satellite data of ships' movements reveal that most countries are either large net importers or large net exporters and that, related to this, at any point in time a staggering 42% of ships are traveling without cargo (termed “ballast”). This natural trade imbalance is a key driver of trade costs. (Brancaccio, 2018)

That is a tough pill to swallow. While the design of the dry-bulk ship is an asset, it is also a liability.

What these ship designs lack is fundamental reimagination.

Fueling adds considerably to port-side turnaround time. With a capacity of 18,000 TEU, the CMA CGM Benjamin Franklin carries approximately 4.5 million gallons of fuel oil. Careful attention must be paid to bunkering a ship. The transfer of fuel is carried out with large hoses that humans can carry. The speed of this fuel transfer is limited to the speed of the pump and the diameter of the hose.

Series 1 freight containers are tied down on the deck with twist locks at the bottom corner castings and with lashing rods. Lashing rods provide necessary lateral bracing from port to starboard side of ships and vice versa. Without lashing, the containers could not safely be stacked as high as currently practiced.

Lashing rods are remarkably dangerous for stevedores. They are strewn about the lashing bridge in pits and are loose. I can only imagine the number of twisted ankles, falls, and worse caused by these loose devices. Because the rods are not tied to anything, they must be lifted high above the head to secure the loads which provide great risk on a daily basis. Rods can miss the corner casting or slip in someone's glove and fall.

Falling 16-foot steel rods 1 inch thick will put a dent in your day!

It is amazing to me how haphazard the lashing bridge is when docked in port.
Lashing is the cause of over 60% of injuries for cargo handlers. (YouTube, 2020)

Yet for some reason, OSHA has not addressed this in the United States. The United States Coast Guard Regulation: Cargo Securing Manual does not have a section on 165 lashing rods.

My sense is that, like many industries, governance can only be as good as the tools available. With that in mind, it does not appear the maritime industry recognizes this danger; the maritime industry has not invented a solution to the problem.

### Trains:

In terms of productivity, freight trains have remained largely unchanged during the same period which began with the series 1 freight container. Malcom Mclean again made improvements in the intermodal shipping industry with a collaboration with Southern Pacific Railroad in 1977, leading to what became known as the “well” car or a double-stacked intermodal train car. (TR News, 2006)

### Series 1 Freight Containers:

Malcom McClean revolutionized global trade when he introduced the shipping container. The innovation was not immediately adopted, but in 1968, twelve years after he introduced the container, an international standard was finally agreed upon. It was known as an ISO 668—series 1 freight container.

They cannot continue to be stacked, as they eventually crush the bottom containers.
The latest generation of mega vessels can load 11-12 tiers of containers under deck. You can extend this but then you start to run into problems that were discovered when Nedlloyd built hatches vessels in the 1990's. No longer were the stowage planners limited by the stack weight limit that the vessel could handle, the limiting factor became the amount of weight that the container at the bottom of the stack could support. (Bebbington, 2017)

PRIOR ART CITED (where reference signs are shown in this section they pertain to that patent or patent application) Cargo Frames in Detail:

U.S. Pat. No. 9,637,305 B2 contemplates specially designed cargo containers which interlock at the sides and corners, depending on the embodiment. It is a clever system but is not capable of interlocking large items as it is restricted to a common forklift for maneuverability.

WO 2011/094835 A1 contemplates a fastening assembly, which connects containers with convenient pins. The pins allow for use in frigid temperatures.

It is not clear from the disclosure how the containers are moved. For example, there are 210 no slots for a forklift or similar movement machine. There are no wheels. It appears that once the containers are connected, they do not move.

US 2021/0380339 A1/US 2021/0339943 A1 utilizes series 1 freight containers as a small, mobile warehouses. The interior of the series 1 freight container has an orthogonal grid of columns, allowing a retrieving device to lower small boxes of goods in the slots created by these columns.

A considerable amount of space is wasted at the top of the columns as the retrieving device rolls atop the columns.

The series 1 freight containers can be aligned next to each other to allow a greater area to be covered. In effect, this allows say four containers side-by-side to create a 40′ x 36′ area for storage.

Given that the z-axis tolerance is 1/10 of a millimeter, it is not clear how such crude pins, which align the containers, will enable that tolerance. However, there are corner height adjusters. Given the tolerances, it appears to me that a single container is more practical.

The invention seems predisposed to items that can fit into boxes and then moved by hand, as opposed to large cargoes such as a series 1 freight container itself.

U.S. Pat. No. 9,359,129 B1 is an automated twist lock device that reduces wear and tear with a unique pin system. The device is a certain improvement over prior art twist lock 235 versions.

It does not appear to allow two series 1 freight containers to be lifted together.

This means lifting two series 1 freight containers that are connected by the device is not 240 possible because of its tension release mechanism. The applicant did not appear to desire lifting more containers in one action.

VS & B Containers Group's (https://www.vsnb.com/container-twist-lock) array of Standard Intermediate Twist Lock, Semi-automatic Twist Lock, and Fully Automatic Twist lock have served the intermodal shipping industry for many years. They are trusted, standard devices and have been around since the 1960's. VS&B have several flavors as alluded to in the previous patent: manual, semi-manual, and automatic. These devices are the backbone of the maritime series 1 freight container trade. When things work, they just work.

What they don't do is allow multiple containers to be bound together when being lifted to or from a crane. They are not designed for much other than keeping series 1 freight containers tied down on deck during maritime transit, trucking transit, or rail transit.

Additionally, they do not provide lateral bracing. This is why lashing rods are so prominent on a cargo ship.

U.S. Pat. No. 4,599,829 is a unique building system utilizing series 1 freight containers. The patent primary embodiment focuses on a correctional facility or prison, as well as an apartment-type building embodiment.

What remains pertinent here are the connectors in which the containers are held together horizontally and vertically. While the connectors will level and stabilize the containers as a building structure, they are not intended for movement in trade.

U.S. Pat. No. 6,363,586 B1 provides a kit for connecting two 20-foot series 1 freight containers so that they may be moved as a larger 40-foot series 1 freight containers. The kit binds two ends of the smaller containers together at the corners and provides a spacer, allowing the bound containers to match the 40-foot container in length.

While this does provide a reduction of steps when encargoing or decargoing a ship where 20-foot series 1 freight containers are employed, it does not reduce steps for 40-foot 12.

The other major disadvantage of this kit is that it does not address lateral loads caused by winds or wave ocean which could topple stacked containers. This is clearly not a part of the invention.

CN 112027378 A provides for a foldable container-sized frame. This type of apparatus is well-trodden in the prior art where tanks and other cargoes must be accommodated. While it would expand the types of cargoes it could contain since the frame could be built around, it the concept does not improve the rate at which ships, ports, and trucks can encargo or decargo.

DE 2154274 A1 utilizes a strap-based connection means and purpose-built recessed grooves in plastic barrels that form a battery, enabling many barrels to be bound together. A further object of the recessed grooves and connection means is to enable battery lines to be linked without the barrels moving or the strap protruding. In one embodiment, pipes with bolted connections ensure the straps do not deform.

The connection means is not meant to enable large scale movements.

U.S. Pat. No. 6,276,550 B1 is a unique stacking system of storage boxes whose interlocking castellated edges are wholly formed and create larger aggregated storage units. The invention primarily aims to solve stacking compact discs for music and movies. At this point in time, the use is moot, but the system is still useful for other things.

While the interlocking nature is novel, the application is for standstill storage and not useful in the movements of cargoes.

### Cargo Hoist in Detail:

U.S. Pat. No. 11,272,984 is a newly minted patent which provides a storage and retrieval system 305 of racks for cargo containers. The patent does specifically point out series 1 freight containers.

While the general principle is compelling considering that the apparatus is intended for use in a warehouse, an extraordinary amount of space is dedicated to the hoist. For example, the lift is as long as a shipping container. At eight feet plus structure on both sides, the hoist could take up as much as 12 feet and is as long as the racks. At eight feet plus rack structure, the racks could easily be 10 feet deep.

If the warehouse was one acre in plan view (208.7 feet×208.7 feet=43,560 square 315 feet), then:

208.7feet/22feet=9.48rows per acre

12feet(hoist)/10feet(racks)=1.2times more space is allotted to the hoist than the racks for storage

43,560square feet/1.2=36,300square feet is dedicated to hoists

It is not an efficient apparatus.

The racks are claimed to hold containers in only at the corners. Looking at their corner supports 5, in a seismic event, the containers can be thrown off the corner supports 5, fall, and become stuck or worse.

The inventors never considered seismic events. By nature of focusing on a warehoused apparatus, wind constraints were never considered.

U.S. Pat. No. 10,913,641 B1 is an ecommerce fulfillment center three-dimensional rack, storage and retrieval system. The retrieval robot occupies a vertical column and may rotate a retrieval arm to one of four adjacent slots in adjacent vertical columns.

Because the retrieval robot must vertically traverse a column to store or retrieve storage units 16 entire columns are left unusable.

WO 2021148657 is an application for a storage and retrieval system for ecommerce sized items, not large items such as series 1 freight containers. The system utilizes a set of orthogonally arranged racks that form vertical columns. There does not appear to be positions in the y-axis wherein a container may be stationed and independently supported.

The containers of items are stored vertically and retrieved vertically. The application does not state how high the containers may be stacked before the weight of the column crushes the lowest or lower containers.

These limitations prevent the system from reaching heights beyond what weight the individual container may bear. If a container is at the second position from the warehouse floor and the column is full of containers, then all containers above the second position would need to be removed.

This is clearly inefficient.

U.S. Pat. No. 5,707,199 presents a multi-level storage and retrieval structure for shipping containers or vehicles. While the displacing module 32 provides X and Y axis movements, vertical movements are confined to the elevating members 20. This means that vertical lifting does not happen in the field area of the structure.

Because of this, the elevating members 20 are not usable for storage. In my view, this is a waste of structure.

EP 0898033 B1 is a multi-level elevator and display for the smart car. I have never seen one, but more recently the Carvana concept seems to borrow heavily from this 365 arrangement.

Like many of the other aforementioned hoists, the central column for y-axis movements is not a storage-capable volume of space.

A turntable is used to spin a car around to the appropriate location and a telescoping apparatus moves the car to position on a load carrier 7.

U.S. Pat. No. 7,729,797 B2 provides a storage and retrieval system of vertically disposed racks oriented in an orthogonal pattern, such that the stored items appear in a grid-like pattern.

The method allows for correcting vertical and horizontal distances where a hoisting device 9 may reach a destination storage location.

Like the other patents cited with a storage and retrieval system, this one requires that floor plan space be dedicated to the hoist. Large amounts of space are lost to the 380 necessary function.

U.S. Pat. No. 10,596,229 B2 stores and retrieves biological test tubes with a unique two-carriage system. The two carriages traverse in the z direction and are able to separate to the x and y directions in order to store or retrieve test tubes at a specific location.

The carriages utilize rack and pinion and a series of covered bearings to reduce contamination of test tube material. One issue I see with the carriages as designed is that they can become long and stretched out, which means the storage is not being conducted in as an efficient a manner as is possible.

While the carriage is highly specific to clean work, like the other storage and retrieval devices, an entire column is dedicated to the z-axis. The z-axis portion of the apparatus appears to be entirely separate from the racks which does not take advantage of the structure already built. In essence, they built a structure for the racks, and then another structure for storage and retrieval. It seems like they could have utilized the structure better to reduce redundancy. I did not find a specific reason for redundancy.

US20220041374 A1 presents a storage and retrieval system built around a set of orthogonal racks. The loading good lifting device 13a provides movement of goods in a singular direction. Only bays adjacent to either side of the rollers are enabled for storage and retrieval.

I was not able to ascertain what moves the goods from the rollers to the racks.

Like the other hoists mentioned, valuable floor plan space is allotted to vertical lifting and not capable of being used as storage.

U.S. Pat. No. 10,926,950 B2 is a telescopically driven storage and retrieval system in a high bay warehouse. The products intended to be stored are things that a human being could pick up. Notably, the inventor says in reference to a toothed belt 232 and toothed rack 211, “Therefore, comparatively high force transmission is allowed without any damage to the toothed belt 232 or the toothed rack 211 occurring. It is thus possible for even comparatively heavy storage items 4 such as components to be moved by means of the telescopic drive 2.”

By the inventor's own admission, this device is not suitable for industrial loading.

U.S. Pat. No. 9,181,067 B1 is a charming little patent. Represented by the Secretary of the Army, this cargo lifting device is coupled with wind deflecting members that aid in stabilizing the cargo when being transported by crane or helicopter in high wind conditions.

While the patent does not specifically state series 1 freight container, the drawings do depict perhaps a 10-foot or 20-foot container of that type.

The device is designed to lift one cargo at a time and does not appear capable of binding more than one cargo together.

U.S. Pat. No. 2,456,104 is a creative gantry-type crane mounted on a ship nearly 75 years ago. This crane has two runways 3, or rails, that enable the gantry to roll lengthwise with the ship and encargo or decargo to adjacent ships or piers.

To reduce wind drag, bad sight lines and more, the crane pivots in its center and lowers itself in opposite directions on the runways so that the crane may be laid down on the deck.

While the crane certainly takes up a lot of space and can be quite useful at sea, it is not fundamentally faster or more productive than a port-side gantry crane.

https://morallift.en.made-in-china.com/product/dMZQpyYPfjak/China-Vertical-3-Axis-Movement-Man-Lift.html is selling a 3-axis lift useful for painting and other 440 related labor tasks. The apparatus runs on a rail along a wall. It is mounted at the floor and upper portion of the wall, enabling the user to traverse the wall and expand out away from the wall.

It could be useful in painting boats, aircraft, cars and other things, where a regular ladder would not provide useful results. While this apparatus would not be useful for storing and retrieving heavy items, it certainly has its place.

### Cranes, Barges & Ships in Detail:

U.S. Pat. No. 9,359,047 utilizes a dual platform barge with cranes which enable the vessel to raise or lower the cranes and working areas for tall structures at sea. It is primarily a construction or maintenance platform and not designed to add or remove cargoes from a vessel.

WO 2014015385 contemplates a new ship design with ship mounted gantry cranes, three moveable decks, a ballast control system and rail access. There are no fundamentally new aspects to this arrangement.

Considerable effort is spent balancing the ship with the extreme loads contemplated from rail access at the loading ramp.

The inventor writes, “The ship may comprise a ballast control system for adjusting the height of the first deck relative to the waterline and/or for adjusting the ship's trim to cater for load imbalance within the hold. The ballast control system may be adapted to adjust the waterline of the ship to maintain the gradient of the loading ramp, when deployed, to be less than +15 degrees from horizontal.”

The movable gantries are interesting but as designed, they are tied up with the access 470 points of the rail. It is not clear if the ship mounted cranes would fundamentally lessen port side time.

The patent was never granted.

U.S. Pat. No. 10,308,327 is designed to retrieve horizontally laid caissons or foundations (monopiles) from a deck and jack them up slowly utilizing one or more raising platforms and a crane. The invention aims to prevent a caisson slipping into the sea or hit one of the vessels and swing in an out-of-control manner.

Dynamic positioning systems and spud poles with a jack-up platform achieve stabilization of the lifting vessel.

WO 2001054968 is a floating pontoon-supported crane. While this seems like it would work to lift items at sea the patent was not granted.

U.S. Pat. No. 5,832,856 provides a monohull fast ship equipped with rail pairs running parallel to the centerline. These rail pairs enable loading rail cars quickly onto the cargo decks. The rail pairs have a single-entry point and do not differ much from a railroad track in that they can only carry one car at a time.

In U.S. Pat. No. 6,537,009 the patentee has created a vessel with an adjustable bridge and gantry crane-like hoist. The loading of cargoes is limited to the stern of the ship. While the patent claims to balance the vessel while loading or unloading, it is not clear from the specification that the bridge would accomplish this, especially from a ship-to-ship transfer as waves could volley the interconnected vessels up and down.

The adjustable cell guides for a container ship in CN 107776829 A & CN 207617921 U allow for 20 TEU, 40 TEU, and 45 TEU containers. An adjustable flap-like device allows the longer container to be accepted onto the ship's hold. This makes the ship more flexible in the containers it can handle, but it does not speed up the rate of cargo loading and unloading.

In CN 113525601 A a telescopic guide rail system forms a new cell guide. The system enables multiple sized shipping containers to be utilized in the cargo hold.

From my assessment of the drawings (which are hard to understand), it appears substantial amounts of space will be lost in the transverse bulkhead to allow for the telescopic guide rails to push in or out as required by differing-sized cargoes.

It seems like a ship dedicated to the odd-sized cargo container would make more sense.

In CN 108466676 A the same applicant sought a different arrangement of twist locks capable of holding down the containers. However, like the aforementioned system, a fair amount of space can be lost to the smaller container.

Again, it seems like a ship dedicated to the odd sized cargo container would make more sense.

While I can appreciate that the aim of US 2006/0104748 A1 is to increase the productivity of port side operations, there is nothing substantially new about this apparatus or method for doing so. Adding more prior art cranes on both sides of a ship is not invention.

U.S. Pat. No. 7,665,945 adds to the art and is commendable for offloading cargoes from a ship directly into a warehouse.

The disadvantage is that the apparatus only handles one container per movement action. While distinct from a gantry crane in removing a number of steps to load a warehouse, it is not wholly transformative. It is not clear how many containers could be stacked in a warehouse.

U.S. Pat. No. 7,686,558 is rather hard to fully understand. There are tracks and a rotating means which allow cargo containers to be removed from a ship and rotated. Supposedly rotating in long perpendicular lanes is desirable.

I fail to see how this helps loading the containers onto trucks in a substantially more efficient manner.

The transportation carrier has a larger floor plan area than the series 1 freight container would not be space-saving. This prevents the transportation carrier from being utilized for anything other than a transportation carrier.

CN 111252693A is an exterior elevator mounted to a ship side. The lift device allows for adjusting the height of the platform to meet any loads desired.

I am not sure it is fundamentally more useful than a crane.

The aerodynamic drag caused by the protruding elevator will be substantial on the vessel at sea.

US 2008/0213067 A1 is a system for cargo transfer at a port. The inventor has the right idea of improving efficiency. The idea is marred in that while moving containers to another smaller boat may enable more containers to be unloaded at their eventual mooring locations, they are still removed from the ships or barges from a conventional gantry crane.

The gantry crane is limited to two containers per action.

This does not fundamentally improve the encargoing or decargoing of ships.

Likewise, the rail-driven cranes in the port yard only move a container at a time. The idea has the right seed but not the inspiration to transform a port as the inventor intended.

The application was not granted letters patent.

WO 2022/069087 A1 is a vertical lift hoist on wheels made for inserting containers and cargoes into a side or mission bay of a ship. Floor-mounted twist locks limit how far the cargoes may enter the hold because there are no further tracks or means to put more than a few containers at the mission bay.

The device requires a stable quay and does not seem suitable for encargoing or decargoing at sea.

U.S. Pat. No. 7,004,707 B2 is a bulk charging and discharging conveyor and elevator that enables cargoes to be lifted into a hold. The apparatus allows for operation during the rain. While it is a unique application it seems to only moderately improve the ability to fill a cargo hold. It seems to contemplate only one elevator and one transport path.

A quick internet search shows that the company no longer has a web presence. It does not appear to have been a commercially successful patent.

U.S. Pat. No. 8,523,490 B2 is an interesting temporary platform which can clip on to at-sea structures, enabling maintenance and construction without a specialized ship at sea.

While it does have great utility on at-sea structures, it is not made to be a high-volume cargo transfer apparatus.

### SUMMARY

### Technical Problem

It's important to address the global supply chain and intermodal trade in a broader sense than described above.

There is an underlying problem causing lack of truckers, trucks, and intermodal chassis at the Port of Los Angeles.

There is an underlying problem causing one-hundred ships to wait for berthing at the Port of Los Angeles.

There is an underlying problem causing Berkshire Hathaway to ask BNSF Railroad to keep containers at the Port of Los Angeles longer than usual so that the Chicago transit hub can clear.

https://www.reuters.com/business/autos-transportation/railroad-cargo-backups-threaten-new-logjam-los-angeles-port-chief-2022-07-13/

I am listing American companies because I am an American and read about these happenings in the business papers daily. However, I have also read the same issues are experienced in varying degrees in Europe, Asia, and beyond. For that, I hope not to smash the toes of those who work at the companies listed, but simply use these pertinent examples to illustrate the broader technical problem this disclosure solves.

If the problems affect the largest companies and organizations in the world in the intermodal logistics industries, then it is fair to state these issues are not unique.

My own friend who recently drove an intermodal route for the logistics company Schneider spoke of having nowhere to park at the Port of Los Angeles. He was often by the port to come back later, causing him to drive an hour and a half or more to find a parking space. This is extremely frustrating and does not keep_consumer prices down. Instead, it raises prices because Schneider and others must put out that money for gas and hotels. They must also deal with upset employees who often are not paid during these lull periods, increasing the likelihood of strikes and other disruptions.

How could any reasonable person disagree with truck driving professionals who must do this?

This is not exclusive to truck logistics companies; it has to do with the fundamental design of the Port of Los Angeles itself.

It is not efficient.

https://kentico.portoflosangeles.org/getmedia/07e1377d-b452-4ecb-a629-9a0c69410805/pola-facilities-map

There are no large semi-truck queuing areas that would allow truckers like my friend to pass a few hours while cargoes are retrieved from ships. Instead, truck driving professionals must suffer the indignity of leaving the port only to be called at a later time.

After reviewing the map above, there is no room for large semi-truck queuing areas.

Neighbor Port of Long Beach currently stacks their containers six-high. But surrounding zoning limits container stacking at warehouses to two-high. This further complicates storage and the ability to take on new ships for berthing.

During the Covid-19 pandemic, the logistics publication FreightWaves reported how the City of Long Beach temporarily alleviated the lack of space for series 1 freight containers in properties near the port:
“Given this current national emergency and [California Gov. Gavin Newsome's] executive order to take necessary steps to alleviate the impacts on the system, the city manager will temporarily waive enforcement of current shipping container stacking and height limits,” the city said in a statement. (FreightWaves, 2021)

In the above case, if the Port of Long Beach could stack more containers, they would place less pressure on the hinterland properties in the supply chain. However, the Port of Long Beach is currently capped at stacking series 1 freight containers six-high.

What both the Ports of Los Angeles and Long Beach are missing is the ability to stack series 1 freight containers sky-high.

There is another advantage not recognized by the named institutions. Space would clear up for semi-truck queueing areas, directly helping semi-truck logistic firms.

It might seem unrelated, but the railroad transshipment hubs in Chicago and other areas of the United States need greater ability to store series 1 freight containers. As the current art shows, rail yards remain, well, on the rails. There is a tragic failure to see other means to accomplish their goals of handling more freight. If the railroads could stack containers conveniently, they could generate more revenues.

In short, the ports could be alleviated from their freight back logs, further allowing the ships waiting at sea to berth.

When viewing these transshipment hubs and ports through an architectural lens, there is a failure to use space efficiently, imaginatively, or gracefully.

As a high-level registered architect, these are a few of my high-level conclusions.

Over the past year, when I looked at ships, docks, gantry cranes, and handling areas, I also noticed tedious inefficiencies. Why do gantry cranes pick one or two containers at a time? It looks to me like picking beans out of a jar-one or two at a time. There are so many containers on a modern cargo ship!

After they are picked, they must be handled individually by longshoremen who pull twist locks from the bottom of the containers—by the tens of thousands—while hanging from a gantry crane. Then the containers are lifted yet again to be put on a cart or truck, or to be stacked again for another round of picking and stacking at a later time. Not only is this repetitious, the longshoremen are also constantly in danger from falling freight or twist locks.

What happens when a truck driving professional arrives and needs a series 1 freight container from the bottom of a stack of six? They pick and pluck. If the containers could be moved in a 3-axis manner getting to the right container would require less steps.

The industry is due for innovation—not incremental niceties, but wholesale reimagination.

Gantry cranes and modern cargo ships have gotten bigger, but they have not changed encargoing or decargoing in the past sixty-six years since the series 1 freight container was standardized.

Cargo ships themselves are marvels on one hand. It is amazing how much freight can be moved by a vessel. This capacity is nullified by inefficient port layouts, rail networks, and transshipment hubs.

What good is a 24,000 TEU ship sitting full of cargo for four weeks off the coast of 705 California?

It is an extreme example of waste by the ship owners. It must be painful when a ship costs hundreds of millions of dollars sitting for several weeks to get a berth. This is what in part drives up the cost of freight.

It also frustrates consumers.

Cargo containerships are not the only unfortunate vessels. Dry-bulk and wet-bulk tanker ships also experience inefficient utilization rates. Because of these vessels' design, they do not accept empty series 1 freight containers for their return trips. They generally return empty.

What I found interesting is that containerships do not readily accept grains and other dry-bulk cargoes. There are cases of grains being shipped in containers, but these were from what I found in bags and ready for sale. They were not bulk commodities.

From my research, it appears bulk commodities are not rate-favorable in series 1 freight containers.

Both bulk ships and container ships do not readily access the other cargo type customers. If ships were more flexible, their utilization rates would improve. But as mentioned above, the handling of even a series 1 freight container full of grain is not rate-favorable. This leads to my observation that larger containers of bulk commodities could pass the rate-favorable threshold.

From my research, I found that bunkering a ship, or loading it with fuel, can take six or eight hours! Surely there is room for improvement when filling up the ol′ tank. Eight hours multiplied by twenty stops per year works out to 160 hours-just sitting at berth waiting for fuel. There has to be a better way.

I would now like to address safety on container ships in more detail. These vessels are quite dangerous for longshoreman to encargo and decargo since the design of the series 1 freight container does not adequately provide lateral bracing. There are moment welds that keep the series 1 freight container vertical but under the stress of large wave events, they crumple like tin cans.

Lashing rods are currently used to reduce the loss of cargoes at sea and to prevent structural failure. As mentioned in the Background Art section, they are quite dangerous.

Watching the video by Lyttleton Port Company (YouTube, 2020), I learned 60% of injuries are caused by lashing.

If the number of lashing rods required was reduced, then it stands to reason that injuries would follow suit. From all accounts, I have found that no one has suggested to remove lashing rods entirely. This naturally would reduce lashing rod related injuries.

Furthermore, ship owners are concerned about the cost of insurance. If they could prove that their loads are not likely to spill overboard, they would save on insurance costs.

I have also observed that ports are generally selected for their natural environment. Areas with deep and calm waters are preferred. However, this does not always coincide with where economic activity occurs.

The Yangshan Deep-Water Port near Shanghai, China is a great example of the lengths humans will go to achieve their goals. From one perspective, it is an engineering marvel, but it's also a great example of much wasted time, money and material.

In fact, it was this epic port that inspired me to observe that moving millions of tons of earth to create a foundation and berth for a deep-water port some twenty miles offshore is not necessary. If cargoes could be transferred at sea, then docks could be used along with barges.

There is precedent for transferring cargoes at sea, but it fares no better in throughput than port-side gantry cranes. What both Yangshan Deep-Water Port and the Port of Los Angeles have shown during the Covid-19 pandemic is that containerships simply do not unload fast enough.

What would happen if ports were no longer restricted by natural features? How would this affect undeveloped places in the world? How many lives could be transformed by tapping into global trade?

I would also like to address the limitations of canals such as the Panama Canal. These infrastructure projects have inspired countless engineers (and with good reason). Yet, they do not accommodate the world's largest containerships. So-called Neopanamax ships may traverse the canal after it was expanded in 2016. These ships have a capacity of 14,424 TEU. This is about 10,000 TEU smaller than the biggest ships of today.

Freight becomes less expensive the larger the ship becomes as a factor of scale. From the above example we can see the world's most efficient ships are limited by land bottlenecks. In particular, the Panama Canal, the Suez Canal, the route around Singapore through the Strait of Malacca and the Bosphorus passageway in Türkiye all provide opportunities for newly imagined infrastructure projects.

### Solution to Problem

I propose both a preferable set of solutions to the technical problems outlined above and a transitional set of solutions.

This is why my invention is called system for cargo transport.

Because intermodal logistics is capital-intensive, it is not wise to put forth a preferable set of solutions without a transitional set of solutions. In this way, I am able to help the intermodal logistics industry make the transition to what I consider 21st-century global trade standards—the pinnacle of intermodal freight conveyance.

But the pinnacle is not convenient for the vast majority of ports, ships, trucks, and trains.

Because of this, I would like to start with the transitional set of solutions. These solutions will enable the transition to the pinnacle. In this regard, I propose a realistic pathway.

At the heart of the system for cargo transport is the cargo frame. The cargo frame binds a plurality of cargoes together and resists lateral gravity and uplift loads so that cargoes are conveyed with fewer steps and may transit more safely. It makes retrieving freight more efficient as a fully loaded cargo frame forms a bundle of cargo. Bundling allows for sorting. One bundle can be bound for Chicago and another can be bound for Las Vegas. This also makes retrieving cargoes more effective as the bundle represents a town, a city, or a region.

The cargo frame is a genus.

The x-clip is a species of cargo frame.

While twist locks may secure a series 1 freight container to a ship deck, they are not good at resisting lateral loads. This is why lashing rods are critical for any container ship that stacks series 1 freight containers above deck. Twist locks and corner castings are not designed to lift two stacked series 1 freight containers.

The x-clip overcomes this major limitation by binding two series 1 freight containers together in a bundle as a structural frame. Because the x-clip binds each container individually, the twist lock may be employed. Some experimentation may be required to ensure there is little slop between the so-called shield slots and the other corner casting slots. It is conceivable the twist lock head and shaft itself will need to be enlarged to reduce the slack.

Aside from this minor technicality, the x-clip allows two containers to be picked with an enhanced gantry crane and spreader frame. Where previous spreaders may pick two series 1 freight containers end to end, the x-clip allows four containers to be picked. This doubles the capacity of a prior art gantry crane. The crane will need to be strengthened for twice the load. Factors such as additional counterweight, strengthened cables and pulleys, modified structural members, and modified foundations will be required, enabling $150M USD gantry cranes to remain at the existing quays.

This demonstrates how my transitional set of solutions bridges the technology gap while doubling the throughput capacity, while also remaining financially practical.

The x-clip utilizes purpose-built structural heads and slots with a lengthened spreader frame and strengthened twist lock mechanisms.

Doubling the amount of cargo lifted with each pick is nothing to sneeze at. But the x-clip does more. As mentioned in the Technical Problem section, lashing rods are disproportionately the cause of injury to stevedores. I find this unacceptable. My goal is to improve the lives of stevedores. I would like to make their voyages more rewarding with less toil.

My great grandfather was a merchant marine captain who sailed around the world 27 times in the 1920's. It will be a mark of pride to help this profession.

When two series 1 freight containers are stacked on a ship's deck, the bottom container is held down with twist locks. The immediately above container is also held with twist locks. In each upper corner of the lower container and all four of the upper container, corner castings receive a lashing rod. That is six lashing rods.

The x-clip reduces the number of lashing rods required to hold down two series 1 freight containers by one-third! This represents hundreds of operations eliminated simply because lashing rods are combined with and structurally attached to an x-clip.

It is even conceivable the lower lashing rods are not necessary because the x-clip braces top corner casting of the upper container to lower corner casting of the lower container.

What would govern here is the strength of the thickness of the steel. For example, a less expensive x-clip may require four lashing rods and a premium model may require two.

The x-clip enhances the resistance to waves and high winds on the high seas. There's no doubt that this will lower insurance premiums.

Not only does the x-clip help on ships, it also allows a train well-car to be loaded twice as fast! Removing all these steps at both ships and rail transshipment yards improves efficiency.

This is an embodiment of what I call the transitional set of solutions.

Another species of a cargo frame is the cargo clip. The cargo clip bundles four series 1 freight containers. Like the x-clip, the amount of freight picked by a gantry crane is vastly improved. With structural modifications to the gantry crane and a new lengthened spreader frame with enhanced structural twist lock mechanisms, the purpose-built cargo clip enables the picking of eight series 1 freight containers.

There are numerous embodiments of the cargo clip which will be described in detail later. But I would like to point to the embodiment which also has structurally attached lashing rods.

Where 12 lashing rods are required to tie down four series 1 freight containers to a ship's deck, the cargo clip only needs four! This reduces the time needed even more so than the x-clip. The reason less time is required is related to the size of the bundle. Four containers may be moved in one action, whereas the x-clip moves two.

As we see here, the x-clip doubles that of the prior art gantry crane and the cargo clip doubles that of the x-clip. In both these cases, true to the genus of cargo frame, these embodiments bundle cargoes effectively and with added lateral bracing, lifting capacity, and stability on a ship's deck.

Structurally attaching the lashing rods to the x-clip and cargo clip not only reduces the number of rods needed, but it also greatly improves the safety of stevedores. The rods are not strewn about the lashing bridge; they are neatly attached to the clips.

Loose, falling rods are a thing of the past. Just imagine the insurance savings!

While I currently contemplate the port-side bundle as a land-based species of the cargo frame, I believe it could also be used on ships. I could simply attach twist lock flaps at the top of the frame to the corner castings. This has the advantage of only needing six twist lock flaps to secure four series 1 freight containers versus 16 twist lock flaps on the larger embodiment of the cargo frame.

As we will soon see, the larger cargo frame utilizes electrically-actuated twist lock flaps, which enable eight containers to roll out on rail carts on two levels in seconds, whereas the port-side bundle lifts the containers out with prior art spreader frames. When looking at the port-side bundle, you can see I utilized a cell guide, which is a new use for the technology outside of a ship.

Each species of the cargo frame is carefully considered for the respective technological status of a given port, logistics firm, ship, or rail firm.

The port-side bundle is not a one-trick pony. It can attach to a rail cart as the cargo clip is, or it can be lowered onto autonomous wheeled carts. Unlike prior art carts, my carts are sized in plan view the same as the bundle, x-clip, or cargo clip. In other words, the cart does not protrude beyond the plan view dimensions. In this way, the carts may wheel themselves into tower slots, preserving precious space as mentioned above in the Technical Problem section.

Stepping away briefly from the cargo frame, I would like to address the transitional set of solutions regarding ports, warehouses, rail yards, etc. to improve their storage capacity. This is not the cargo frame tower but a species of it.

Where port-side bundles are contemplated, a port-side bundle structure may be employed. This structure uses hydraulic elevator lift platforms to double or triple the stacking capacity of a given piece of property; even higher heights can be reached with other hoist mechanisms. We will cover sky-high stacking abilities later in the cargo frame tower.

Autonomous carts wheel the port-side bundle into a hydraulic elevator lift platform by communicating with a wireless control bollard & signal light. The wireless control bollard & signal lights are further controlled by a central, and/or location-specific server where instruction sets are sent to the various bollards employed.

These bollards are placed in strategic locations to communicate with the autonomous carts, rail carts, trucks, freight trains, cargo frames, and other elements of the system for cargo transport.

The port-side bundle structure could also utilize 3-axis hoists versus hydraulic elevator lift platforms. It is all a matter of customer needs.

Depending on whether the port-side bundle structure is in a seismic zone, twist lock flaps or corner twist lock rack mechanisms can be employed to tie down the port-side bundles in their bays. Where there is low seismicity, the safety rail may be all that is needed.

The port-side bundle structure need not only use the port-side bundle, but it is entirely feasible that individual series 1 freight containers on autonomous rail carts can roll in on rails with a modified hydraulic elevator lift platform. Even the cargo clip on an autonomous rail cart can roll in on rails in a similar fashion.

The transitional set of solutions are designed to be flexible.

With the aforementioned embodiments of the cargo frame and port-side bundle structure, series 1 freight containers can be stacked several levels. Ports with substantial infrastructure in place can reorganize without a wholesale scrapping of equipment. This clearing of land provides more space for semi-truck queueing.

Extra dollars are earned with easily retrievable series 1 freight containers. This can benefit port terminal operators, railroad organizations, and warehousing firms.

The first movers on the transitional set of solutions will gain favorable business loyalty from truck driving professionals as these improved terminals will be more pleasurable to work with. Ships will be able to call without delay. Rail yards will not be pressured to keep series 1 freight containers at port but gladly send them to their new facilities.

Moving on to the preferable set of solutions, I propose wholesale change to global trade and the manner freight is conveyed. It will require new ships, new ports, new barges, new bulk siloes, new railroad configurations, and of course, the largest cargo frame of all.

While I believe 16 series 1 freight containers bound in a bundle represent the practical physical limits of working with large quantities of containers, a five-by-five cargo frame can also be possible. From my preliminary calculations, this exceeds the ability of two sets of rails and eight bogies to support the weight of such a bundle of cargo. It requires more than welding filler steel to the rails and widening the flange. New, heavier duty wheel sets, bogies and more are also required.

A possible work around for the five-by-five bundle utilizes a third set of rails. This adds four more bogies to alleviate the added weight. But rotating the center bogie requires the bogies to be modified again to allow for turning clearance. This likely removes one bogie per side and would negatively affect the carrying capacity.

I do teach how this could be done, but my gut sense is that while possible, a five-by-five would be a bit impractical and would not overcome the added expense.

The 16 series 1 freight container cargo frame is a species of cargo frame that enables containers on autonomous rail carts to load four at a time per level. In a two-level port platform, eight containers are swiftly loaded and locked in place at the rear of the cargo frame. As the 3-axis hoist lowers the cargo frame, the remaining eight containers on autonomous rail carts roll into position and are locked at the stationary twist lock flaps.

When you multiply this over 20 bundles, 320 series 1 freight containers may be loaded in one operation! The two sets of rails that serve these cargo frames are doubly loaded such that there is a matching number of 3-axis hoists on the other side of the tracks. This enables 640 series 1 freight containers to be loaded in minutes.

If a port had two terminals, 1,280 series 1 freight containers could be loaded in the same fashion.

As mentioned above, this species of cargo frame requires two sets of rails to carry the weight. Special rail turntables have been designed to accommodate these behemoths to enable 90-degree turns.

Another feature of this species of cargo frame is that the frame structurally isolates series 1 freight containers from the weight above. Only eleven fully loaded containers may be safely stacked on top of each other before the bottom one crushes. In contrast, the cargo frame enables sky—high stacking by diverting loads to a purpose-built structure—not to the container below.

Conveying series 1 freight containers is not all this cargo frame can do.

The same spaces used for series 1 freight containers can be slightly modified from utilizing cargo frame joists with wheels to utilizing cargo frame joists with a platform, allowing wheels to roll and thus accept vehicles. Measures for chain tie-downs can be accommodated. There is no need to wait for a roll-on, roll-off ship. With this embodiment 32 cars could be shipped (and even more if they are compact cars)!

The cargo frame standardizes the shipment of series 1 freight containers and more. With a current maximum gross weight rating of 36,000 kg, or 79,370 lbs., this species of cargo frame can hold 576,000 kg, or 1,269,920 lbs. A unique feature with this manner or rating is that as long as a bay in the cargo frame remains under the maximum weight of one series 1 freight container, it can carry freight other than containers.

Another way to visualize this is that when shipping tractors (which are larger in height than a series 1 freight container), two cargo frame bays can be reduced to one for added height. So long as the tractor weighs less than two series 1 freight containers' maximum gross weight, the tractor may ship in that bay. If it exceeds that, more cargo frame bays can merge into that bay until it complies with the weight restriction.

For even larger cargoes such as military hardware, bays can be reduced to six. This enables six A1M1 Abrams tanks to be shipped all without breaching the design loads of the cargo frame tower on land or on ship.

The largest of cargoes are characterized as bulk cargoes. Imagine 576,000 kg, or 1,269,920 lbs., of grain are desired to be shipped. One bay may be defined by the exterior portion of the cargo frame and a bulk silo may be installed inside the one bay cargo frame. This level of standardization and increased weight carrying capacity make shipping dry-bulk goods with cargo frames economically viable.

Like the vehicles above not needing to wait for a roll-on, roll-off ship, farmers can make sure at least a portion of their goods are shipped with every ship leaving port. This will have a marked effect. In the example of the United States and China trade where there is a trade imbalance, dry-bulk cargo frames will improve the utilization rate of returning ships.

The cargo frame is simply more versatile than prior art ships and their means to convey cargo.

A bulk-cargo cargo frame effectively compartmentalizes the bulk-cargo within the cargo frame cargo ship and prevents dangerous shifting and liquefaction effects that are prevalent in large bulk-cargo holds. In this manner, even if all the cargo contained in the bulk-cargo cargo frames transition to a liquified state, they are prevented from listing the ship. The cargo frame cargo ship structure prevents these dangerous movements.

As a result of this discovery, I imagine that the International Maritime Organization will seriously consider changing the standards of design for bulk-cargo ships.

How, after seeing these advantages, could you desire to keep dangerous vessels?
Commercial agendas also play a role. For example, pressure to load vessels quickly leads to more hard loading even though it risks raising the water pressure in the cargoes. And pressure to deliver the same tonnage of cargo as was loaded may discourage the crew of the vessel draining cargoes during the voyage. (The Conversation, 2018)

With the bulk-cargo cargo frame, cargoes may be loaded hours or even days prior and stored safely in the cargo frame towers. Again, the system for cargo transport displays its rich flexibility. If cargoes are stored long before a ship arrives, the economic pressure to cut corners is lessened. As such, the orders of magnitude faster loading capability of a cargo frame cargo ship will reduce, if not eliminate, the corner cutting.

While bulk-cargo represents both dry-bulk and liquid bulk goods, I would like to turn to liquid bulk. As mentioned in the Technical Problem section, loading a ship with fuel is a long process—but not with the bulk-cargo cargo frame designed for fuels. The lengthy process of certifying fuels can be done hours or days ahead of time!

Depending on the ship's needs, these special purpose embodiments make fueling up a cinch. Simply load the fuel tanks into the ship and connect them to rerouted fuel lines. Even one connected fuel-equipped bulk-cargo cargo frame will do. Stevedores can connect the others once the ship is in route. Seriously, what can beat the cargo frame?

Moving such enormous cargo frames is no mean feat. It requires two sets of rails; depending on the gauge of the rails and the country they are purchased from, they may require structural enhancement. With four rail bogies per set of rails, the cargo frame has twelve rail bogies in total. They comprise two shortened axle rail bogies in the center of each side and four pivoting rail bogies at the corners. Some of the rail bogies may be mechanized to enable autonomous movement.

The pivoting rail bogies enable 3-axis movements within a cargo frame tower, or cargo frame cargo ship.

Another embodiment of this cargo frame may remove bogies on two sides.

Another embodiment of this cargo frame may create a new type of rail car, the cargo frame rail car. These rail cars have coupling attached so that two train engines can pull them-one engine per set of rails. They can be dedicated to rail routes as outlined in some FIGS. below. This embodiment is well suited for the cargo frame cargo ship that carries 10,000 bundles, or 160,000 TEU is employed. These monster ships are nearly seven times larger than the world's largest container ships.

They will deliver colossal amounts of cargo at a price too good to refuse.

Because of canal sizes, these monster ships cannot pass the world's current infrastructure. This provides little resistance. Cargo frames are unloaded on one side of the canal, or an unfavorable maritime route, or a geologic restriction, and pulled via train engines to the other side where another matching cargo frame cargo ship picks them up without skipping a beat.

Let this sink in.

No longer will the intermodal logistics industry speak in terms of TEU, they will speak in terms of bundles. This is a factor of 32 as one TEU is a twenty-foot equivalent, and 16 forty-foot containers are 32 TEU.

Storing bundles is a breeze.

I would like to introduce the 3-axis structure and 3-axis hoist. This structure enables ports, rail yards, warehouses, and other similar establishments to stack bundles of cargo sky-high.

As mentioned previously, the cargo frame prevents the weight of upper series 1 freight containers from being imposed on lower series 1 freight containers. As such, the only height limitations of such a tower I can see stem from available capital, geotechnical conditions, seismicity, wind, and other weather events.

The positions in a cargo frame tower may be programmed with software code. As the cargo frame has pivoting rail bogies and the 3-axis hoist enables the rotation of the bogies, these towers are now 3-axis capable.

They are not the only towers in the system for cargo transport.

Semi-truck queueing towers allow the precise injection of semi-trucks to retrieve available cargoes delivered in cargo frames. For example, in FIG. 1 there are six semi-truck queueing towers. 1, 3, and 6 may service terminal A and 2, 4, and 6 may service Terminal B. This happens in coordinated fashion wherein a server or computer stores, retrieves, and executes software code, telling truckers which bay to go to and what cargo frame and container goes where via wired and wireless control boxes and hand-held devices such as smart phones. Smart phones are convenient places to deploy computer software code, but other purpose-built devices could also be employed.

Each batch of cargo frames will take some time for semi-trucks and rail carts to clear out their cargoes or unload their cargoes-depending on whether they are encargoing or decargoing.

The tower may have a rest and recreation floor including but not limited to: a café, a convenience store, a bathroom, a medical professional, a game room, a reading area, a work-out area, a dental professional, a laundromat, and a massage therapist.

Series 1 freight containers coming in via rail may enter the port and decargo at the rail transshipment yard. Where x-clips are employed on well cars, wireless control boxes may be added such that they link up with an autonomous rail cart and are pre-programmed on where to go rather than having a person read each container and direct it in that fashion.

Once a rail cart is loaded from an incoming freight train, it may proceed to the semi-truck transshipment yard and be loaded as previously discussed.

Once these cargo frames are fully loaded, the bundle exits the 3-axis hoist and rolls to the cargo frame turntable as it receives instructions from the wireless control bollard and signal lights. After making its turn, the cargo frame heads to the cargo frame dock to the proper bay where it waits for a cargo frame barge.

As the cargo frame barge makes its way between the cargo frame dock pilings, it extends its lobster claws and clamps onto lobster claw clamping rods, forming a part of the cargo frame dock pilings. Once clamped and firmly held, a platform raises to the level of the cargo frame dock with optical and distance sensors. The platform then rolls towards the dock and aligns with the two sets of rails the cargo frame is conveyed upon.

As this is set in place, 3-axis hoists descend down to connect with the cargo frame and lift it off the tracks so the pivoting rail bogies may turn. Once placed back on the rails, the cargo frames roll onto the barge. Electric power is supplied for these short maneuvers with an electric third rail or battery power.

Optical, motion and distance sensors on the cargo frame alert the control box as to the distance needed to arrive at a central resting place on the barge. Once in place, twist lock racks are pushed via hydraulic pistons into place with the corner twist lock rack slots. The electrically actuated twist locks tie down all four corners of the cargo frame. After the cargo frames are secured, the lobster claws slowly release their grip so that the barge may descend to its final displacement. The claws then release and retract towards the center hull so the barge may exit the dock.

Now the cargo frame barges motor towards the cargo frame cargo ship and wirelessly communicate positions and the side to which the barge will dock with the ship.

Doors open up from the cargo frame cargo ship as the barges near the ship and barge bumpers are tossed out so the ships do not collide. Longshoremen throw ropes to ease the barge in place and opened lobster claws grip the lobster claw clamping rods on the side of the ship.

As the barges becomes secure, the cargo frame platform raises up as required to meet the level of the ship's rails. Using optical sensors, the barge comes to its completed operation, twist lock racks unlock, and the bundles roll into the cargo frame cargo ship. From there, the ship control boxes communicate with the cargo frame to roll and/or lift into its voyage position.

The cargo frame cargo ship travels to its next port and reverses the operations.

To recap, I propose a preferable set of solutions to the Technical Problem section outlined above which are the pinnacle of intermodal freight conveyance, as well as a set of transitional set of solutions including apparatus, infrastructure, and port layouts that allow my customers to come up to 21^{st} century global trade standards over time.

### ADVANTAGES

While the ultimate goal of the preferred embodiment is entirely revamping the manner in which global intermodal trade is conducted, numerous other embodiments provide the opportunity for existing intermodal logistics firms to transition. This is necessary because ships, ports, trucks, and railroads are capital-intensive.

I believe the following drawings and descriptions will show that entirely revamping global intermodal trade is possible and will need all the various embodiments shown to accomplish this.

It is no mean feat.

Existing infrastructure, ports, and ships may be improved with more efficient apparatus. As time goes by, these transitional apparatus will begin to reap financial rewards for my customers. When the financial time is right, they could then upgrade to more aggressive machines, port layouts, ships, barges, and infrastructure-all part of my grand solution.

Those with the ability and freedom to start a port from scratch will have the ability to choose from a good, better, or best set of machines, ships, barges, apparatus, port layouts, and infrastructure.

Just as the United States of America cannot be without Arizona, neither can the system for cargo transport be without its constituent parts. Like Arizona, however, the system for cargo transport constituent parts can exist and function without the totality of the system—albeit having a lesser impact on global trade, if isolated. In that sense, the system for cargo transport is an invention all itself and is why I have created a single application and not 50 or so individual applications.

Every following embodiment or invention is unified by the cargo frame.

### BRIEF DESCRIPTION OF DRAWINGS

FIG. 1 An aerial orthogonal view of the preferred embodiment of the system for cargo transport (sheet 1/73)

FIG. 2 An aerial perspective view from the upper left corner of FIG. 1 (sheet 2/73)

FIG. 3 An aerial perspective view from the upper right corner of FIG. 1 (sheet 3/73)

FIG. 4 An aerial perspective view from the lower left corner of FIG. 1 (sheet 4/73)

FIG. 5 An aerial perspective view from the lower right corner of FIG. 1 (sheet 5/73)

FIG. 6. A site plan view of a system for cargo transport (sheet 6/73)

FIG. 6A An enlarged site plan view of a upper portion of system for cargo transport (sheet 7/73)

FIG. 6B An enlarged site plan view of a middle portion of system for cargo transport (sheet 8/73)

FIG. 6C An enlarged site plan view of a lower portion of system for cargo transport (sheet 9/73)

FIG. 7 A perspective view of a semi-truck queueing tower entrance (sheet 10/73)

FIG. 8 A perspective view of a semi-truck queueing tower exit (sheet 11/73)

FIG. 9 A low aerial perspective view of a semi-truck transshipment yard entrance (sheet 12/73)

FIG. 10 An eye-level perspective view of four series 1 freight containers at a semi-truck transshipment yard leaving a cargo frame in a 3-axis hoist (sheet 13/73)

FIG. 11 An eye-level perspective view of four series 1 freight containers leaving a cargo frame in a 3-axis hoist towards a semi-truck transshipment yard (sheet 14/73)

FIG. 12 An eye-level perspective view of a cargo frame dock with an empty cargo frame barge (sheet 15/73)

FIG. 13 An eye-level perspective view of a cargo frame cargo ship on a body of water transferring cargo to a cargo frame barge (sheet 16/73)

FIG. 14 A low-aerial perspective view of a truck transshipment yard, a bulk silo and 3-axis hoist (sheet 17/73)

FIG. 15 A low-aerial perspective view of a truck transshipment yard, a bulk silo and 3-axis hoist (sheet 18/73)

FIG. 16 An eye-level perspective view of a truck transshipment yard, and a bulk silo and 3-axis hoist (sheet 19/73)

FIG. 17 An eye-level perspective view of a 3-axis structure and 3-axis hoist (sheet 20/73)

FIG. 18 A perspective view of an empty cargo frame turntable (sheet 21/73)

FIG. 19 A perspective view of a loaded cargo frame turntable (sheet 22/73)

FIG. 20 A perspective view of a cargo frame maintenance bay and freight car transshipment yard (sheet 23/73)

FIG. 21 A perspective entrance view of a fully loaded 16 series 1 freight container cargo frame (sheet 24/73)

FIG. 22A perspective rear view of a fully loaded 16 series 1 freight container cargo frame (sheet 25/73)

FIG. 23 An elevation front view of a fully loaded 16 series 1 freight container cargo frame (sheet 26/73)

FIG. 24 An elevation side view of a fully loaded 16 series 1 freight container cargo frame (sheet 27/73)

FIG. 25 An elevation rear view of a fully loaded 16 series 1 freight container cargo frame (sheet 28/73)

FIG. 26 An enlarged plan detail view of a twist lock flap at the entry of a 16 series 1 freight container cargo frame (sheet 29/73)

FIG. 27 A plan view of a 16 series 1 freight container cargo frame's structural framing and rail bogie arrangements (sheet 30/73)

FIG. 27A An enlarged plan view of a pivoting rail bogie (sheet 31/73)

FIG. 27B A lower cut plane of an enlarged plan view of a pivoting rail bogie (sheet 31/73)

FIG. 28 A perspective view of a pivoting rail bogie (sheet 32/73)

FIG. 29 An exploded perspective view of a pivoting rail bogie from above (sheet 33/73)

FIG. 30 An exploded perspective view of a pivoting rail bogie from below (sheet 34/73)

FIG. 31 A perspective view of a cargo frame sized to match a 16 series 1 freight container cargo frame wherein the bays are resized to accommodate military hardware while not exceeding the weights prescribed by 16 series 1 freight containers (sheet 35/73)

FIG. 32 An elevation side view of a cargo frame sized to match a 16 series 1 freight container cargo frame wherein the bays are resized to accommodate military hardware (sheet 36/73)

FIG. 33 An elevation rear view of a cargo frame sized to match a 16 series 1 freight container cargo frame wherein the bays are resized to accommodate military hardware (sheet 36/73)

FIG. 34 A perspective view of a cargo frame sized to match a 16 series 1 freight container cargo frame wherein the bay is resized to accommodate a bulk cargo carrier (sheet 37/73)

FIG. 35 A perspective view of a cargo frame sized to match a 16 series 1 freight container cargo frame wherein the bays are used to transport vehicles (sheet 38/73)

FIG. 36 A perspective view of a pair of train engines pulling a series of fully loaded 16 series 1 freight container cargo frame rail cars coupled together (sheet 39/73)

FIG. 37 A perspective view of a 16 series 1 freight container cargo frame rail car with coupling (sheet 40/73)

FIG. 38 A detail section view of a structurally modified rail (sheet 41/73)

FIG. 39 A perspective view of a cargo frame barge (sheet 42/73)

FIG. 40 A section view of a cargo frame barge (sheet 43/73)

FIG. 41 A perspective view of a lobster claw (sheet 44/73)

FIG. 42 A perspective view of a 3-axis structure and 3-axis hoist (sheet 45/73)

FIG. 43 A lower plan view of a 3-axis structure and 3-axis hoist (sheet 46/73)

FIG. 44 A lower perspective view of a 3-axis structure and 3-axis hoist FIG. 44 (sheet 47/73)

FIG. 45A lower perspective view of a 3-axis structure and 3-axis hoist where the retracting and extending beams are in extended position (sheet 48/73)

FIG. 46A lower perspective view of a 3-axis structure and 3-axis hoist where the retracting and extending beams are in closed position (sheet 49/73)

FIG. 47A perspective view of a corner hoist lift mechanism (sheet 50/73)

FIG. 48A plan view of a corner column at a 3-axis structure (sheet 51/73)

FIG. 49 An upper perspective view of a 3-axis structure and 3-axis hoist (sheet 52/73)

FIG. 50 An upper plan view of a 3-axis structure and 3-axis hoist (sheet 53/73)

FIG. 51 A frontal perspective view of a 3-axis hoist (sheet 54/73)

FIG. 52 A angled perspective view of a 3-axis hoist (sheet 55/73)

FIG. 53 An enlarged world plan view of Türkiye and Egypt wherein a schematic route is planned according to FIG. 30 as an alternative to the Istanbul Canal, and next to the Suez Canal respectively (sheet 56/73)

FIG. 54 An enlarged world plan view of Panama wherein a schematic route is planned according to FIG. 30 as an alternative to the Panama Canal (sheet 57/73)

FIG. 55 An enlarged world plan view of Thailand wherein a schematic route is planned according to FIG. 30 as an alternative to the “Land Bridge” project (sheet 58/73)

FIG. 56 An enlarged world plan view of Mexico wherein a schematic route is planned according to FIG. 1, and FIG. 30 from Puerto Peñasco, Mexico to Yuma, Arizona (sheet 59/73)

FIG. 57 An perspective view of a sea bluff utilizing the best mode of invention in a unique setting (sheet 60/73)

### ADDITIONAL EMBODIMENTS

FIG. 58 An exploded perspective view of a port-side bundle sized to house 4 series 1 freight containers wherein two vertical bays are formed by a pair of cell guides and a separate autonomous cart is used to transport said cargo frame (sheet 61/73)

FIG. 59 A perspective view of a port-side bundle tower and hydraulic lift sized to house a plurality of cargo frames which are further sized to house 4 series 1 freight containers (sheet 62/73)

FIG. 60 A perspective front view of a cargo clip with castellations (sheet 63/73)

FIG. 61 A perspective rear view of a cargo clip with castellations (sheet 63/73)

FIG. 62 A perspective rear view of a cargo clip with a plurality of arced slots for modified, bent, structurally attached twist lock open & closing arms for hand use (sheet 64/73)

FIG. 62A An enlarged perspective front view of a cargo clip a plurality of arced slots for modified, bent, structurally attached twist lock open & closing arms for hand use (sheet 64/73)

FIG. 63 A perspective front view of a cargo clip with a plurality of arced slots for modified, bent, structurally attached twist lock open & closing arms for hand use (sheet 65/73)

FIG. 63A An enlarged perspective rear view of a cargo clip with a plurality of arced slots for modified, bent, structurally attached twist lock open & closing arms for hand use (sheet 65/73)

FIG. 64 A perspective front view of a cargo clip wherein a plurality of structurally attached lashing rods are in closed position, and a plurality of slotted pipes to allow a plurality of rods to push left or right, enabling open and closing arms to maneuver (sheet 66/73)

FIG. 64A An enlarged perspective front view of a top portion of a cargo clip wherein a plurality of structurally attached lashing rods are in closed position, and a plurality of slotted pipes to allow a plurality of rods to push left or right, enabling open and closing arms to maneuver (sheet 67/73)

FIG. 64B An enlarged perspective front view of a middle portion of a cargo clip wherein a plurality of structurally attached lashing rods are in closed position, and a plurality of slotted pipes to allow a plurality of rods to push left or right, enabling open and closing arms to maneuver (sheet 67/73)

FIG. 64C An enlarged perspective front view of a lower portion of a cargo clip wherein a plurality of structurally attached lashing rods are in closed position, and a plurality of slotted pipes to allow a plurality of rods to push left or right, enabling open and closing arms to maneuver (sheet 67/73)

FIG. 65A perspective front view of a cargo clip wherein a plurality of structurally attached lashing rods are in open position structurally attached to a ship deck, and a plurality of slotted pipes to allow a plurality of rods to push left or right, enabling open and closing arms to maneuver are shown attached to four series 1 freight containers (sheet 68/73)

FIG. 66 A perspective underside view of a pair of cargo clips with castellations FIG. 66 shown locked to four series 1 freight containers, and an autonomous rail cart (sheet 69/73)

FIG. 66A An enlarged perspective underside view of a cargo clip with castellations shown locked to four series 1 freight containers, and an autonomous, motorized rail cart (sheet 69/73)

FIG. 67 An exploded perspective view of a cargo clip with castellations shown in relation to a set of four series 1 freight containers, and an autonomous, motorized rail cart (sheet 70/73)

FIG. 68A plan view of a cargo clip locked to a set of four series 1 freight containers in a ship's modified cell guide (sheet 71/73)

FIG. 69A perspective view of an x-clip with structurally attached lashing rods binding a set of two series 1 freight containers (sheet 72/73)

FIG. 70 A perspective view of an x-clip with structurally attached lashing rods wherein a horizontal beam with a punched slot provides for forklift access (sheet 73/73)

### Best Mode for Carrying Out the Invention

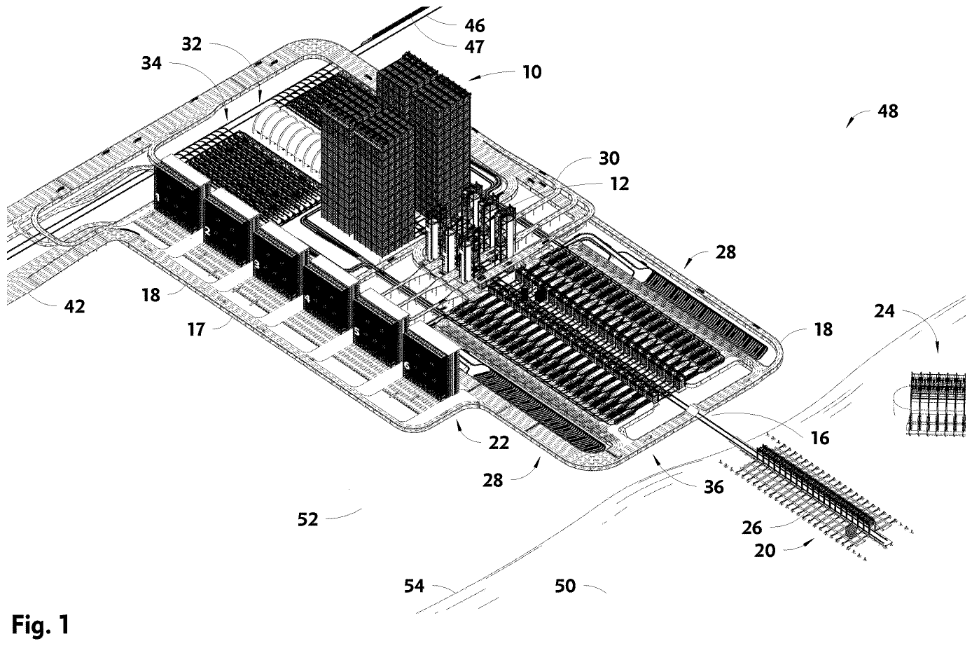

I will first describe these new concepts by giving a high-level tour of how the system for cargo transport operates when taking into account FIG. 1. Then I will describe in further detail in the next Figs.

The collection of port apparatus shown here comprises one “repeatable” terminal. It is entirely probable that a port would wish to have numerous terminals while on a real site. It is unlikely that you could simply copy and paste as shown in this restriction-free disclosure. The gist is that repeatable terminals are possible and can be done when considering normal architectural and engineering considerations such as: rock outcroppings, water bodies, bounding real estate, codes, setbacks, and other site-specific features.

As such, it is expected that an existing port marked for demolition will have a lot of “baggage” from prior art layouts such as old quays, rail lines, and the like. Despite these and other potential innumerable restrictions, this system for cargo transport can take on infinite variation to meet site-specific features and still shine.

Empty semi-trucks 220 enter the port 48 at the access road for trucks 42. The truck drivers are instructed by the app to arrive at the ground-level 17 or the second-level 18. They are then instructed to navigate to one of six semi-truck towers 22. Here, they will have further instructions to pull into a lane and subsequent elevator and find a destination slot in the semi-truck tower 22.

The drivers will park their semi-truck 220 for a period of time prescribed by the app while awaiting the fully loaded cargo frames 40. During this time, they may walk around the semi-truck tower 22 or visit the café.

While the semi-truck towers 22 fill up in anticipation of retrieving bundles of cargo, longshoremen are awaiting the cargo frame cargo ship 24 at the cargo frame dock 20. When a ship radios in that they are arriving, the cargo frame barges 26 are readied by longshoremen, and they begin the process of motoring towards the cargo frame cargo ship 24.

Ship stevedores await and are ready for the longshoremen and their cargo frame barges 26. The ship stevedores lower barge bumpers 510 at each bay in the cargo frame cargo ship 24. Ropes are thrown and tightened to cleats to enable the cargo frame barges 26 to be drawn into position at the cargo frame ship 24. Once in position, flaps open so lobster claw clamping rods 504 on the cargo frame cargo ship 24 may receive lobster claws 500 on the cargo frame barges 26.

With lobster claws 500 in place, the ship lowers and extends a collapsible 3-axis hoist 14 to connect with the cargo frame barges 26 and begin the process of decargoing.

When the cargo frame barges 26 have been filled with cargo frames 40, they begin motoring to return to the cargo frame dock 20. Here, longshoremen throw ropes as required and moor the cargo frame barges 26. Lobster claws 500 grab onto lobster claw dock pilings 502 on both sides of the cargo frame barges 26. This allows a stable conveyance of cargo frames 40. Once conveyed to the cargo frame dock 20, a corresponding number of 3-axis hoists 14 lift the cargo frames 40, enabling the perpendicular rotation of a pivoting rail bogie 308 so that the cargo frames may travel to their proper positions along the two sets of rails for a cargo frame, (an electric third rail is not shown for clarity) 218 to their cargo frame turntable 38. After rotating 90 degrees, the cargo frames 40 approach a 3-axis hoist 14.

Autonomous rail carts loaded with series 1 freight containers 222 roll out of their cargo frames 40 on both the ground-level 17 and second-level port platform 18. After advancing to the semi-truck and rail transshipment area 202, the 3-axis hoist 14 lowers and enables the next batch of autonomous rail carts loaded with series 1 freight containers 222 to enter the rail cart queueing area free from semi-trucks 212.

While the semi-truck spreader frames 208 load series 1 freight containers 226 onto semi-trucks 220, some autonomous rail carts loaded with series 1 freight containers 222 continue on rails to the freight car transshipment yard 34. Here, series 1 freight containers 226 are unloaded via freight car spreader frames 35 on outbound freight well cars 37.

Once unloaded, empty rail carts 306 motor towards the access rails from outside the port 46 and loop back towards the semi-truck transshipment yard 224. Here they wait until all semi-trucks 220 have retrieved their series 1 freight containers 226 and left the semi-truck transshipment yard 36.

Undoubtedly, a few truckers will get a flat tire, sleep in, get sick, or for some other reason, miss their appointment. In these scenarios, all remaining autonomous rail carts loaded with series 1 freight containers 222 scuttle to freight purgatory 28.

As the name implies, these unclaimed cargoes remain in an abandoned state until claimed and paid for. If the cargoes exceed a certain time period prescribed by the port administration, they may return to the semi-truck transshipment yard 36 and load back into fresh cargo frames 40 via the 3-axis hoists 14. Here, the loaded cargo frames 40 maneuver to the cargo frame turntables 38, orient themselves to the two sets of rails for a cargo frame 218, and motor towards the 3-axis structure and 3-axis hoists 10.

Upon arriving at the proper cargo frame turntable 38, the cargo frame 40 turns and enters the cargo frame tower and hoist 10 for longer term storage. While the present FIG. 1 shows four 3-axis structure and 3-axis hoists 10, no doubt a port will need additional storage capacity and so it is likely that more 3-axis structure and 3-axis hoists 10 will be found at future ports. There are limitations to a patent disclosure that utilizes A4 paper size, especially when the subject material is physically huge.

The advantages are staggering if a port has 100 hectares, or 250 acres, and builds 10-level 3-axis structure and 3-axis hoists 10. For interest, let us imagine 50 hectares, or 125 acres, are used as storage in this scenario. That would give this modest sized port 500 hectares of storage, or 1,250 acres of storage. No doubt this would alleviate the world's ports and provide substantial monies in new forms of revenue streams.

As we will see shortly in another embodiment, the 3-axis structure and 3-axis hoists 10 can be built without needing all the bells and whistles of this preferred embodiment. The storage can enable the port to earn monies needed for the eventual upgrade to the preferred embodiment.

For those with dry-bulk or liquid-bulk cargoes, the sequence starts at the access road for semi-trucks 42. The semi-trucks maneuver up to the second-level port platform 18, and the truckers motor to the third-level bulk platform 30 to drop off bulk-cargo at the bulk drop 68. After dropping of their cargoes, they may leave the third-level bulk platform 30 and descend to the exit road for trucks 44.

Truckers who need to pick up dry-bulk cargoes continue past the third-level bulk platform 30 to the semi-truck transshipment yard where they pass the semi-truck spreader frames 208, drive under a bulk-cargo silo, and hoist 12 to retrieve their cargoes. After they have filled their trucks, they leave via the exit road for trucks 44.

It is the cargo frame 40 that enables near limitless stacking as the structural nature of cargo frame 40 transmits loads to the columns for 3-axis hoist structure 11, without crushing the lower containers.

As I see it now, the limitations that affect the height of the 3-axis structure and 3-axis hoists 10 stem from issues of this nature: seismic zone, propensity for typhoons and similar storms, weak or limited load bearing capacity of the soil at the port, or more simply . . . money. If money is an issue that restricts height for a port, the structural engineers could design the 3-axis structure and 3-axis hoists 10 to later add additional stories. 1565

This approach does require foresight.

Hopefully, this gives you a taste of what is to come in more detail below.

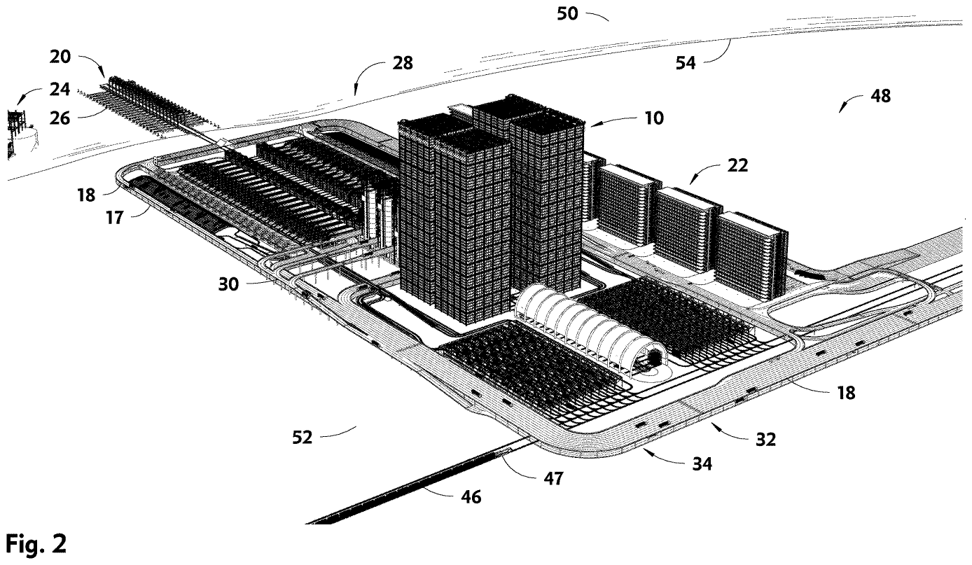

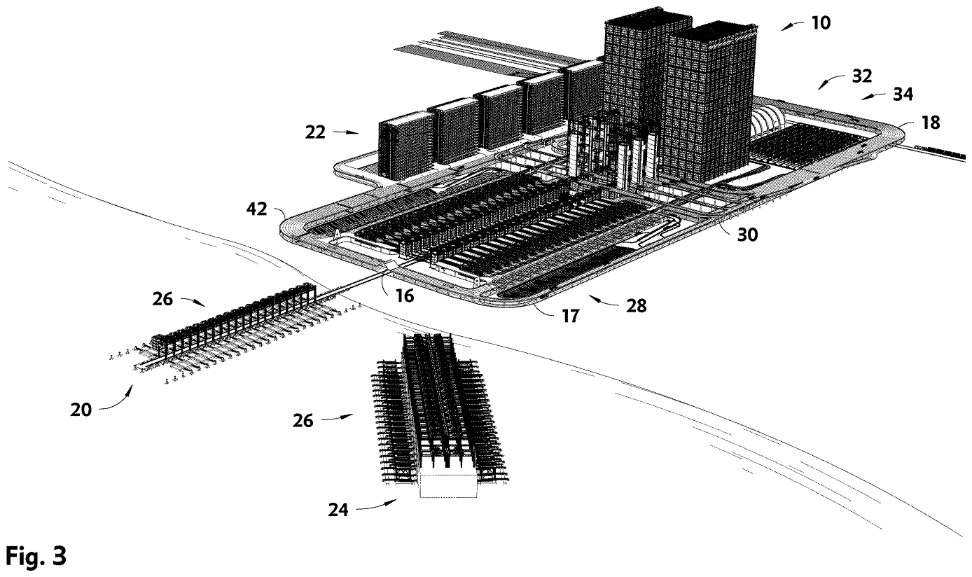

FIG. 2 is an aerial view which largely shows the same elements of the port 48 as in FIG. 1. However, greater detail is shown at the cargo frame maintenance yard 32 and how it relates to the central axis of the port 48. Also seen is the truck driving loop that is formed for the third-level bulk platform 30.

FIG. 3 is an aerial view which largely shows the same elements of the port 48 as in FIG. 1. The clear relationship of the semi-truck queueing towers 22 as they sit primed to unleash the proper amount of trucks per terminal, level, and location. Each tower is designed to match the number of truck bays at the semi-truck transshipment yard 36. In this manner the six towers shown would accommodate three cargo turnovers on both the ground level 17 and second-level port platform 18.

The cargo frame cargo ship 24 is shown closer to shore than would be the case in some ports, but because of the limitations of the size of a sheet of A4 paper, it is shown close to the shoreline 54.

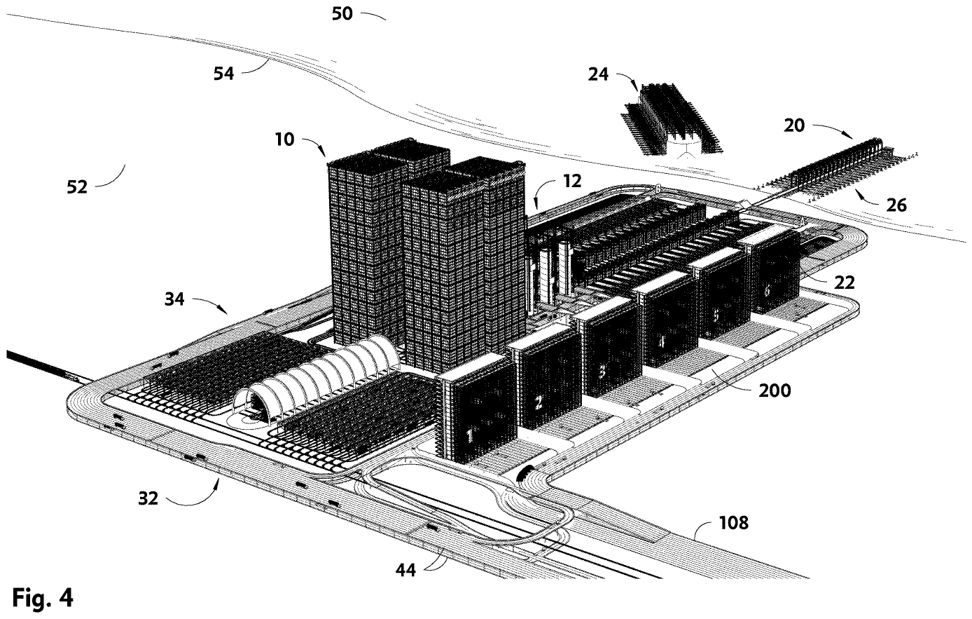

FIG. 4 is an aerial view which largely shows the same elements of the port 48 as in FIG. 1. Here a clearer view is depicted which shows how a semi-truck 220 would enter the port 48.

All movements of the road infrastructure are smooth to facilitate a pleasurable experience. Note the soft round corners, nice transitions, and general tidiness of the port 48.

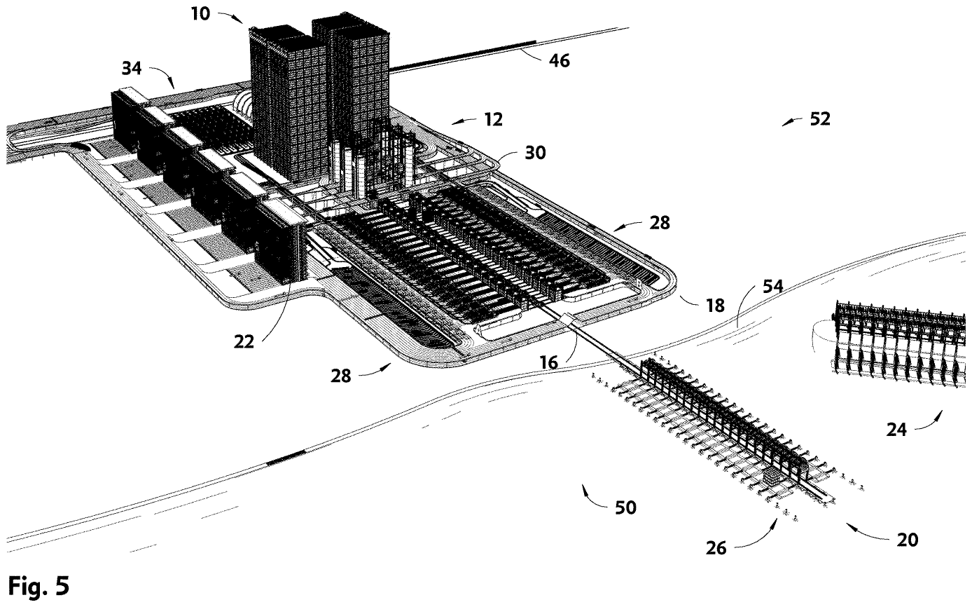

FIG. 5 is an aerial view which largely shows the same elements of the port 48 as in FIG. 1. Here, you may see a more frontal view than that of FIG. 1.

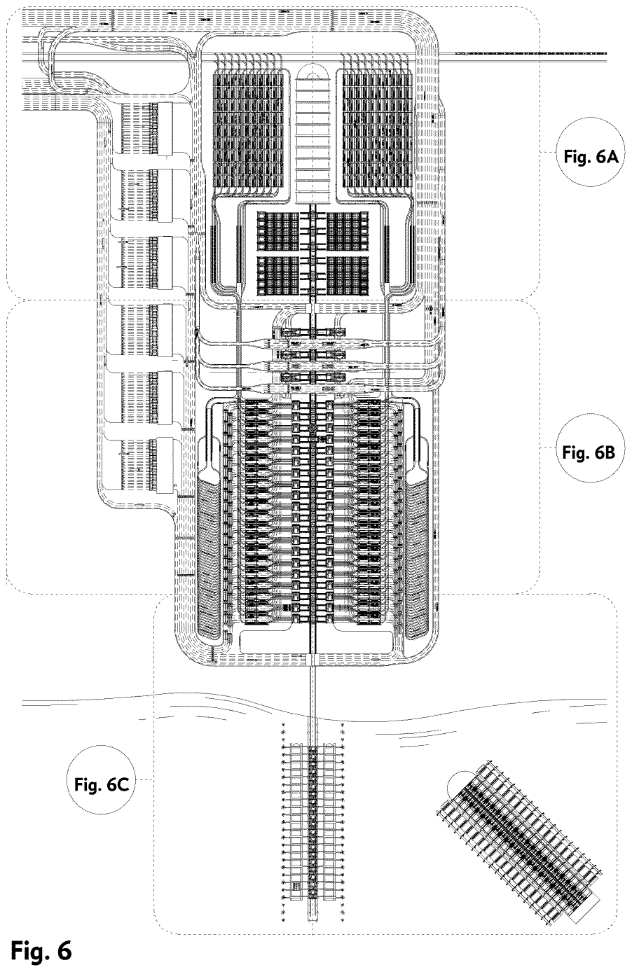

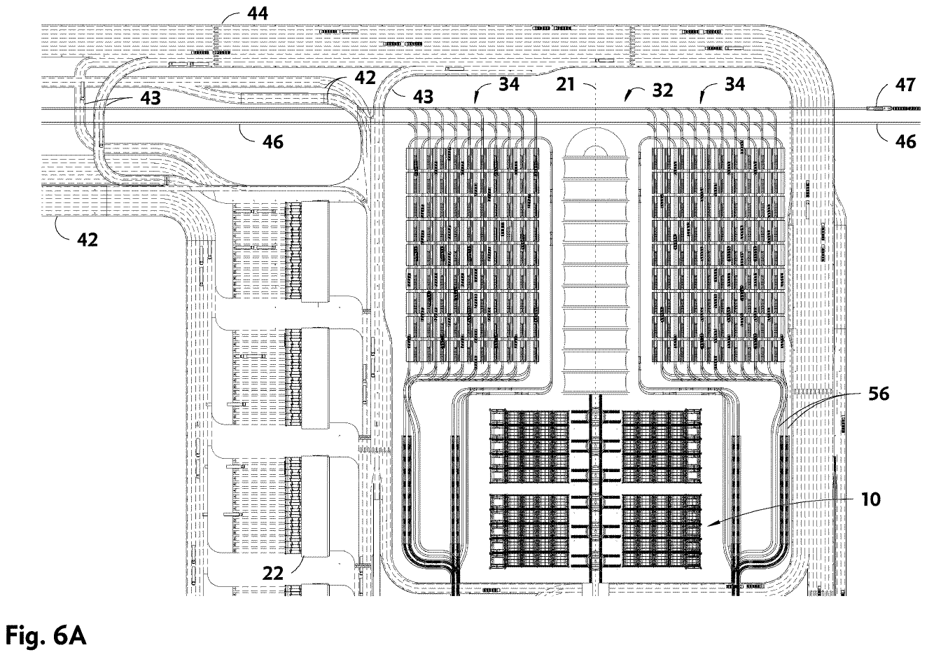

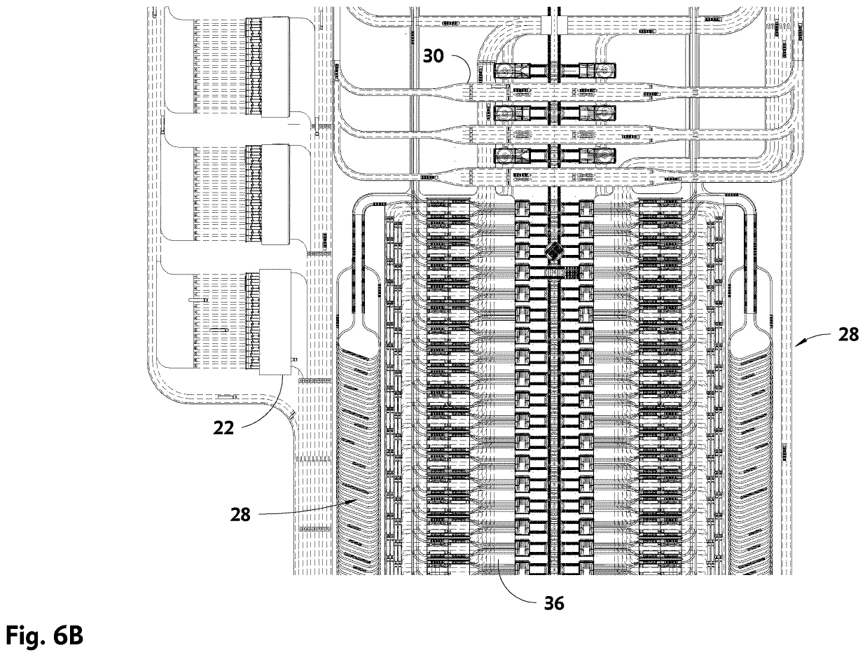

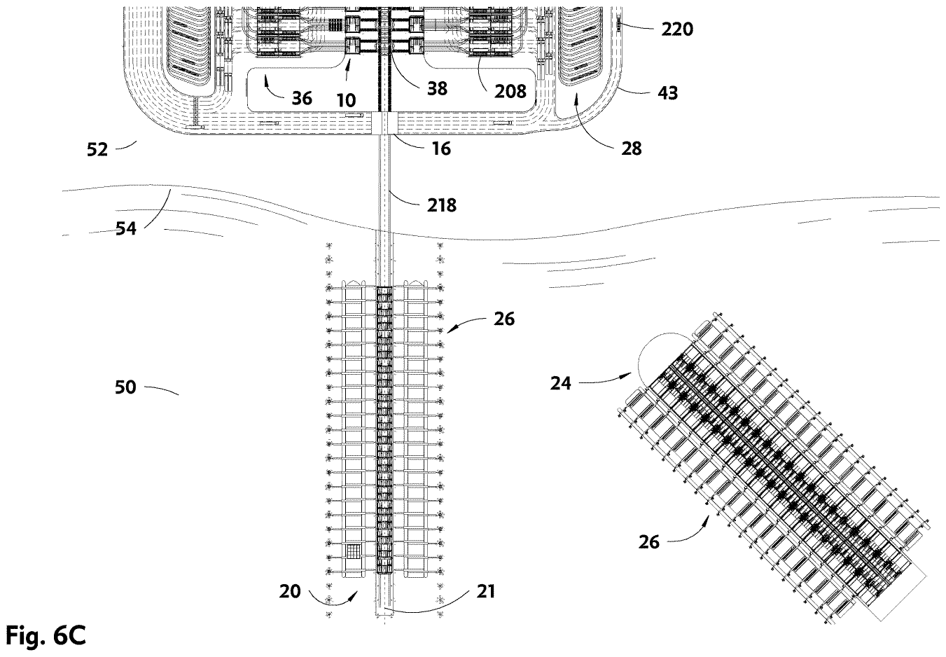

FIG. 6 depicts a site plan view of a port 48.

FIG. 6A is an enlarged site plan view of an upper portion of FIG. 6. Truckers enter at the access road for semi-trucks 42 and may continue to either a third-level bulk platform 30 or semi-truck queueing tower 22; three of these towers are shown.

At the top portion of the view is an exit road for semi-trucks 44, as well as a return loop for semi-trucks 43. Also shown are access rails from outside the port 46. At the top right a freight train 47 is shown.

Towards the upper middle portion of the view are freight car transshipment yards 34 and cargo frame maintenance yard 32. Return loops for rail carts 56 are shown.

Along the central spine 21, two sets of rails for a cargo frame 218 enable conveyance of Cargo frames to 3-axis structure and 3-axis hoist 10, and the cargo frame maintenance yard 32. Four 3-axis structures and 3-axis hoists 10 are shown with six cargo frame turntables 38.

FIG. 6B is an enlarged site plan view of a middle portion of FIG. 6. At left are three semi-truck queueing towers 22.

To the right is a freight purgatory 28 where stray rail carts loaded with series 1 freight containers 222 may be stored for later retrieval.

At the upper middle portion of the view is a third-level bulk platform 30. Six bulk silo & hoists 12 are shown along with 12 bulk drops 68.

In the middle portion of the drawing two semi-truck transshipment yards 36 are shown flanked to the central spine 21. Cargo frame turntables 38 are spaced to match 3-axis structures and 3-axis hoists 10.

FIG. 6C shows an enlarged site plan view of a lower portion of FIG. 6. At the upper 1635 portion of the view, two truck transshipment yards 36 are shown flanked along the central spine 21. A plurality of cargo frame turntables 38 and 3-axis structures and 3-axis hoists 10 also flank the central spine 21.

At the lower mid-section, a cargo frame dock 20 and cargo frame barge 26 is shown 1640 flanking each side of the dock.

At lower right a cargo frame cargo ship 24 is shown with two cargo frame barges flanking both sides of the ship.

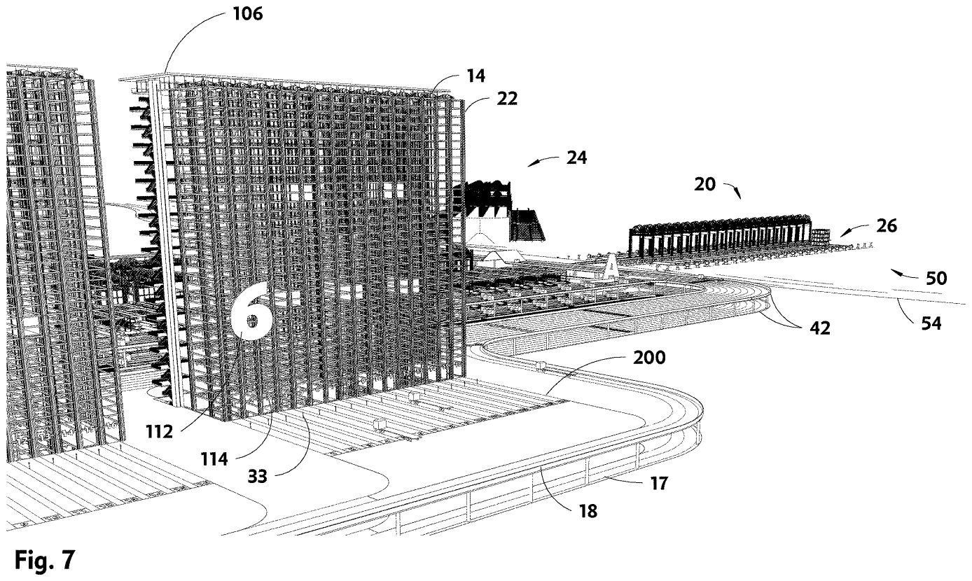

FIG. 7 is a low-aerial perspective view of two semi-truck queueing tower 22 entrances For context, in the center of the view we see a full semi-truck queueing tower 22. An alpha-numeric character for semi-truck queueing tower designation 112 is shown with smaller sized alpha-numeric characters for semi-truck queueing tower column bays 114 below.

In the upper portion of the view, you see an entire rest and recreation floor 106 where truckers may cool off, stay warm, get a bite to eat, purchase a snack, see a doctor, get a massage, use the restroom, play a game, read, and more. This amenity will greatly improve the lives of truck driving professionals and ease their stress. In addition, the view is fantastic and allows the truckers to gain familiarity with the port layout 48. At the top of each column of semi-truck bays 132, we see an embodiment of the 3-axis hoist 14.

This occurs at both the ground level 17 and the second-level port platform 18.

To the right and rear we see a cargo frame cargo ship 24 and a cargo frame barge 26 on a body of water 50.

To the very right, the access road for semi-trucks 42 leads your eye up to the cargo frame dock 20 and cargo frame barge 26 that are shown just beyond the shoreline 54.

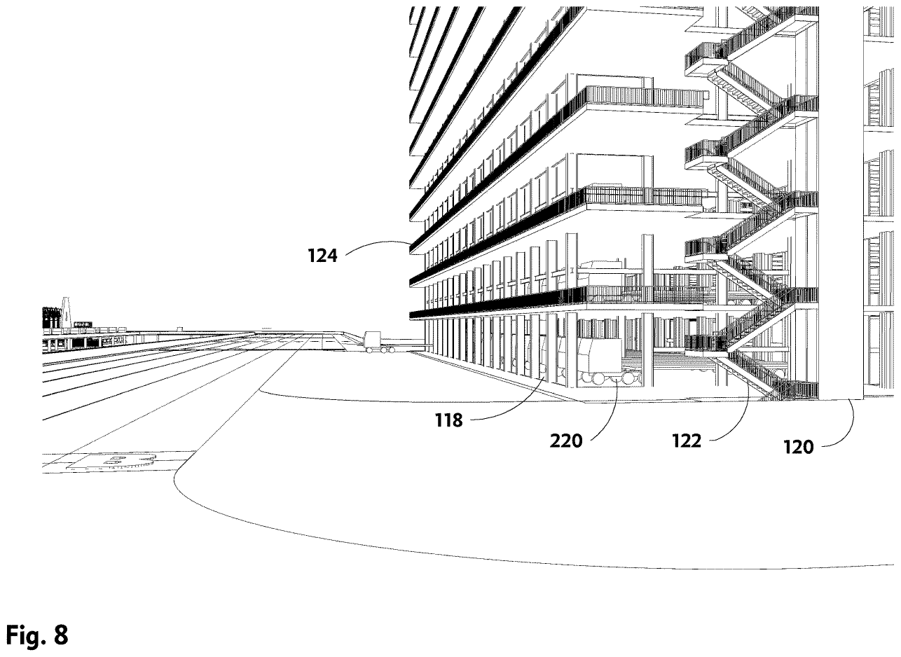

FIG. 8 shows a perspective view of a semi-truck queueing tower 22 on the exit side. At the left rear portion of the view, an alpha-numeric character for terminal designation 213 is seen at the entrance of the semi-truck transshipment yard 36. You may see a semi-truck 220 leaving the semi-truck exit from a semi-truck queuing tower 118 in the middle section.

In the middle, you may see the semi-truck queueing tower 22 and a plurality of semi-truck bays 132 along with semi-trucks 220.

To the right is a human fire exit stairs for semi-truck queueing tower 122 and a human elevator for semi-truck queueing tower 120.

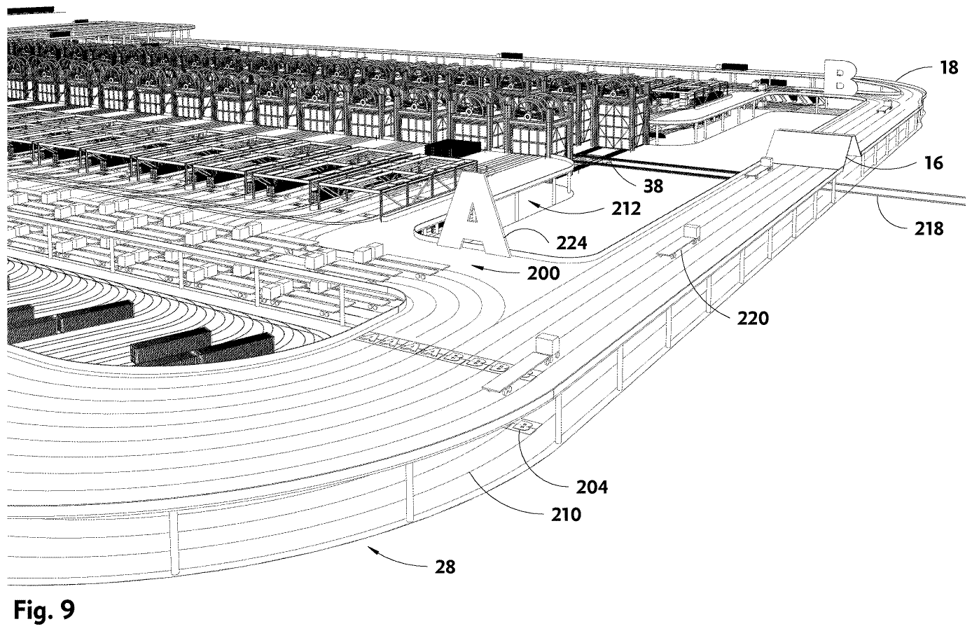

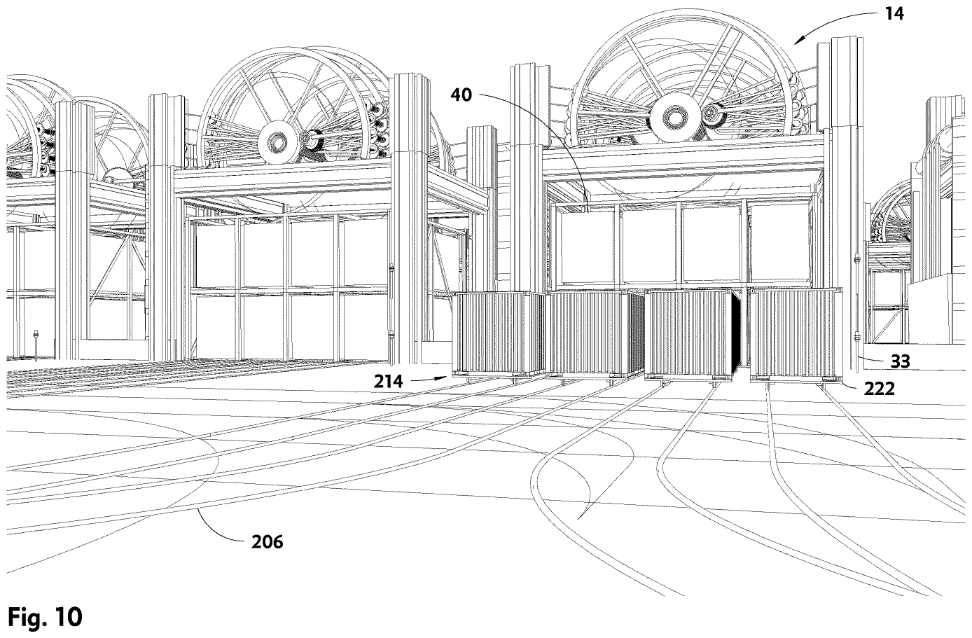

FIG. 9 features a low aerial perspective view of a semi-truck transshipment yard 36 entrance where semi-trucks 220 arrive at the semi-truck queueing area 200, having turned the corner and driven past the freight purgatory 28. Due to the height of the cargo frame, a draw bridge 16 is needed to pass through. A cargo frame turntable 38 is shown in the middle of the view. Just to the left of the turntable is a rail cart queueing 1685 area free from semi-trucks 212.

Alpha-numeric characters for terminal designations 213 are large and easily viewed. In addition to signals from the wireless control bollard and signal light 33 (shown in closeup view), truckers may use these designations for visual cueing. Painted alpha-numeric characters near semi-truck loading bay 204 also accomplish this task.

As the truckers await for their space to open up, semi-truck spreader frames 208 unload series 1 freight containers 226 (shown in closeup view). Lane striping 210 keeps the semi-trucks 220 organized.

This occurs at both the ground level 17 and second-level port platform 18.

FIG. 10 shows an eye-level perspective view of four autonomous rail carts loaded with series 1 freight containers 226. They are leaving a cargo frame 40 from a 3-axis hoist 14 in the rail cart queueing area 212 at a semi-truck transshipment yard 36.

The rail carts are guided and receive software instructions by wireless control bollards and signal lights 33. They roll on four sets of tracks 214 towards the semi-truck transshipment yard 36, which is behind this view.

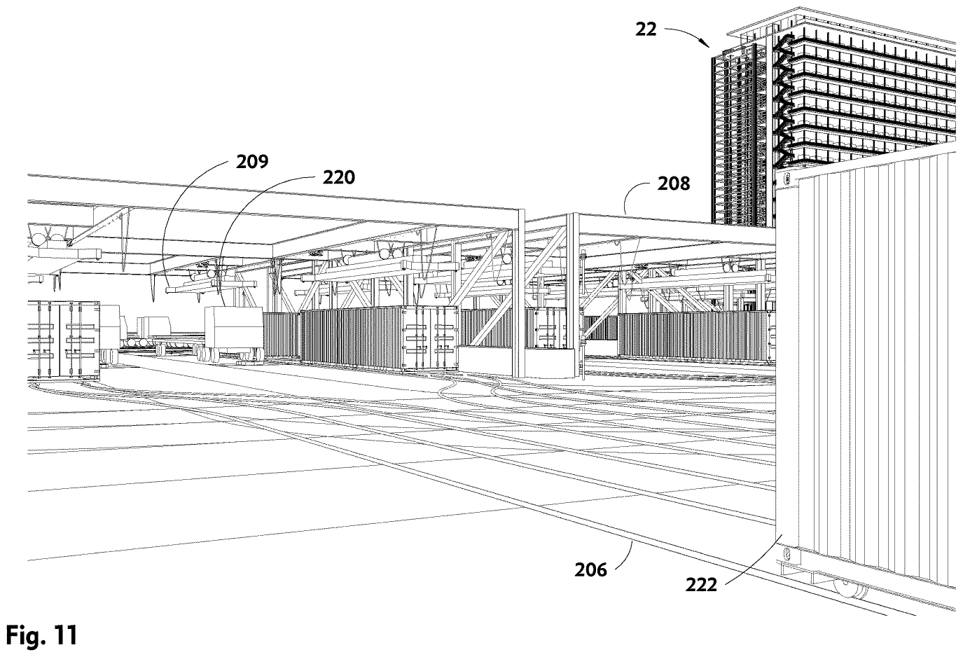

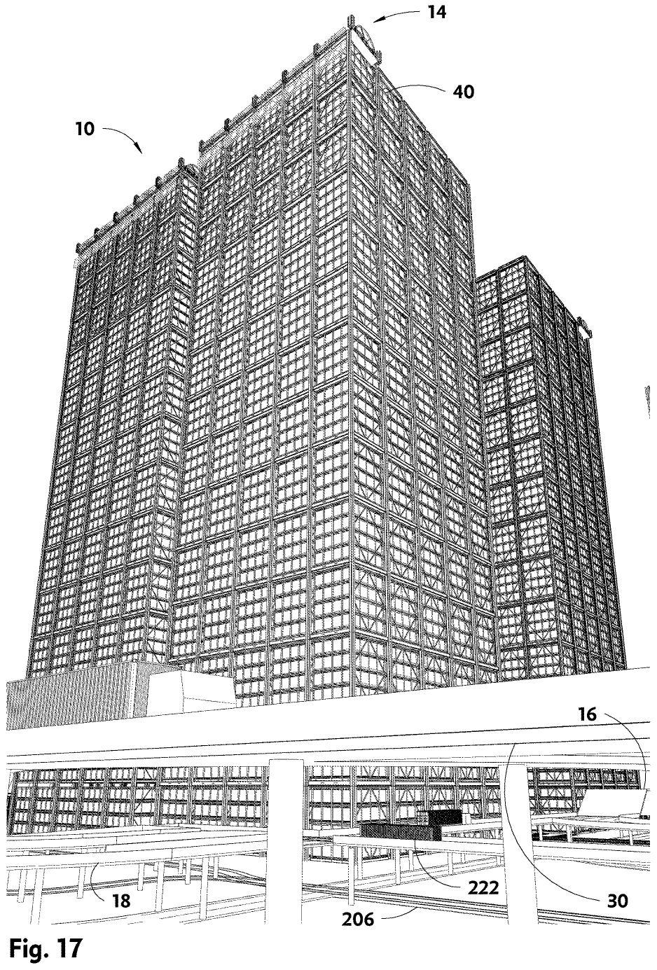

FIG. 11 is an eye-level perspective view on the opposite side of FIG. 17 showing four autonomous rail carts loaded with series 1 freight containers 226 leaving a cargo frame 40 in a 3-axis hoist 14 towards a semi-truck transshipment yard 36. To the upper right, a semi-truck queueing tower 22 is seen. Four sets of rails 214 lead the autonomous rail carts loaded with series 1 freight containers 226 beneath a semi-truck spreader frame 208 where the wireless control bollards and signal lights 33 direct the autonomous rail cart loaded with series 1 freight container 226 to arrive at a position relative to the semi-truck 220 with optical, motion, and distance sensors 311.

Instructions are then sent from the wireless control bollards and signal lights 33 to a control box 424 in the autonomous rail cart loaded with series 1 freight container 222 to release the electrically actuated twist locks 330. Then instructions are sent to each spreader for one series 1 freight container 209 to move to position with optical, motion and distance sensors 311 to lower and engage the series 1 freight container 226 corner castings. Then the spreader for one series 1 freight container 209 lifts the container and utilizes optical, motion, and distance sensors 311 to arrive at position at the intermodal chassis on the semi-truck 220 to lower the container on the chassis.

A trucker may then tighten the twist locks on the intermodal chassis. At this point, the truck driving professional may leave with their cargo after speaking with customs agents. The agents will clear the trucks by sending instructions via hand-held devices or smart phones to the wireless control bollards and signal lights 33 which in turn, send coordinated instructions to a hand-held device or smart phone held by the trucker.

In this way, the semi-truck transshipment yard 36 may be vacated with cargoes in a coordinated manner. Depending on the situation, the autonomous rail carts loaded with series 1 freight containers 222 may receive instructions to return to the cargo frame 40, continue on to a maintenance yard, go to the rail freight transshipment yard 34, or remain in place for further instructions.

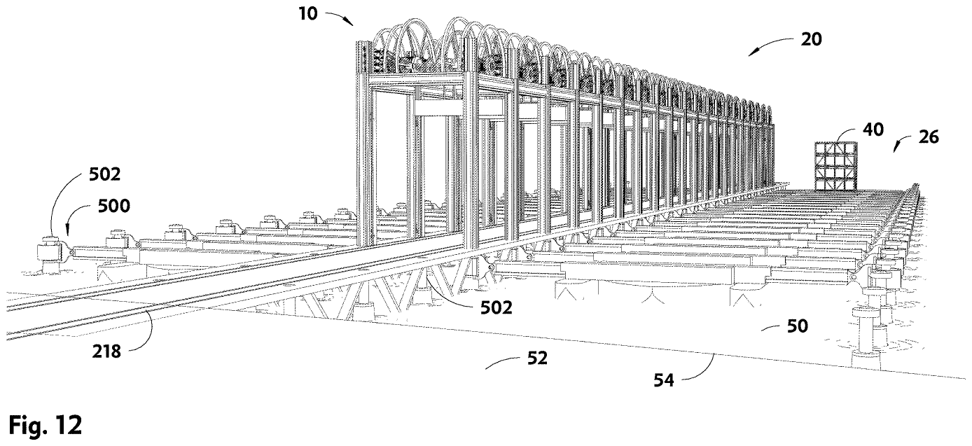

FIG. 12 is an eye-level perspective view of a cargo frame dock 20 with an empty cargo frame barge 26. At left are two sets of rails for a cargo frame 218 where cargo frames 40 (not shown) roll onto the cargo frame dock 20. Also seen are lobster claws 500 gripping the lobster claw clamping rods 502.

Utilizing wireless control bollards and signal lights 33, the cargo frames 40 receive instructions via the control box 424 which communicate when and where to stop along the dock. Wireless control bollards and signal lights 33 are also receiving information from the cargo frame barge 26 control box 424.

At the appropriate time, instructions are sent to the 3-axis hoist 14 to lower and lift the cargo frame 40 so that the pivoting rail bogies 308 may turn. Wireless control bollards and signal lights 33 send instructions to the cargo frame 40 control box 424 to turn the bogies. Once complete, the cargo frame 40 control box 424 sends completion status to the wireless control bollards and signal lights 33, which in turn, send instructions to the 3-axis hoist 14 to lower the cargo frame 40.

The cargo frame 40, having been lowered and given instructions to proceed, rolls onto the cargo frame barge 26 mechanized platform 518.

At this point, success status is sent from the cargo frame 40 control box 424 to the wireless control bollards and signal lights 33.

The reverse is true when cargoes are being loaded from the cargo frame barge 26 to the cargo frame dock 20.

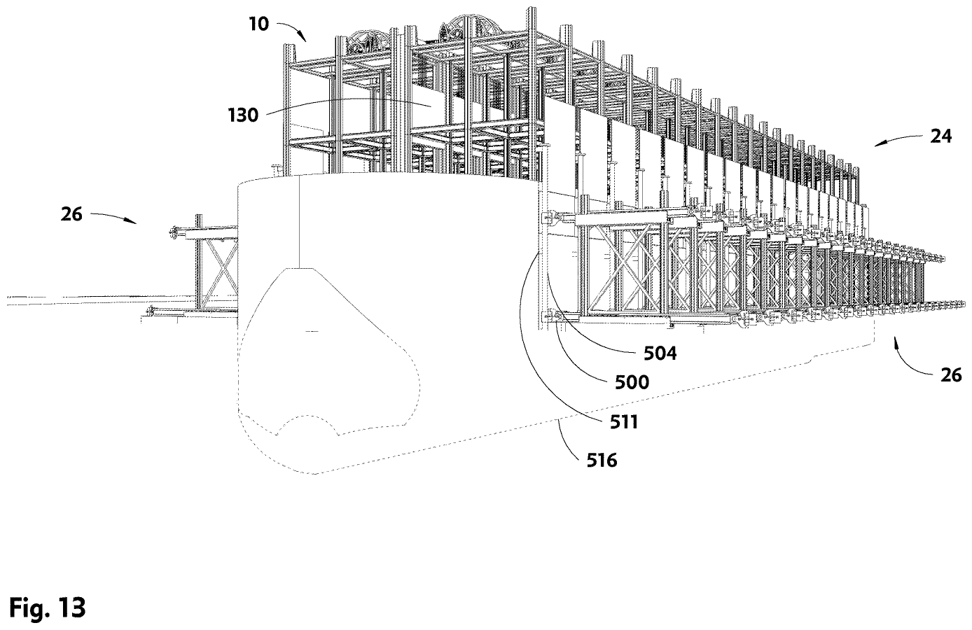

FIG. 13 shares an eye-level perspective view of a cargo frame cargo ship 24 on a body of water transferring cargo to a pair of cargo frame barges 26. The ship's hull 516 is shown for reference.

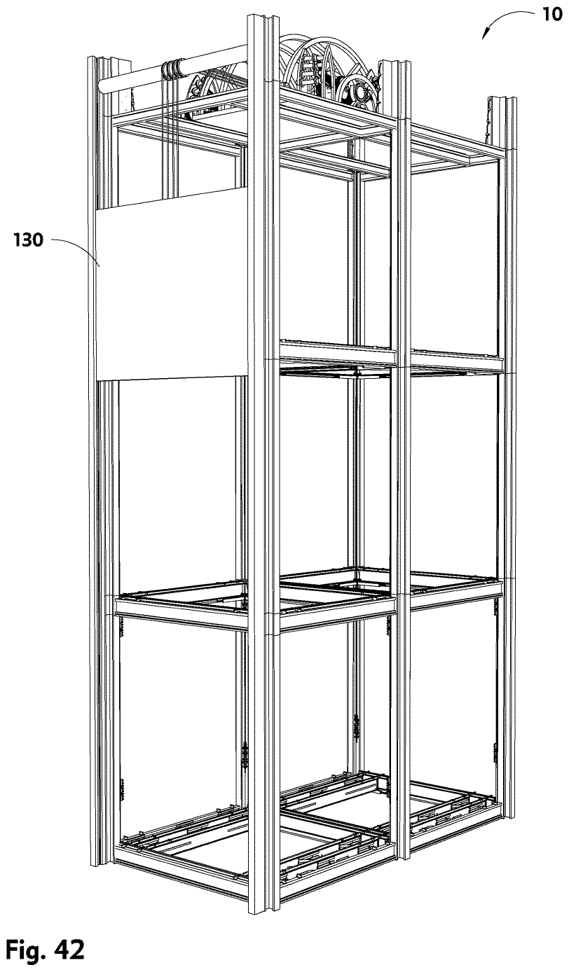

At the top of the view is a 3-axis structure and 3-axis hoist 10 in combination with a cargo ship. A counterweight 130 is shown to orient you to FIG. 42.

Two barges are used to keep the cargo frame cargo ship 24 from listing. This is my method to enable larger than normal cargo transfers at sea or another body of water. Each cargo frame 40 which stows 16 series 1 freight containers 226 moves 576,000 kg, or 1,269,920 lbs worth of freight—not including the weight of the frame itself.

With a 20 bundle cargo frame barge, 26 that works out to 11,520,000 kg, or 25,398,400 lbs!!!

It would be very sad to see such cargoes go to the bottom of the sea.

Having two barges flank a vessel and move their cargoes in concerted fashion prevents the fiasco just mentioned.

This is why, and where, the lobster claws 500 shine. With 40 claws per barge, they can get the job done. By grabbing hold of the lobster claw clamping rods 504 two barges may convey such incredible amounts of cargo-all in one concerted action!

While this method of stabilizing a ship is presently concerned with the above problem, it works for nearly any size vessel, so long as all three vessels are positively, structurally attached.

There is another problem with moving this magnitude of weight. If left to roll off the cargo frame cargo ship 24 without easing the gravity loads, the barge would capsize no questions asked. However, the design of the lobster claw clamping rods 504 has greater utility than just something to grab and hold on to.

To borrow from our first responder friends, firefighters are always at the ready. In an instant, they'll drop a bowl of beans, grab the fire pole, and descend down to the engine floor and rush to save you.

But what is going on here?

Friction from their hands prevents their free fall. Similarly, lobster claws 500 have thumbs 536 and fingers 538. They can grip the lobster claw clamping rods 504 just as a firefighter descends a fire pole.

In this way, the cargo frame barges 26 may slowly descend into the water, finding their final displacement. After the barge is settled, the cargo frame cargo ship 24 extendable and retractable structural outriggers 526 begin pushing away from the ship until they are fully stretched out.

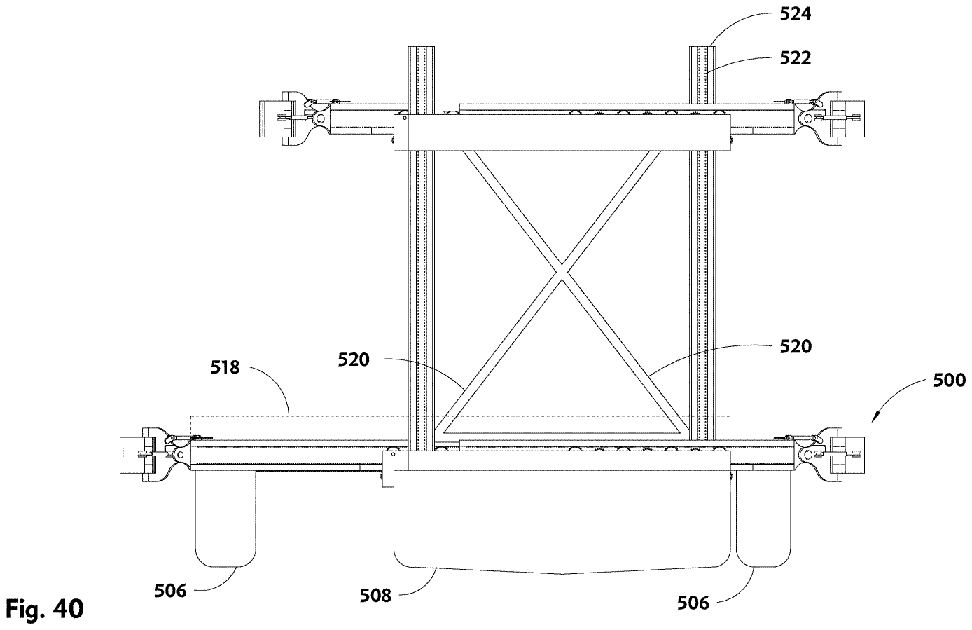

Now, both outer hulls 506 are extended and provide added stability to the barge. Reference FIG. 40.

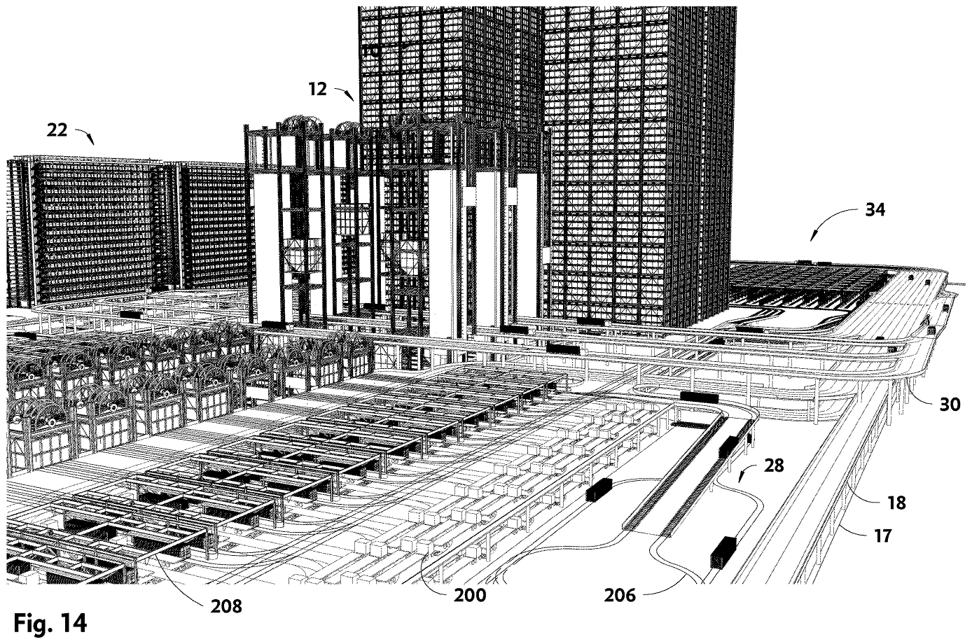

FIG. 14 shows a low-aerial perspective view of a truck transshipment yard 34 at lower left and middle, several semi-truck queueing towers 22 in the left rear, a bulk silo and 3 axis hoist 12 in the middle of the view, with the 3-axis hoist structure and 3-axis hoist 10 in the middle right. A freight car transshipment yard 34 is shown off to the lower right. In the right foreground, a freight purgatory 28 is shown.

Semi-trucks 226 enter the semi-truck queueing area 200 and wait for instructions to enter the proper semi-truck spreader frame 208. In this view, the semi-trucks will turn left and await a spreader to load their truck. Customs may visit each truck for their papers.

For containers not truck-bound, sets of rails lead to the rail transshipment yard 34 at right. Rail carts loaded with series 1 freight containers 222 that missed a pickup are bound for freight purgatory 28. Several containers on carts are shown motoring to or from purgatory. Wireless control bollards and signal lights 33 communicate with the rail cart 206 control box 424.

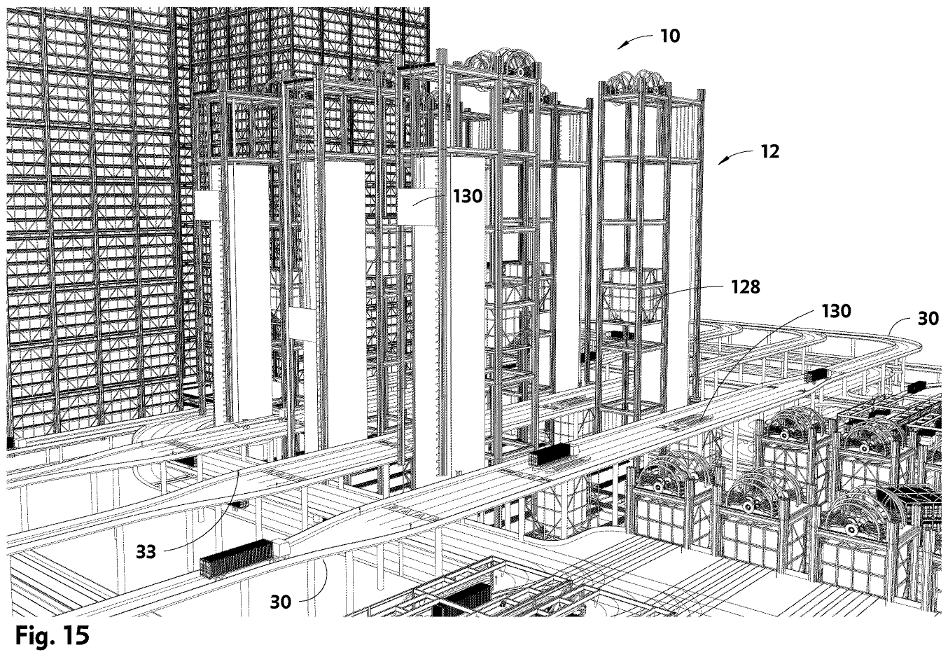

Slicing through the view is the third level bulk platform 30. This shows how easy dropping off bulk goods can be. The goods are dropped directly into the bulk-cargo silo cargo frame 128. Also see FIG. 15.

This view clearly shows the massive throughput of cargo possible with the system for cargo transport.

It is a multi-level port.

FIG. 15 shows an eye-level perspective view of a truck transshipment yard 34 at lower right, six bulk silos and 3axis hoists 12 in the middle of the view, and a 3-axis hoist structure and 3-axis hoist 10 on the left.

The bulk drop 68 and semi-truck guide bumpers 133 are shown on the third level bulk platform 30. Wireless control bollards and signal lights 33 communicate with semi-truck 226 drivers.

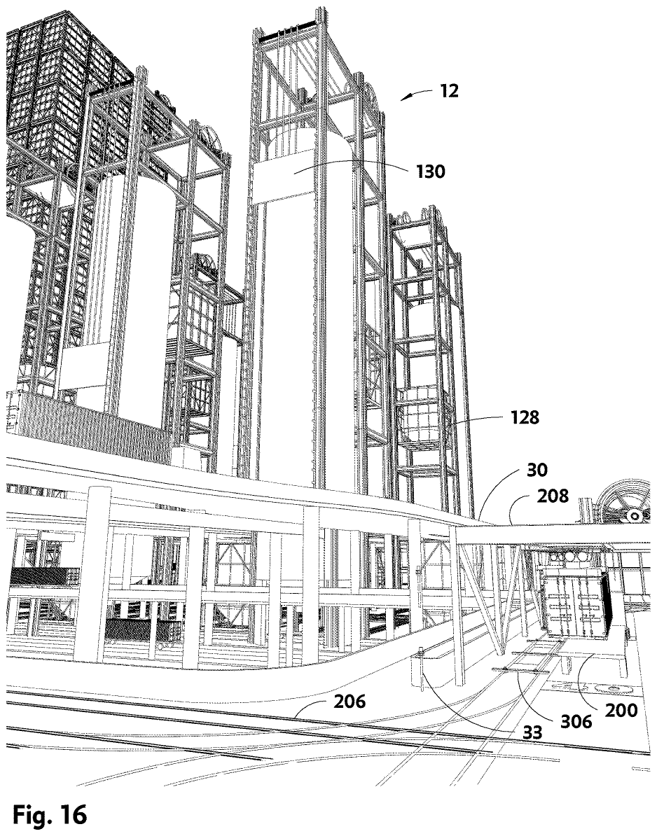

FIG. 16 shows an eye-level perspective from the second-level port platform 18 looking up to six bulk silos and 3-axis hoists 12 in the middle.

At lower right, a series 1 freight container 226 is being hoisted onto a semi-truck 220, under spreader frame 208. Third-level bulk platform 30 cuts through the middle of the view where bulk-cargo silo cargo frame 128 is being lifted to the top of the bulk silo and hoist 12. There it will use retractable, extendable roller beams 706 to motor over the silo and drop its load.

Counterweights 130 are shown, easing the load on the hoist.

FIG. 17 depicts an eye-level perspective view of a sky-high 3-axis structure and 3-axis hoist 10. Just imagine the storage potential.

At the bottom of the view, a rail cart loaded with series 1 freight container 222 motors to a freight car transshipment yard 34. One set of rails 206 below shown below going in two directions; one goes to the freight car transshipment yard 34 and the other is the return loop to the semi-truck transshipment yard 36.

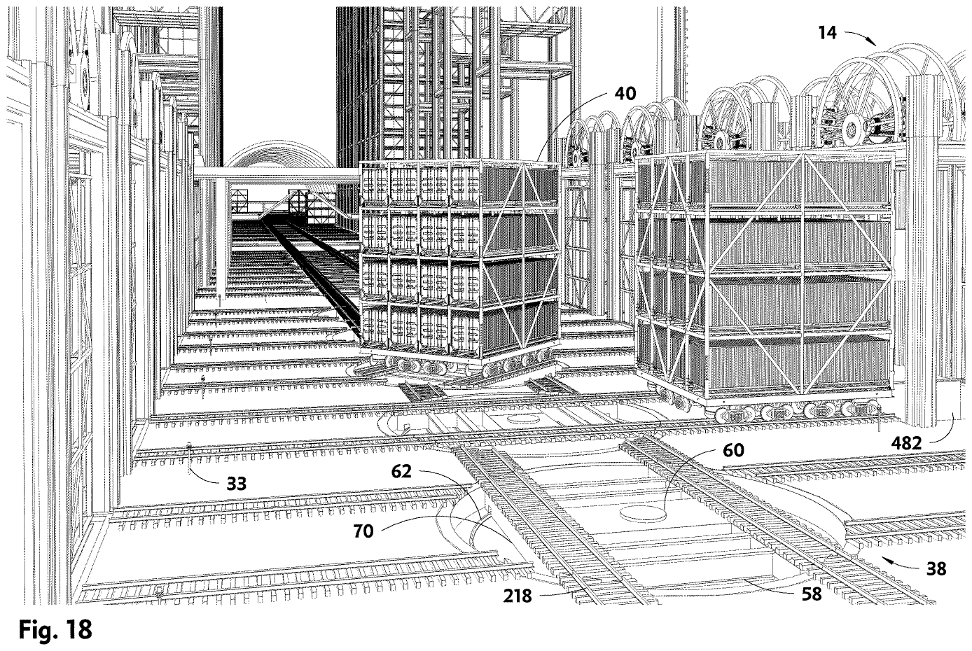

FIG. 18 shows a perspective view of an empty cargo frame turntable 38. The central spine 21 runs right between the two sets of rails 218.

At the foreground, a motorized pivot 60 enables a fully loaded cargo frame 40 to turn 90 degrees. Because there is space between the 3-axis hoists 14, pivoting rail bogies 308 are not required. Two connected bridges 70 support two sets of rails 218. They are braced with brace beams 58.

At center, a pit rail 62 is shown in pit 66.

At left, wireless control bollards and signal lights 33 are placed to receive information from control boxes 424 in cargo frames 40.

At far right, an elevator pit 482 is shown for the 3-axis hoist structure and 3-axis hoist 10 below ground level 17. This allows the second and fourth level of cargo frame 40 to be reached.

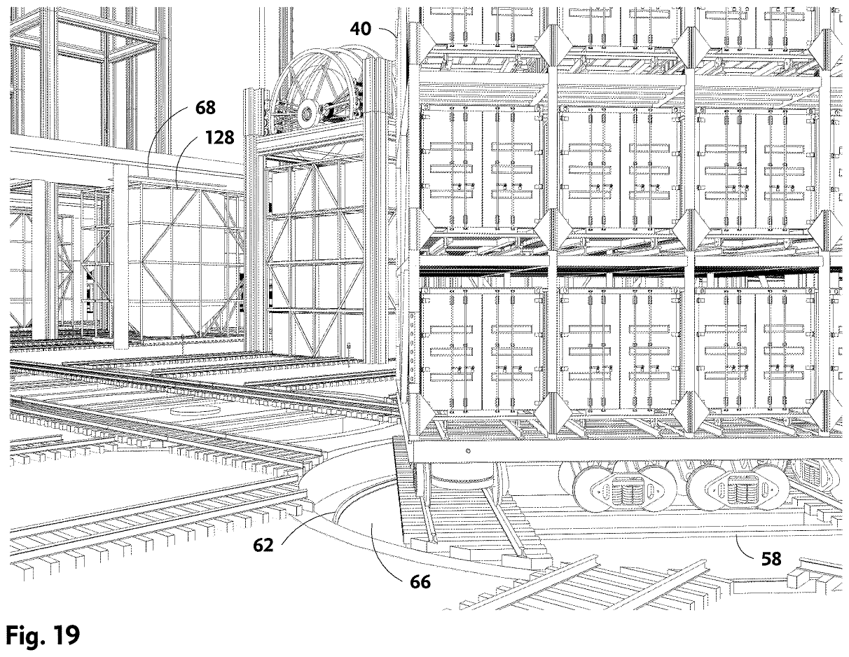

FIG. 19 shows an eye-level perspective view of a loaded cargo frame turntable 38.

At center, a pit rail 62 is shown in pit 66.

To the level we can view how the bulk drop 68 operates with a bulk-cargo silo cargo frame 128 waiting for cargo.

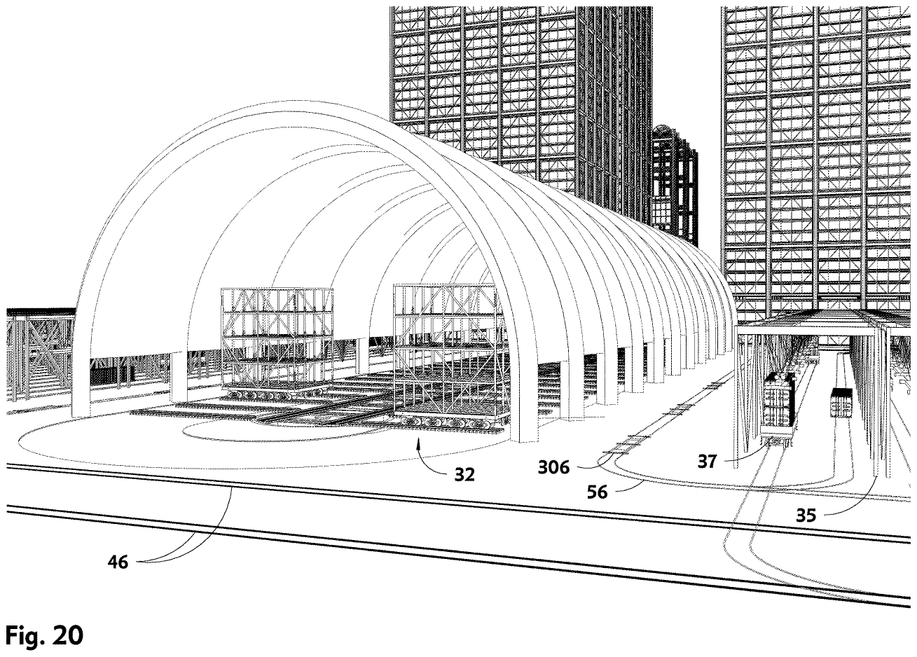

FIG. 20 shows a perspective view of a cargo frame maintenance yard 32 and freight car transshipment yard 34. The maintenance yard is aligned to the central spine 21 and is doubly loaded as elsewhere in the port 48.

At right, we see a freight car spreader frame 35 and a fully loaded freight well car 37. The return loop 56 for rail carts 306 is shown with several carts on their way back to the semi-truck transshipment yard 36.

3-axis hoist structures and 3-axis hoists 10 are located in the rear for context.

In the foreground, access rails from outside the port 46 enable hinterland freight dispersal via rail.

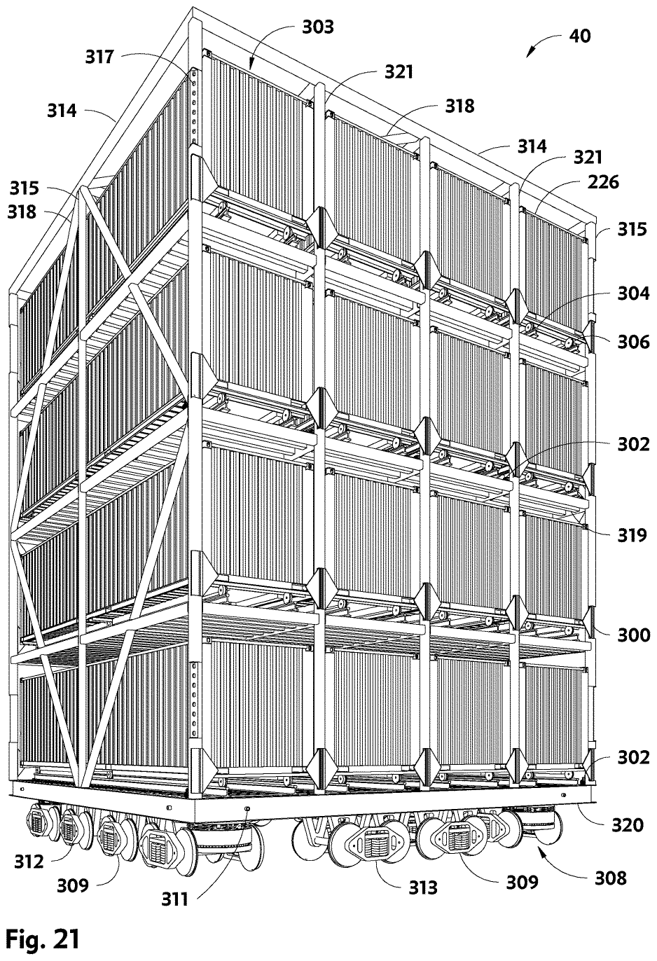

FIG. 21A perspective entrance view of a fully loaded 16 series 1 freight container 226 cargo frame 40. A cargo frame enlarged corner column 315 provides space for specialized corner castings with corner twist lock rack slots 317 to fit and provide sufficient structural strength to lift with 3-axis hoists 14. At the entrance, enlarged cargo frame columns 321 are utilized to accommodate motorized twist lock flaps 300. The remainder of cargo frame columns 316 are similar to each other in size. Cargo frame beams 314 connect columns and utilize cargo frame joists for each cargo frame bay 303. Cargo frame bracing 318 provides a resilient and stable structure.

Each series 1 freight container 226 rolls in on a rail cart 306 and has its own cargo frame bay 303. One set of rails 304 is set in each cargo frame bay 303.

An electric motor 302 powers the motorized twist lock flaps 300 so that they may open 1930 and close.

At the base of the cargo frame is a cargo frame bottom beam 320 where optical, motion, and distance sensors 311 are placed. Below the cargo frame bottom beams 320 are structurally mounted pivoting rail bogies 308, shortened axle rail bogies 309, and motorized shortened rail bogies 313.

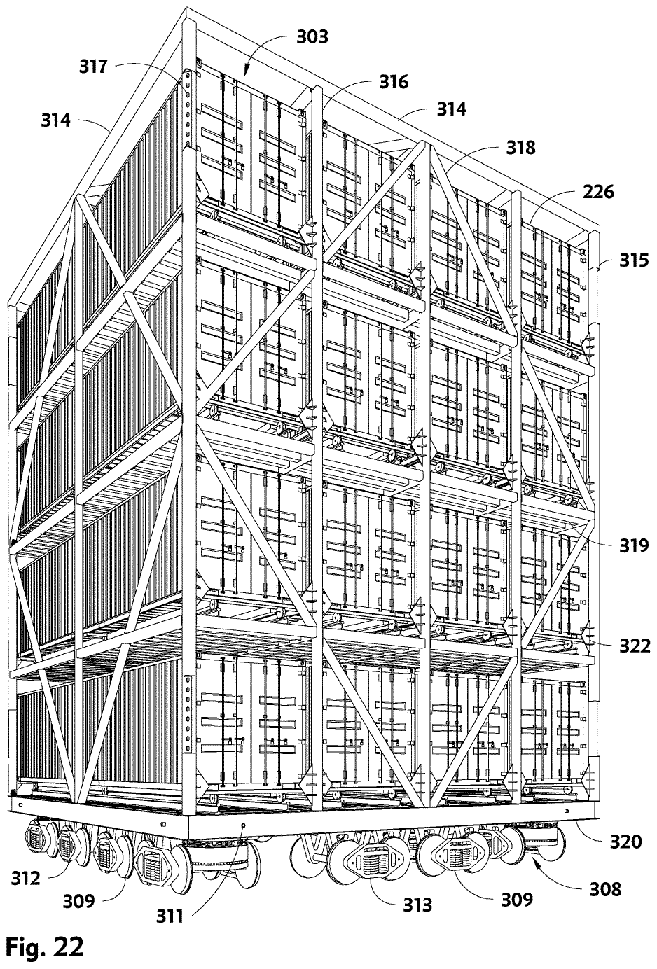

FIG. 22A perspective rear view of a fully loaded 16 series 1 freight container 226

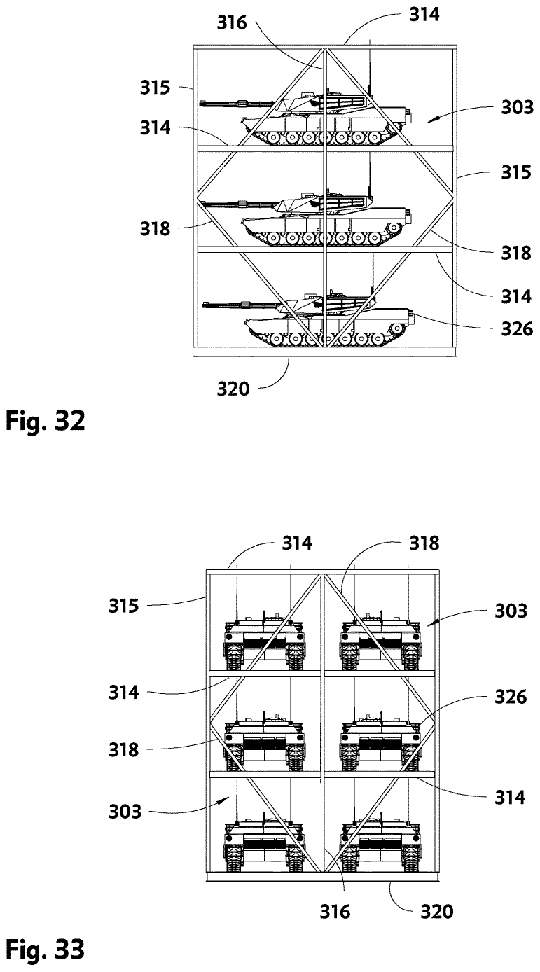

Cargo frame 40 that is substantially similar in description to FIG. 32, except that stationary twist lock flaps 322 are employed and mounted slightly different.

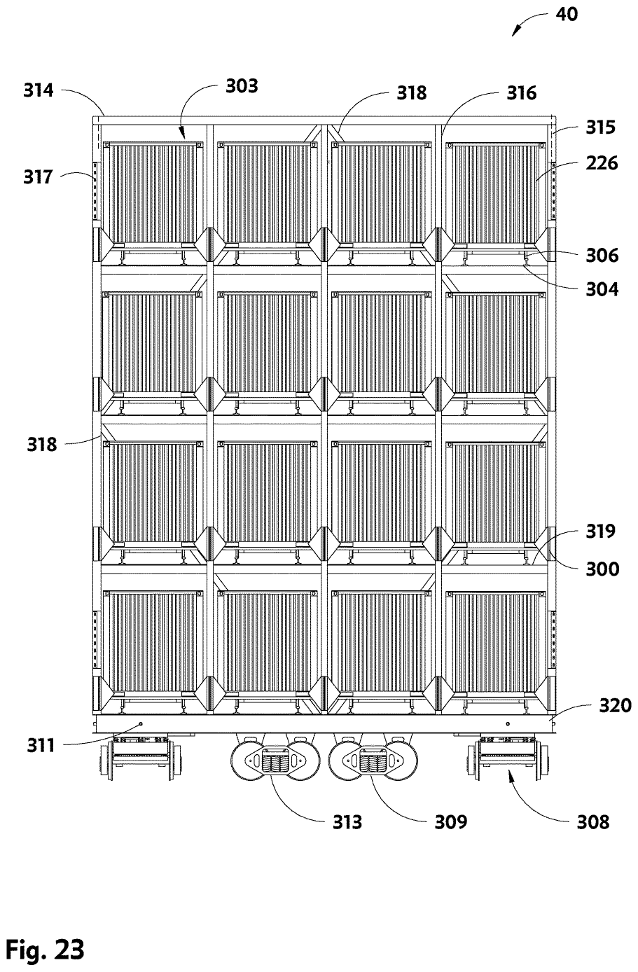

FIG. 23 An elevation front view of a fully loaded 16 series 1 freight container 226 cargo frame 40 that is substantially similar in description to FIG. 21.

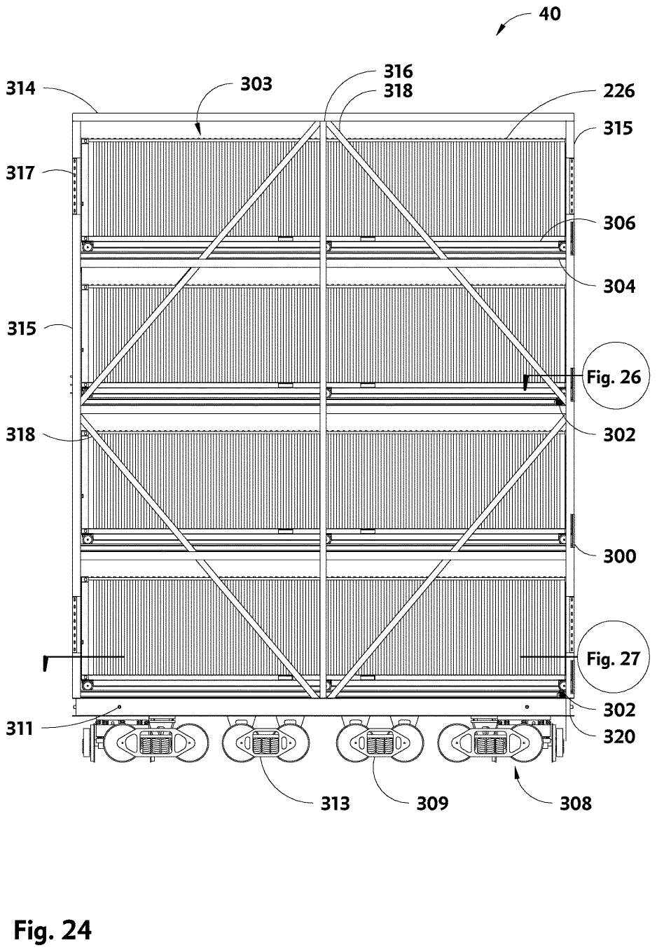

FIG. 24 An elevation side view of a fully loaded series 1 freight container 226 cargo frame 40 that is substantially similar in description to FIG. 21. A electric motor for twist lock flaps 302 is shown at both the first and third levels of the cargo frame.

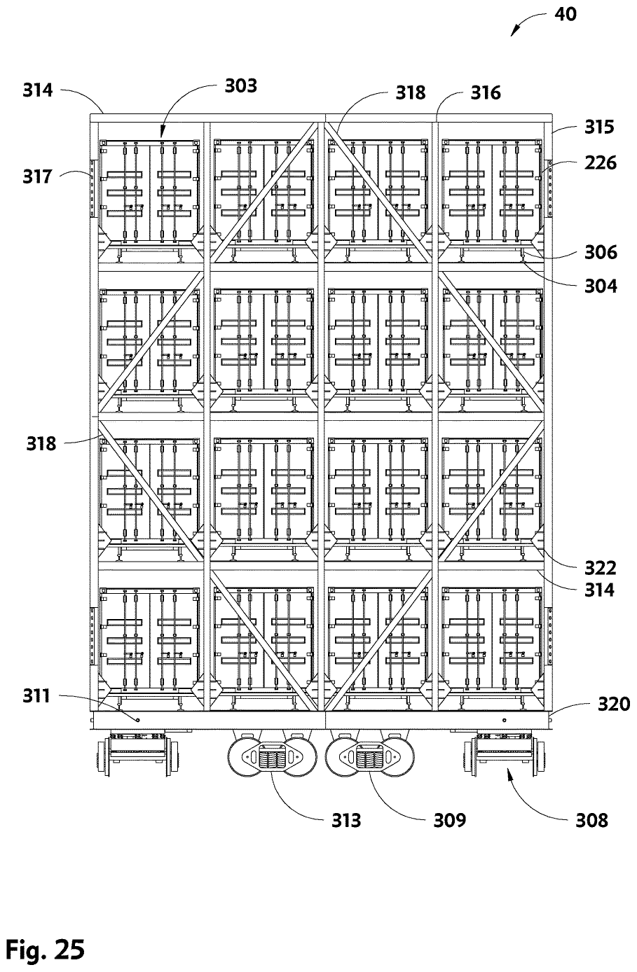

FIG. 25 An elevation rear view of a fully loaded series 1 freight container 226 cargo frame 40 that is substantially similar in description to FIG. 21. The rear side of the cargo frame utilizes stationary twist lock flaps 322.

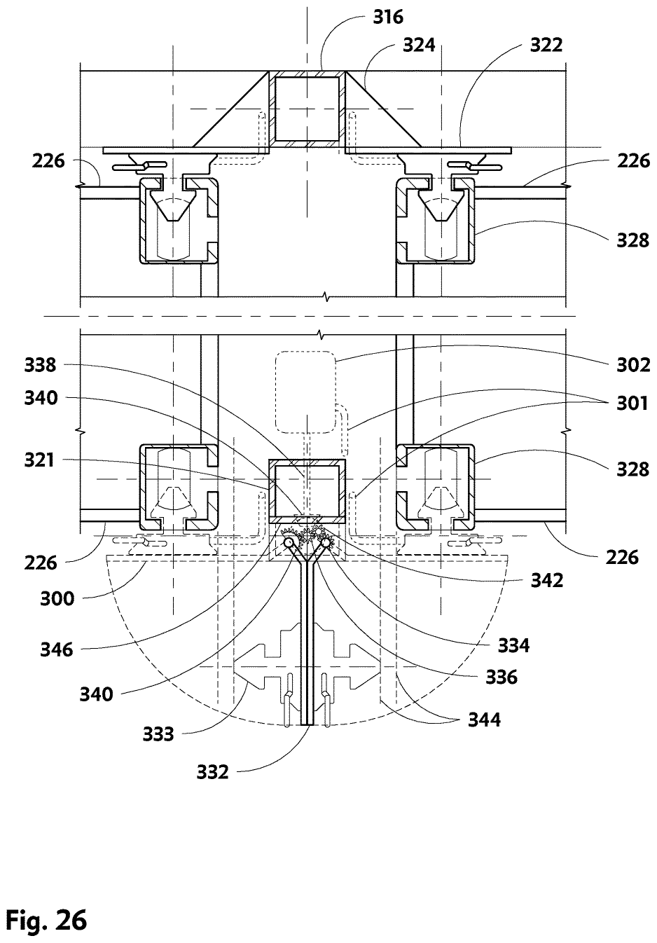

FIG. 26 An enlarged plan detail view of a motorized twist lock flap 300 at the entry of a 16 series 1 freight container 226 cargo frame 40.

At the top of the view is a cargo frame column 316 that provides welding support for structural gusset plates 324. Structurally attached to the stationary twist lock flap 322 is a twist lock 330. This twist lock may be electrically actuated. Either way, the twist lock will engage with the corner casting of series 1 freight container 226 to lock in place.

In the center of the view is an electric motor 302 that operates the motorized twist lock flaps 300 via a drive shaft 338 and bevel gear 340 to transfer the rotation to the twist lock flaps 300. The motor driven vertical axle 336 also has a bevel gear 340 to match and receive such rotation. A control box 424 may be placed in a convenient location to drive the electric motor 302.

The vertical hinges and integral gears at motorized twist lock flaps 334 engage with the motor driven vertical axle 336. A counter rotating gear 342 is provided for coordinated opening and closing.

Clearance of twist lock 330 and series 1 freight container 226 and motorized twist lock flap 300 is dashed and shown in open position 332 for clarity.

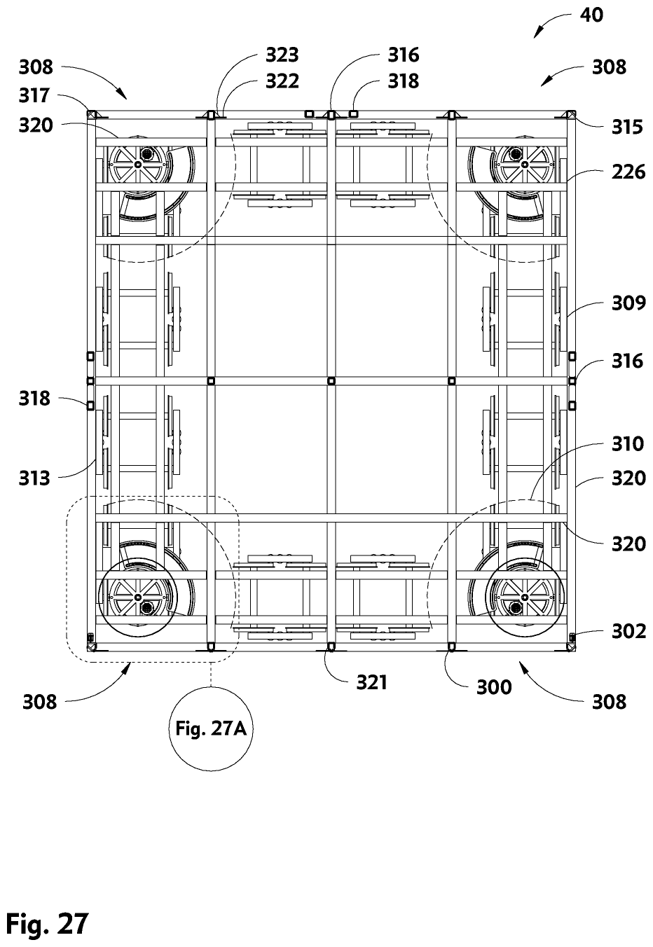

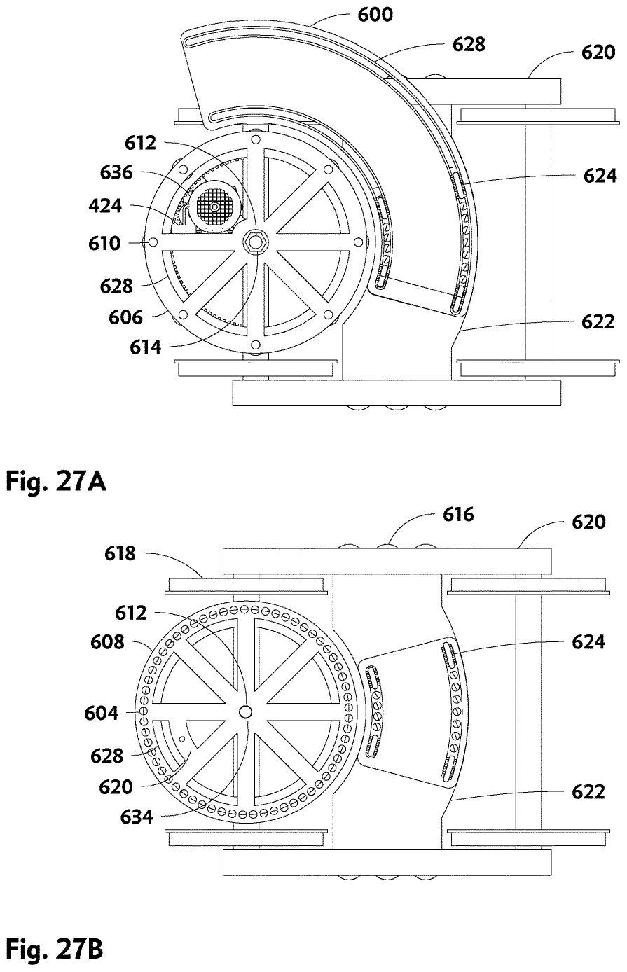

FIG. 27A plan view of a 16 series 1 freight container 226 cargo frame 40 structural framing and rail bogie arrangements.

A cargo frame enlarged corner column 315 provides space for specialized corner castings with corner twist lock rack slots 317 to fit and provide sufficient structural strength to lift with 3-axis hoists 14. At the entrance, enlarged cargo frame columns 321 are utilized to accommodate motorized twist lock flaps 300. The remainder of cargo frame columns 316 are similar to each other in size. Cargo frame beams 314 connect columns. Cargo frame bracing 318 is utilized to provide a resilient and stable structure.

Structurally mounted pivoting rail bogies 308, shortened axle rail bogies 309, and motorized shortened rail bogies 313 are shown in their relative positions. The extent of radius 310 for pivoting rail bogie 308 demonstrates that the rotating operation is possible.

Electric motors 302 are shown here where the specialized corner castings with corner twist lock rack slots 317 block motor driven vertical axle 336 and must be mounted here for that reason.

FIG. 27A shows an enlarged plan view of a upper portion of a pivoting rail bogie 308 is substantially similar to FIG. 27 except that the orientation of the electric motor and driveshaft 636 is more clear, as well as the angled crossbeam bearing plates 626 in relation to the main cross beam 622.

FIG. 27B shows an enlarged plan view of a lower portion of a pivoting rail bogie 308 is substantially similar to FIG. 27 except that the orientation of the drive gear 634 and gear 630 is more clear.

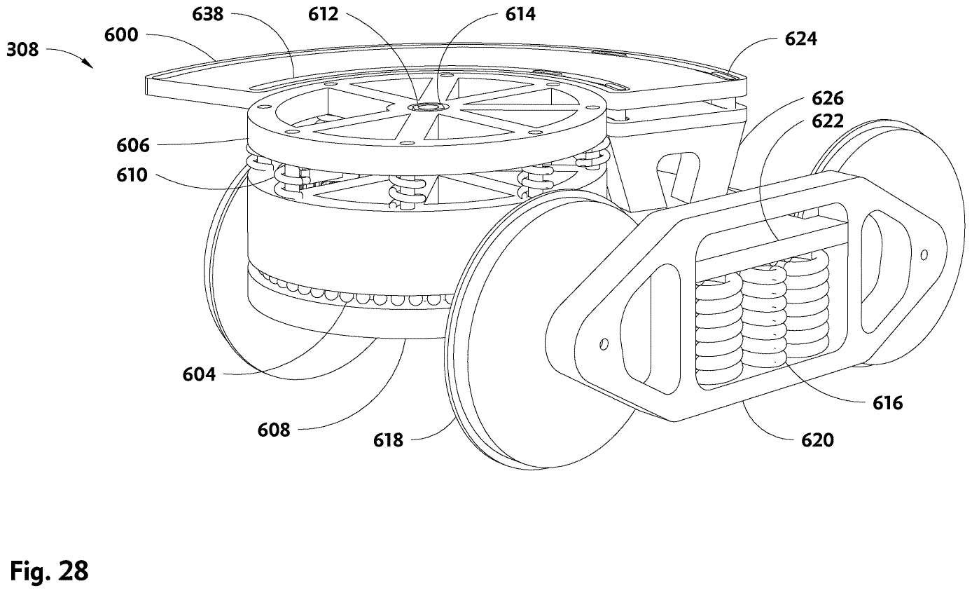

FIG. 28 shows a perspective view of a pivoting rail bogie 308. The bogie pivots along the central pin 612. A locking nut 614 binds an orange slice chassis upper portion 606 to an orange slice chassis lower portion 608.

The orange slice chassis upper portion 606 is structurally mounted to the cargo frame bottom beams 320. The orange slice chassis lower portion 608 is structurally attached to the rail wheel set 618.

When a 3-axis hoist 14 lifts a cargo frame 40, the rail bogie is free to receive instructions to the control box 424 to actuate the electric motor and drive shaft 636. Take note that one slice of the orange slice chassis upper portion 606 is enlarged for the electric motor and drive shaft 636.

Bearings between the orange slice chassis upper portion 606 and orange slice chassis lower portion 608 reduce friction. In this manner, the entire rail bogie rotates with guide rollers 624 by radiused slots 638 in the radiused guide plate 600. Angled crossbeam bearing plates 626 make the movements smooth by sharing the center point of the central pin with threaded rod 612.

Suspension is provided via springs and guide rods 610 between the orange slice chassis 2030 upper portion 606 and orange slice chassis lower portion 608. For the other rail wheel set 618, suspension is provided via the main crossbeam 622 and suspension springs 616.

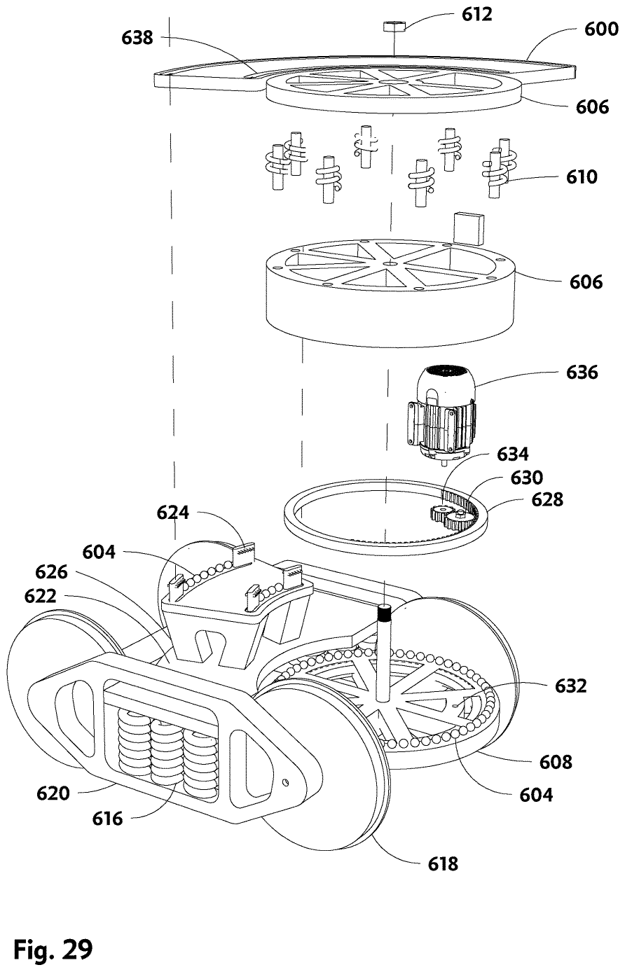

FIG. 29 shows an exploded perspective view from above of a pivoting rail bogie 308 that is substantially similar to FIG. 28, except that a control box 424 and electric motor and driveshaft 636 are shown with a drive gear 634, a gear 630, and a semi-geared ring 628 while demonstrating the pivoting rail bogie's 308 ability to rotate.

Also seen is a slot for a gear bolt 632.

At left bearings in radiused layout 604 are shown.

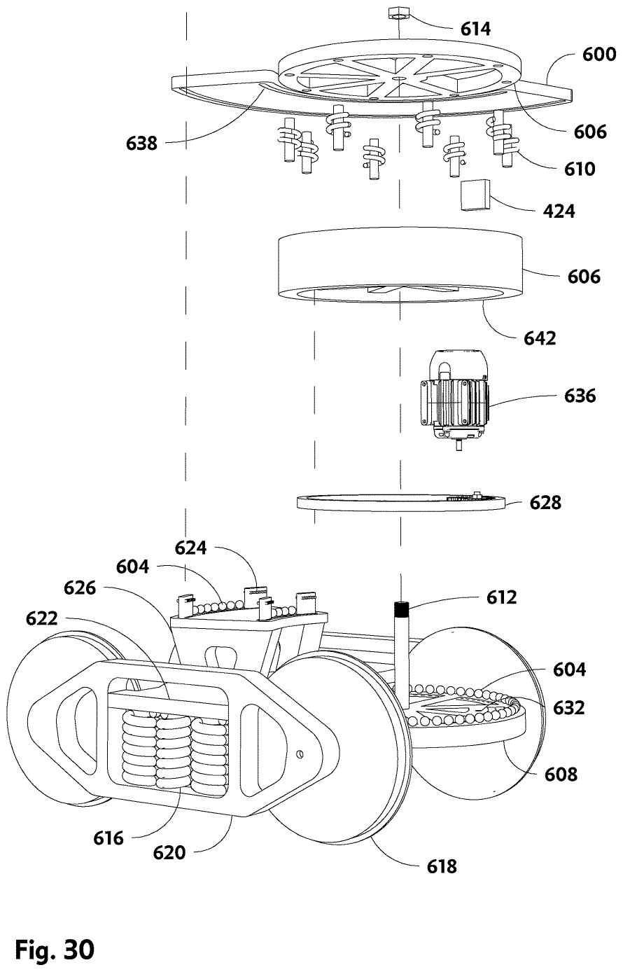

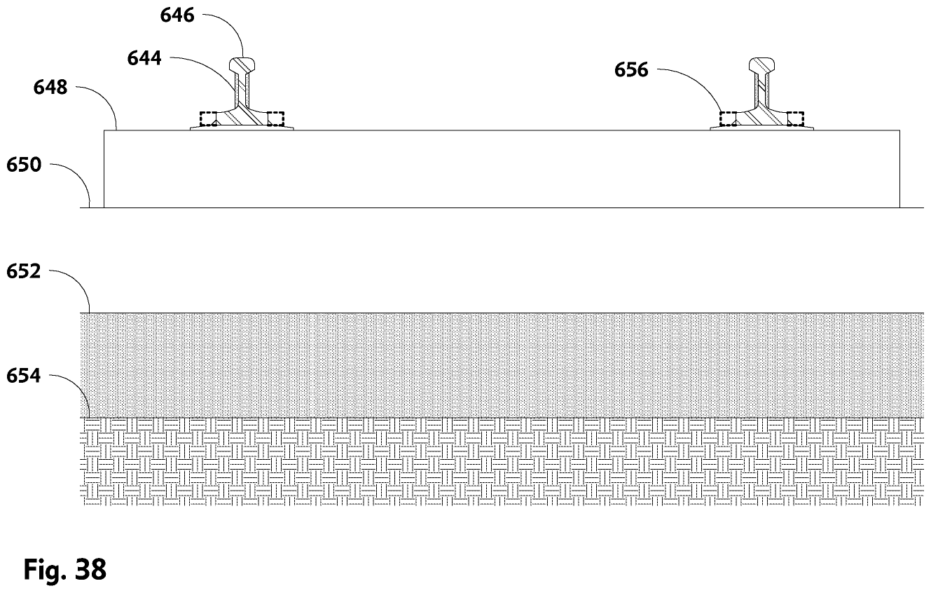

FIG. 30 An exploded perspective view of a pivoting rail bogie 308 from below that is substantially similar to FIG. 38 except that the orange slice chassis upper portion 606 has a semi-geared ring cutout 642 to receive the semi-geared ring 628. A control box 424 and electric motor and driveshaft 636 are shown and demonstrate the pivoting rail bogie's 308 ability to rotate.

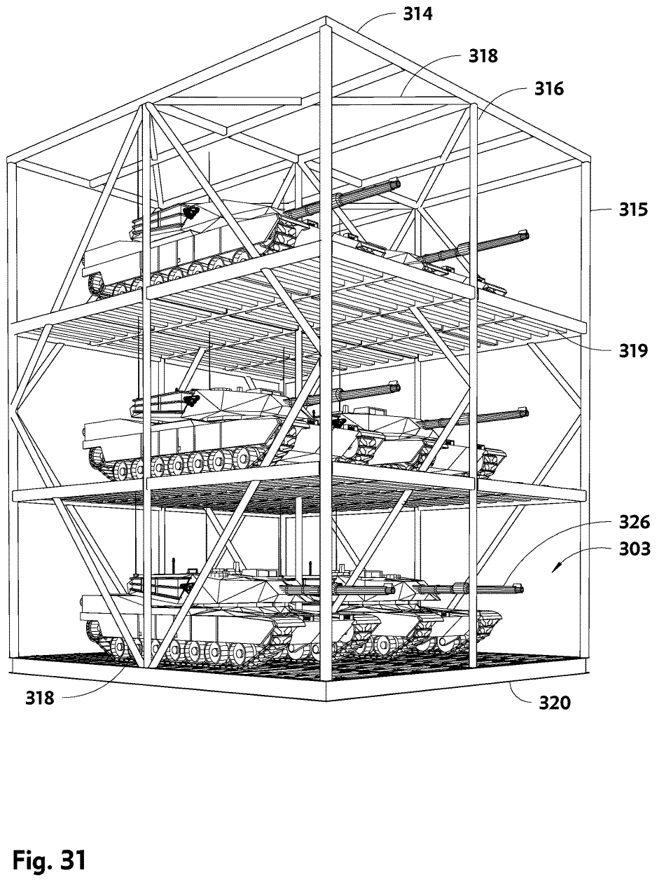

FIG. 31A perspective view of a cargo frame sized to match a 16 series 1 freight container cargo frame wherein the bays are resized to accommodate military hardware. Cargo frame beams 314, cargo frame columns 316, cargo frame columns 315, cargo frame bracing 318, cargo frame joists 319, and cargo frame bottom beam 320 form the basis of this cargo frame 40.

As with all the embodiments shown in this disclosure, you are free to mix and match components to achieve different things. Specialized corner castings with corner twist lock rack slots 317 also could be added.

It is up to my customers how they wish to use the cargo frame 40.

An M1A1 Abrams tank 326 sits in one of six cargo frame bays 303. With a current maximum gross weight rating of 36,000 kg, or 79,370 lbs., a series 1 freight container 226 weighs a little more than half of the tank. The M1A1 Abrams tank weights 57,152.34 kg, or 126,000 lbs. Therefore, two bays may be swapped out for a tank bay. While embodiment shows six cargo frame bays 303, more could be added if tanks were the only cargo intended for this cargo frame.

FIG. 32 shows an elevation side view of a cargo frame sized to match a 16 series 1 freight container 226 cargo frame substantially similar to FIG. 31.

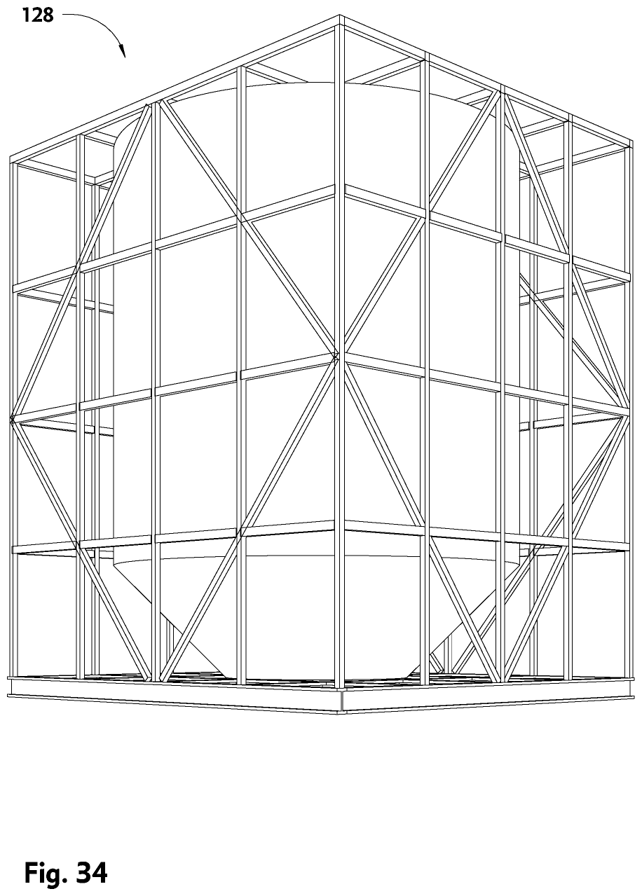

FIG. 33 shows an elevation rear view of a cargo frame sized to match a 16 series freight container 226 cargo frame substantially similar to FIG. 31.

FIG. 34 shows a perspective view of a cargo frame 40 sized to match a 16 series/freight container 226 cargo frame wherein the bay is resized to accommodate a bulk-cargo cargo frame 128.

These containers could house grains, fuel, ore and more.

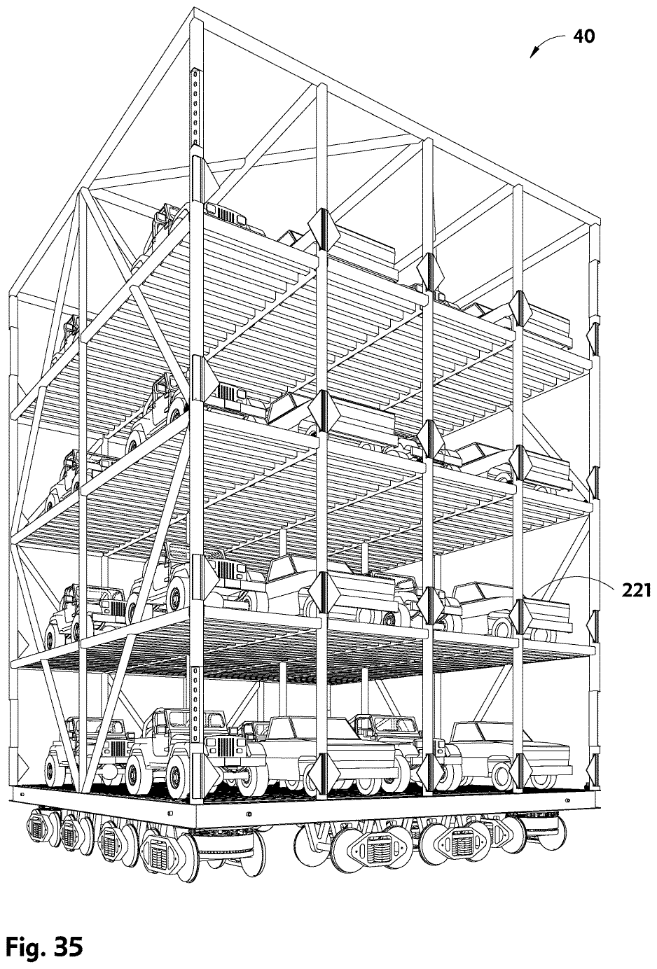

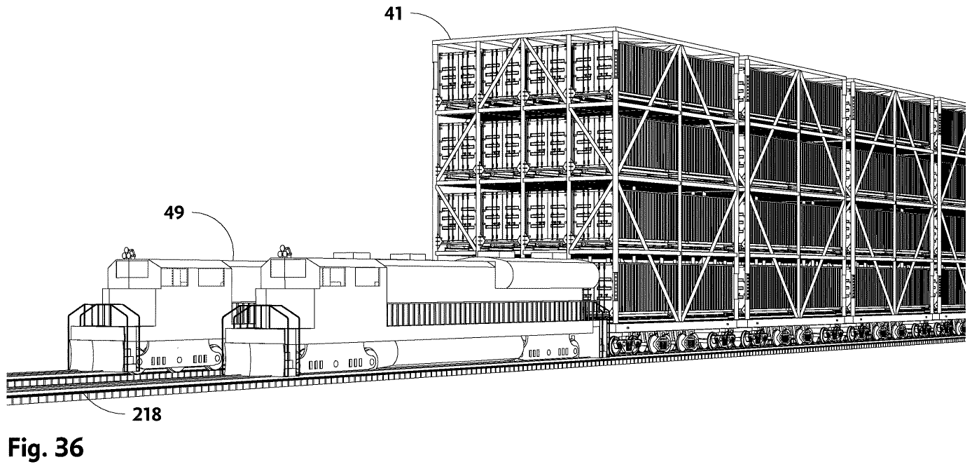

FIG. 35 shows a perspective view of a cargo frame 40 sized to match a 16 series 1 freight container 226 cargo frame wherein the bays are used to transport vehicles 221.

Here, is another example of the cargo frame's flexibility 40.

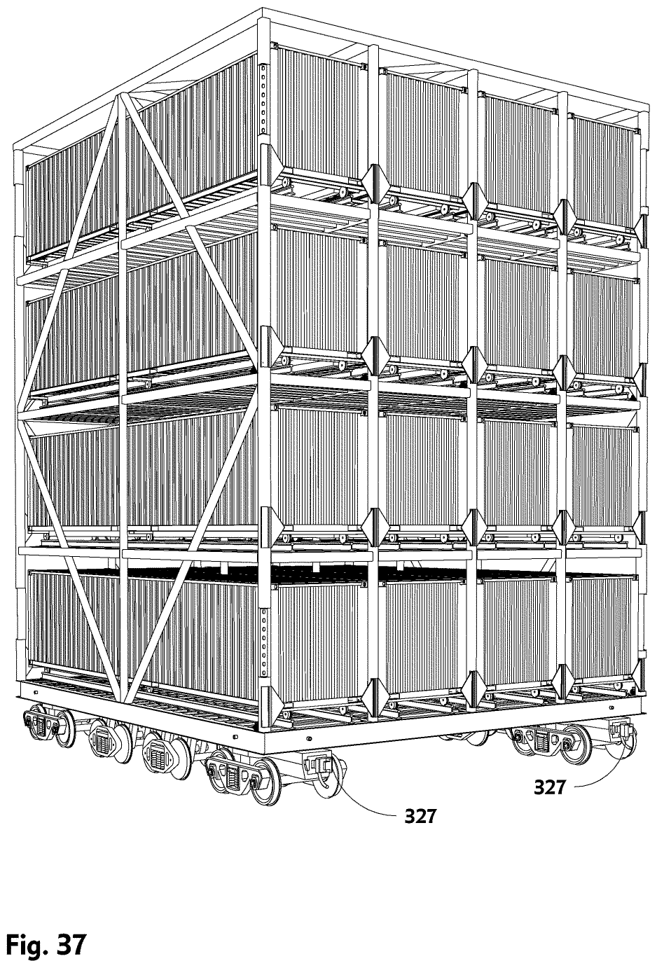

FIG. 36 paints a scene in perspective view with a pair of train engines 49 pulling a plurality of fully loaded 16 series 1 freight container cargo frame rail cars 41. The rail cars are coupled together with bogies as shown in FIG. 37. Two sets of rails 218 are required.

FIG. 37 shows a perspective view of a 16 series 1 freight container cargo frame rail car 41 with coupling 327, for use over two sets of rails 218.

FIG. 38 shows a detail section view of a structurally modified rail 646. Filler steel 644 is scribed and cut to fit the rail profile. This is cheaper than retooling a rail manufacturing assembly line.

Where greater loads are required, the rails can be strengthened as required by following the outline of additional steel 656. Rail ties 648 can be widened and lengthened to meet a great bearing capacity.

The rail tie 648 may rest on an upper ballast 650, which rests on a lower ballast 652, which then bears on compacted subgrade 654.

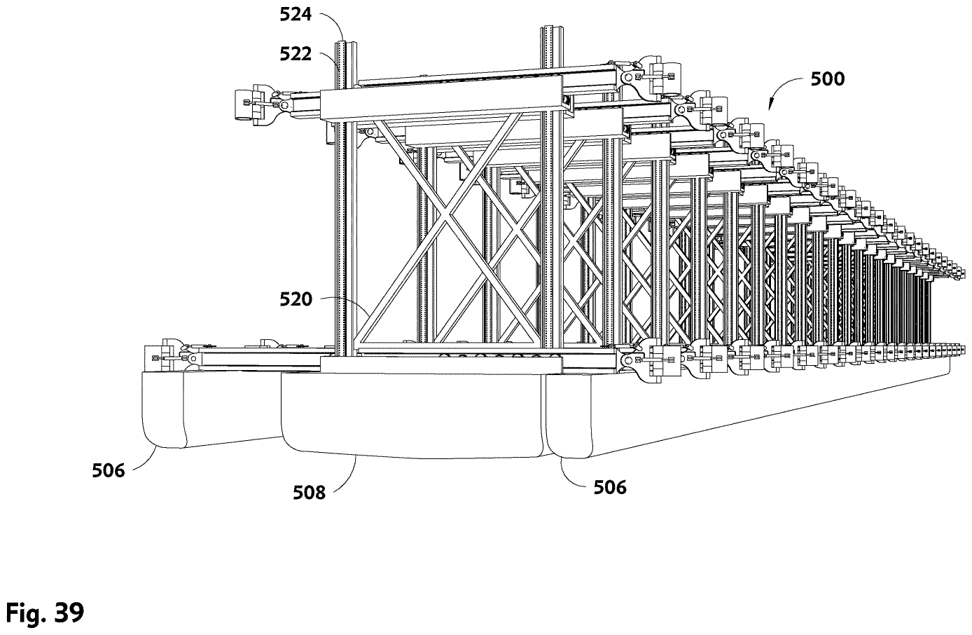

FIG. 39 depicts a perspective view of a cargo frame barge 26. This is largely the same as FIG. 40 but with a 3-dimensional perspective of this industrial piece of equipment.

FIG. 40 shows a section view of a cargo frame barge 26 shows the versatility of an independent, three-hull barge. One outer hull 506 may extend for stability of large freight loads on the barge. The opposing outer hull 506 may retract close to the inner hull 508 to enable encargoing or decargoing. Cargo frame barge columns 524 provide support for upper lobster claws 500.

Lobster claws 500 may be manually adjusted with adjustment holes 522 in cargo frame barge columns 524. As an alternative, it is perfectly prudent to have a mechanized lifting and lowering capability for both the upper and lower lobster claws 500.

As is seen here, when two lobster claws 500 grip a lobster claw clamping rod 504 there is enough distance between the claws to provide a rigid connection. This will be advantageous for at-sea cargo transfers.

Bracing 520 is shown as required.

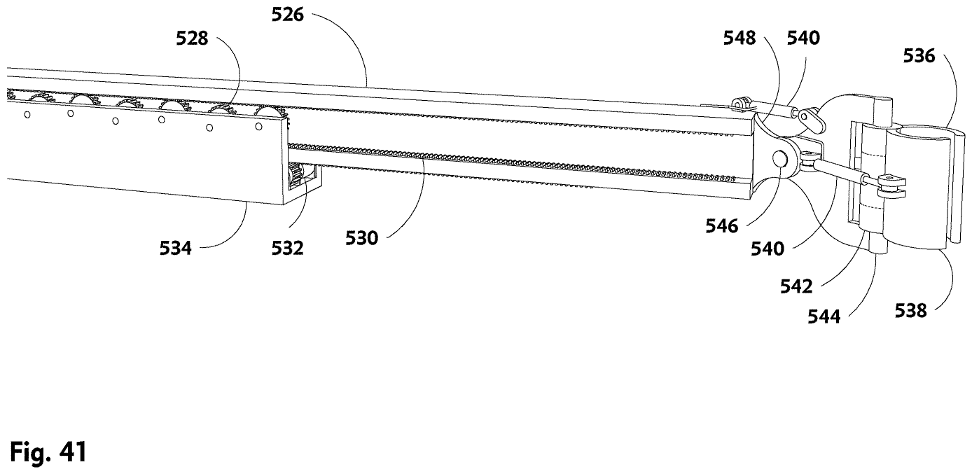

FIG. 41 depicts a perspective view of a lobster claw 500. At left, a lower structural guide beam 534 is outfitted with at least one electric motor and pinion 532. This enables the extendable and retractable structural outrigger 526 to reach out to a lobster claw clamping rod 504. Geared rollers 528 prevent fast movements of the outrigger.

The geared rollers 528 are arranged so that an upper set engages the top flange of the extendable and retractable structural outrigger 526. A lower set of geared rollers 528 engages the bottom flange of the outrigger. In this manner, the outrigger will experience very little slop.

At the right, in this particular embodiment, the lobster claw 500 is angled relative to the extendable and retractable structural outrigger 526. This occurs because the columns on the cargo frame barge 26 align with the centerline of the cargo frame cargo ship 24 columns.

By angling as shown, the lobster claw 500 may grip a lobster claw clamping rod 504 on a cargo frame cargo ship 24.

Bearings and pin 546 enable the claw portion to mechanically rotate via a hydraulic piston 540. An armature with pivot rod 544 provides structure for the hydraulic piston 540 and lobster claw finger 538 and lobster claw thumb 536 to operate.

This may be guided by a longshoreman or a by a control box 454.

Because this embodiment has an angled armature 544 and lobster claw thumb 536 is shorter than the lobster claw finger 538. This allows a lobster claw 500 to grip a lobster claw clamping rod 504 without damaging the lobster claw clamping rod recess 505. Or a lobster claw dock piling 502.

Both the lobster claw finger 538 and lobster claw thumb 536 pivot the armature 544 with a lobster claw pivot section 542. The pivot section looks similar to a door hinge.

FIG. 42 depicts a perspective view of a freestanding 3-axis structure and 3-axis hoist 10. At the top of the view is a 3-axis hoist 14 which moves on a platform to be interlocked with four corner hoist mechanisms at each column for 3-axis hoist structure 11. A counterweight 130 creates a smoother hoisting action.

The counterweight 130 may be used for each vertical bay of the 3-axis structure and 3 axis hoist 10; in this simplified example, two bays could be accessed. This reduces the number of counterweights commonly found on other hoists and elevators. It could be said that the counterweight ought to move like the rolling platform for cargo frame hoist 734.

Having given great consideration to this, it negates the effect of 20 bundles of decargoing at the same time on both sides of a ship.

To put it plainly, saving weight on counterweights adds time to decargoing.

While manually threading of hoist cables 712 is shown here, mechanical threading is also contemplated. Stevedores may walk along a catwalk between flanking 3-axis structures and 3-axis hoists 10 to access the rolling platform for cargo frame Hoist 734.

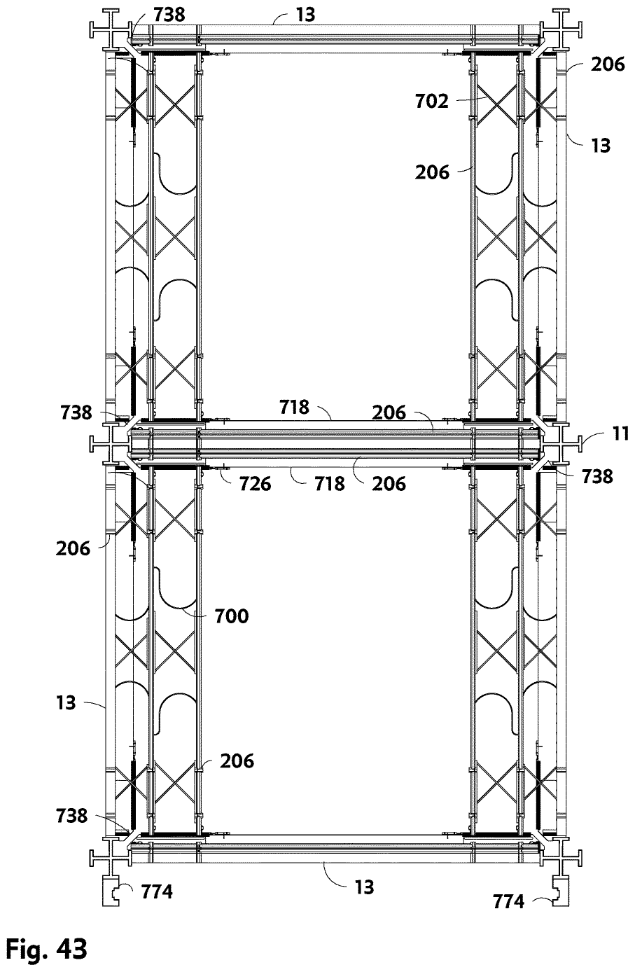

FIG. 43 presents a lower plan view of a 3-axis structure and 3-axis hoist 10. The top portion shows a notch in structural rolling plates 738 for the corner hoist lift mechanism 714. This enables the corner hoist lift mechanism 714 to traverse the y-axis with a load.

Collapsible braces and bearings 702 keep the retracting and extending beams 706 stable, Upright, and parallel to each other. By doing so, one set of rails 206, which is mounted to the beams, may align to the matching pair of rails in the next bay.

At the lower portion of the plan, a guide structure 774 is shown. This structure keeps the counterweight 130 in place.

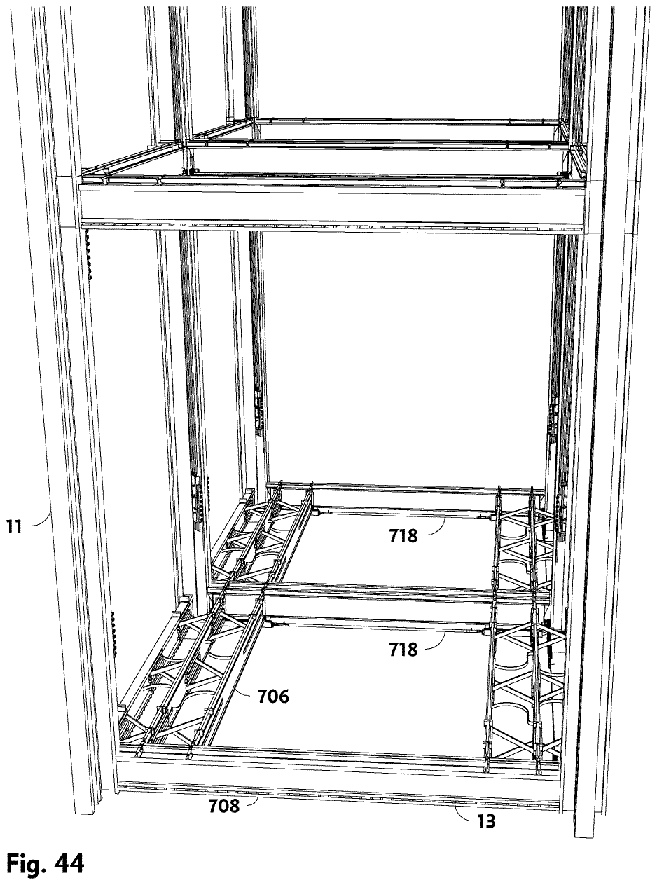

FIG. 44 shows a lower perspective view of a 3-axis structure and 3-axis hoist 10 for orientation purposes. Please see the following Figs.

One item that is well-seen here is the structural rolling plate 718 that enables the retracting and extending beams 706 to perform their desired function.

The corner hoist lift mechanisms 714 are shown in a lowering state.

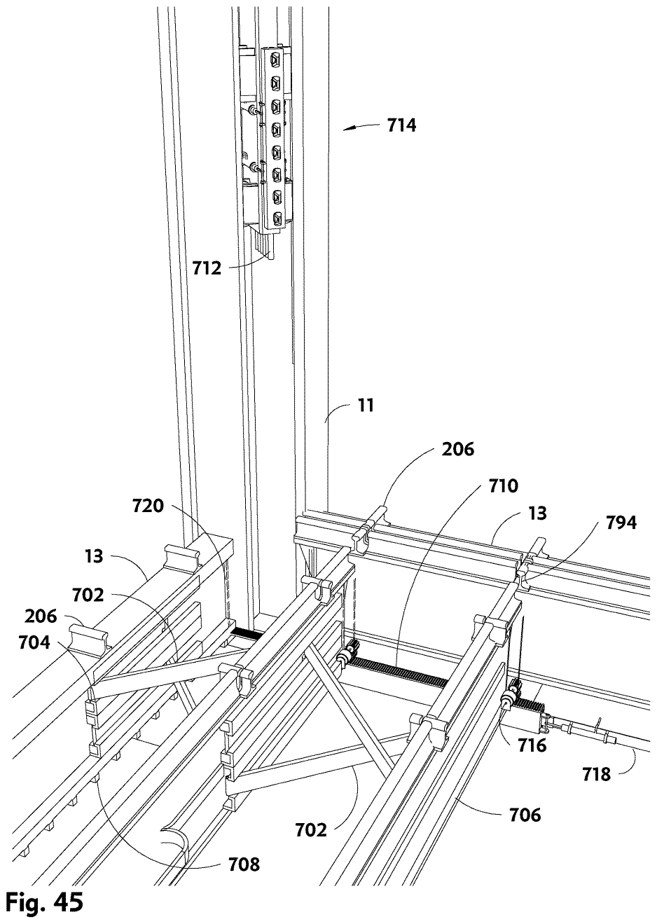

FIG. 45 is a lower perspective view of a 3-axis structure and 3-axis hoist 10 where the retracting and extending beams 706 are in open position.

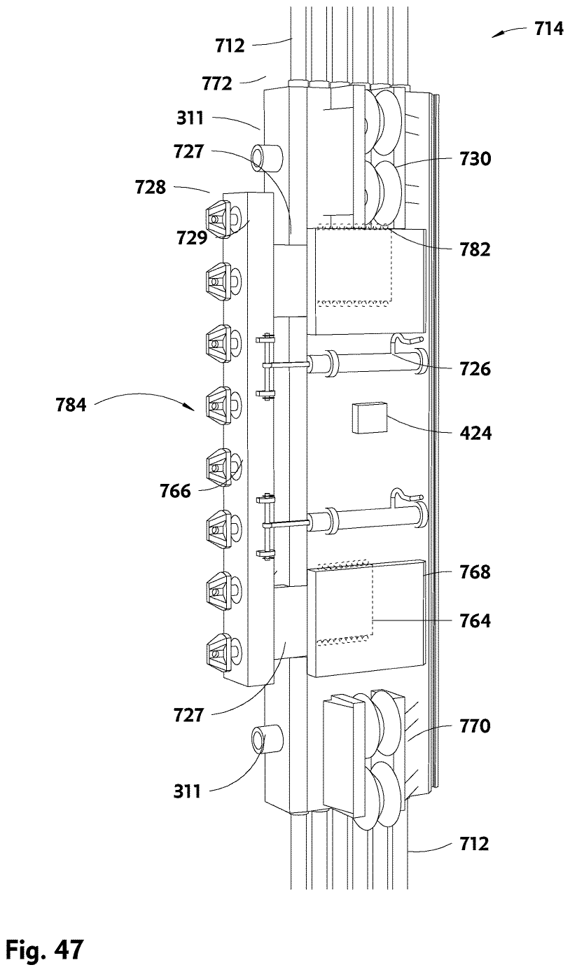

Starting at the top of the view, we see a corner hoist lift mechanism 714 with hoist cable stops 712 at the base. This is the lower corner hoist lift mechanism. You can see the twist lock rack 784 and how it may extend out from the center of the column 11 towards the bay. Reference FIG. 47.

Structural stiffeners 720 are shown dashed so we may view beyond.

My experience as an architect has proven the value of the phrase “field verify.”

The adjust to fit slot 794 is a good example of where this applies. The ends of the retracting and extending beams 706 stop at the face of the corner column 11 for a 3-axis structure 23. This leaves a gap. The gap should be field verified and welded to the transverse retracting and extending beams 706 retracting and extending beams 706. Structural stiffeners should be employed.

The electric motor and pinion 716 enable the retracting and extending beams 706 to move to position to align with one set of rails 206. Reference the pivoting rail bogie in FIG. 28. Both the pivoting rail bogie 308 and the corner hoist mechanism 714 work together to enable x, y, and z-axis movements.

If instructions are sent from the control box 494 for a cargo frame 40 to change direction from an x-axis to the y-axis, the corner hoist lift mechanism 714 will engage the specialized corner castings with corner twist lock slots 317, lift the cargo frame, and send further instructions to pivot the rail bogies to the appropriate direction.

The cargo frame 40 can then move to a different bay, enabling a higher or lower cargo frame 40 to reach its destination.

WE now have a 3-axis structure and 3-axis hoist 10!

One interesting feature is that the cargo frame 40 can remain in place on the retracting and extending beams 706, and the corner hoist lift mechanisms can disengage the specialized corner castings with corner twist lock slots 317 and attend to a different bay.

To lock the cargo frame 40 in place, column mounted an extendable, pivoting twist lock rack 784 engages the cargo frame (not shown). This would happen at each specialized corner castings with corner twist lock slots 317.

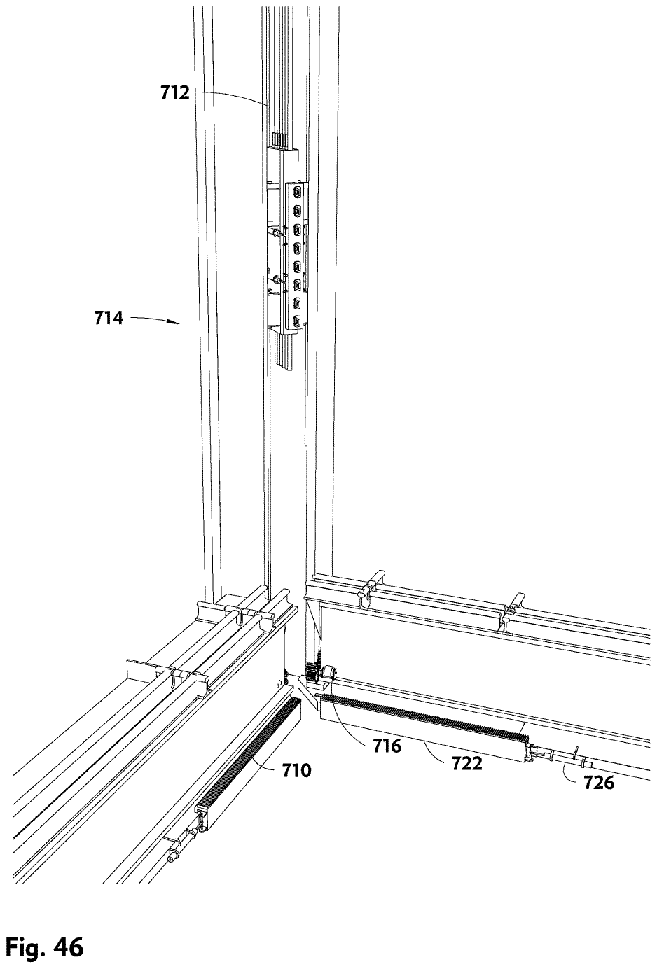

FIG. 46 shows a lower perspective view of a 3-axis structure and 3-axis hoist 10 where the retracting and extending beams 706 are in closed position.

Racks 710 are mounted on c-shaped structural channels 722. This enables the retracting, extending mechanized roller beams 706 to roll out from a closed position via an electric motor and pinion 716. A slot in structural rolling plates 738 must be bridged so that a cargo frame may traverse in the x-axis or y-axis. If a call for the z-axis occurs to the control box 424, the retracting, extending mechanized roller beams 706 will retract when possible.

For example, if a cargo frame 40 is sitting on the retracting, extending mechanized roller beams 706, this will not occur. But if the corner hoist lift mechanisms 714 engage the cargo frame and begin to lift the cargo frame 40, the roller beams will retract after receiving instructions from the control box 424.

FIG. 47 shows a perspective view of an isolated corner hoist lift mechanism 714. Starting at the top we see hoist cables 712 which thread through the chassis 772. An optical, motion, and distance sensor 311 is utilized to identify a cargo frame 40 the specialized corner castings with twist lock rack slots 317.

A twist lock rack 784 is pushed or pulled via a hydraulic piston kg. Mounted to the chassis 772 is a control box 424 for sending instructions to the various components of the corner hoist lift mechanism 714. Sliding structural arms 727 guide the twist lock rack. Roller pins in a notch in chassis 782 enable this function. Structural guide plates 768 are mounted to the chassis 772. The twist lock rack extends to a cargo frame 40.

A reserve structural length 764 is shown to provide shear capacity when the corner hoist lift mechanism 714 rises or lowers.

Depending on whether the corner hoist lift mechanism 714 serves the upper specialized corner castings with twist lock rack slots 317 of a cargo frame 40 or the lower corner castings, hoist cables may continue to the next corner hoist lift mechanism or end with cable stops.

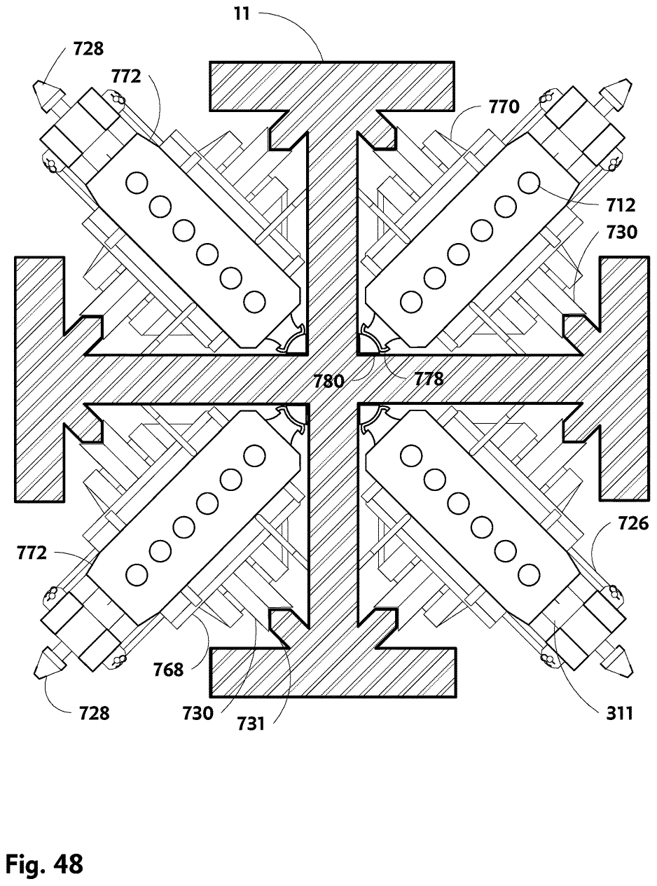

FIG. 48 illustrates a plan view of a corner column 11 for a 3-axis structure 23. The column shape is like two wide flange columns were welded together in a transverse manner.

Having four quadrants each with an open corner, and each serving one bay the corner hoist mechanism 714 has a free and clear shaft to hoist cargo frames. Each quadrant has an insulated electric power line 780 where an electric power rail 778 may derive power. While the overall corner hoist mechanism is controlled by the 3-axis hoist 14, the electrically actuated twist locks 728 and overall twist lock racks 784 require a separate power source for the control box 424.

A chassis 772 of the corner hoist mechanism 714 fills each quadrant of the column 11. The open corners of each quadrant enable the corner hoist lift mechanism to traverse in the z-axis while lifting or lowering a cargo frame 40. Corner guide rail rollers 730 mate with corner guide rails 731.

Hoist cables are shown in the center of the chassis 772. The optical, motion, and distance sensor 311 is pointed to, but is below the cut plane. Refer to FIG. 47 for more information.

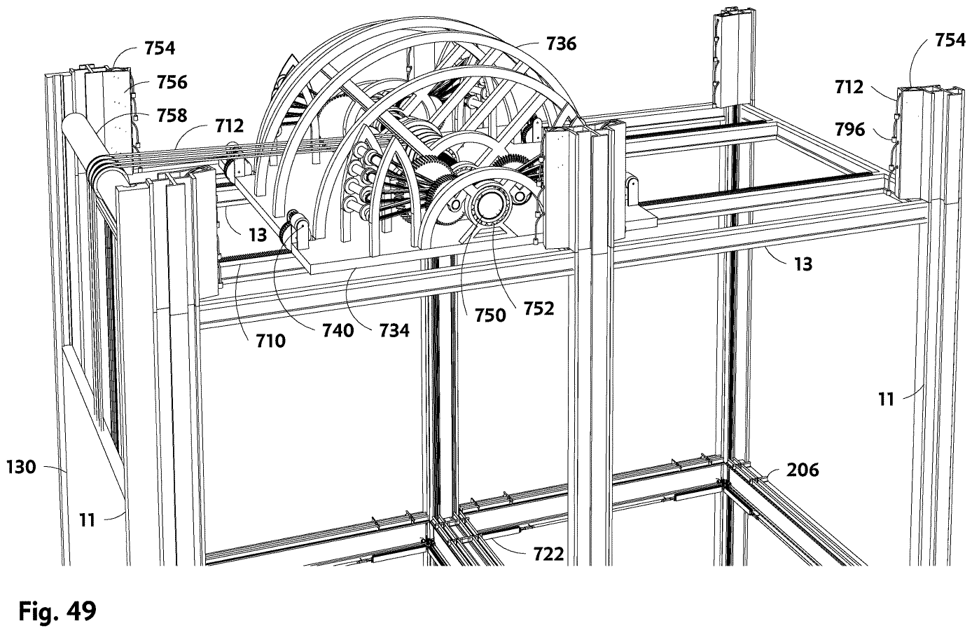

FIG. 49 shows an upper perspective view of a 3-axis structure and 3-axis hoist 10. You may see that the rolling platform 734 enables a lot of possibilities where many bays are desired.

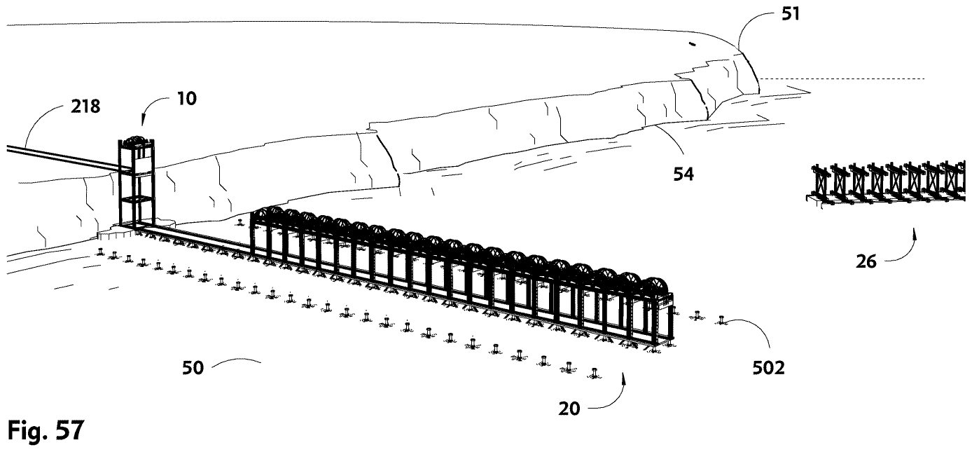

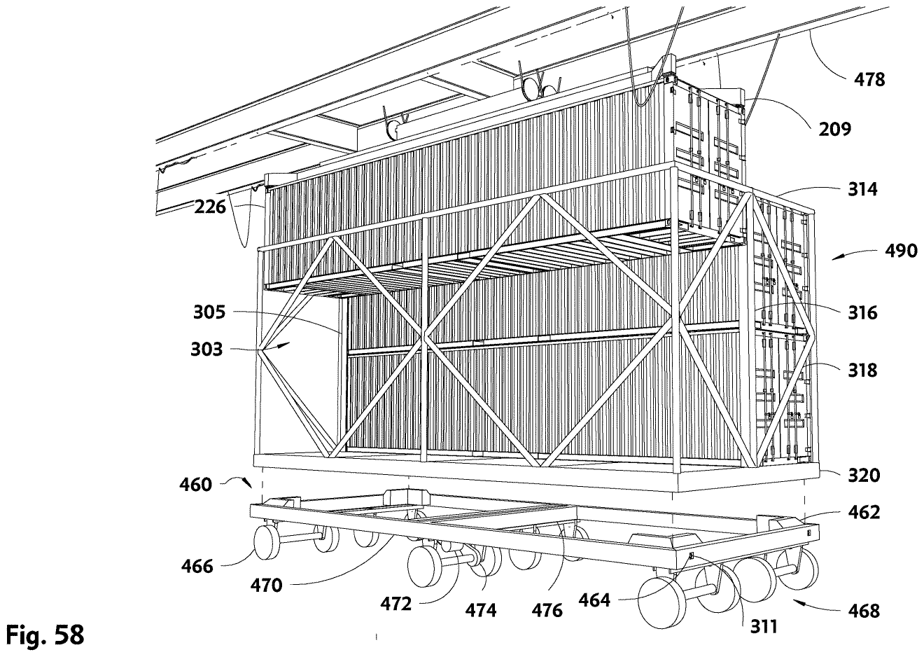

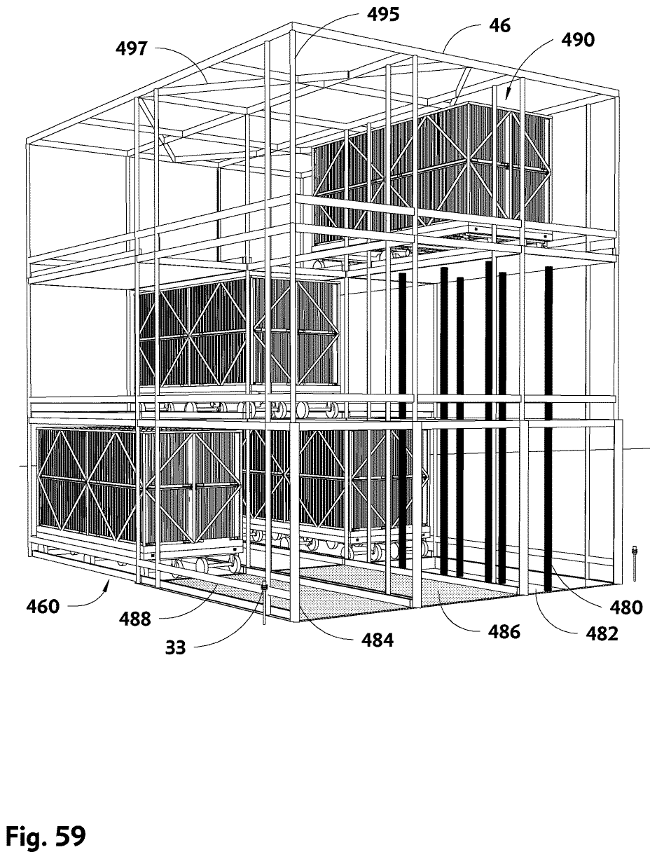

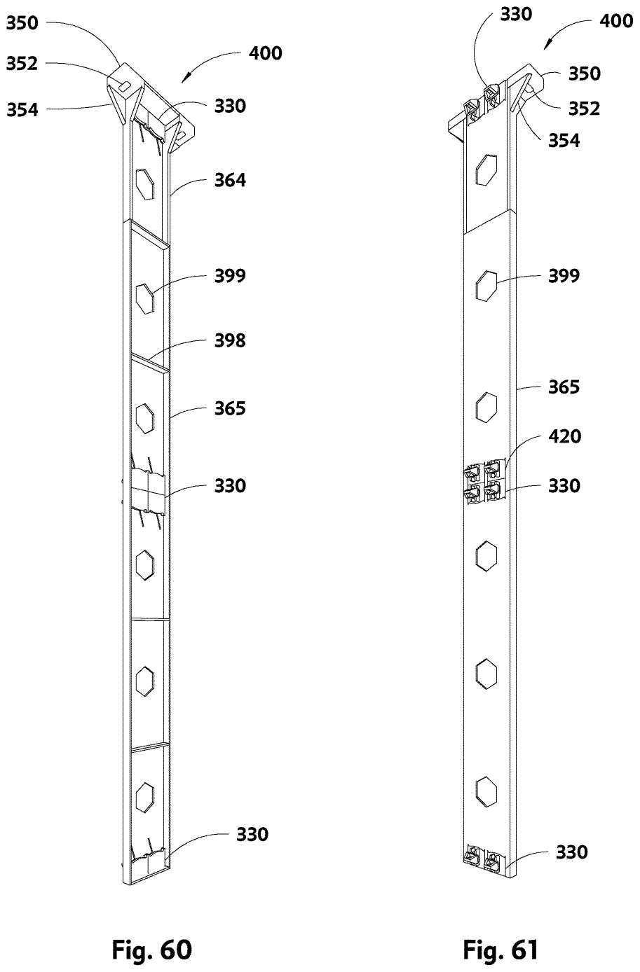

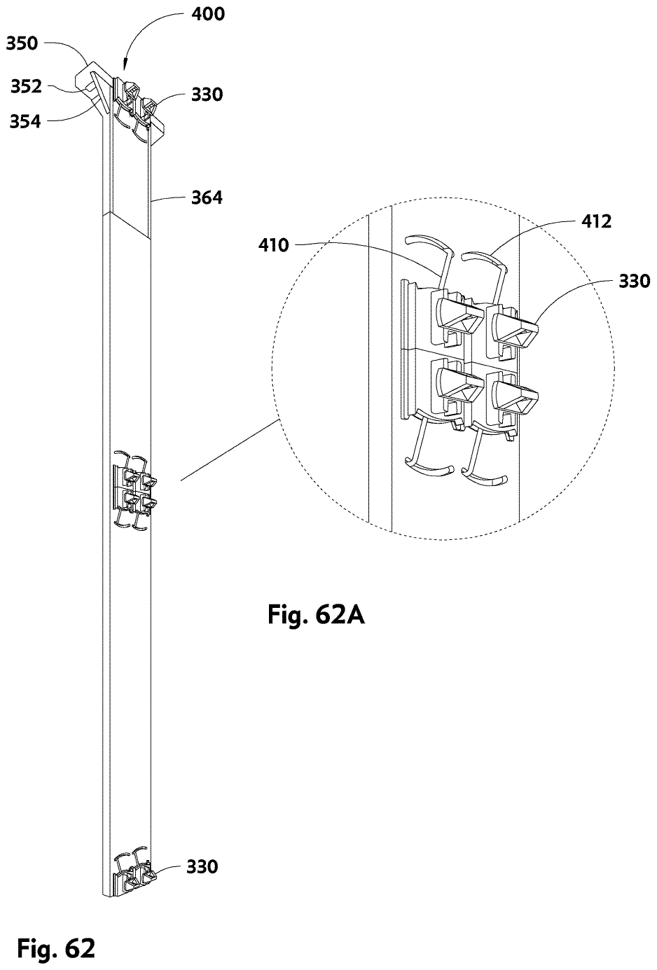

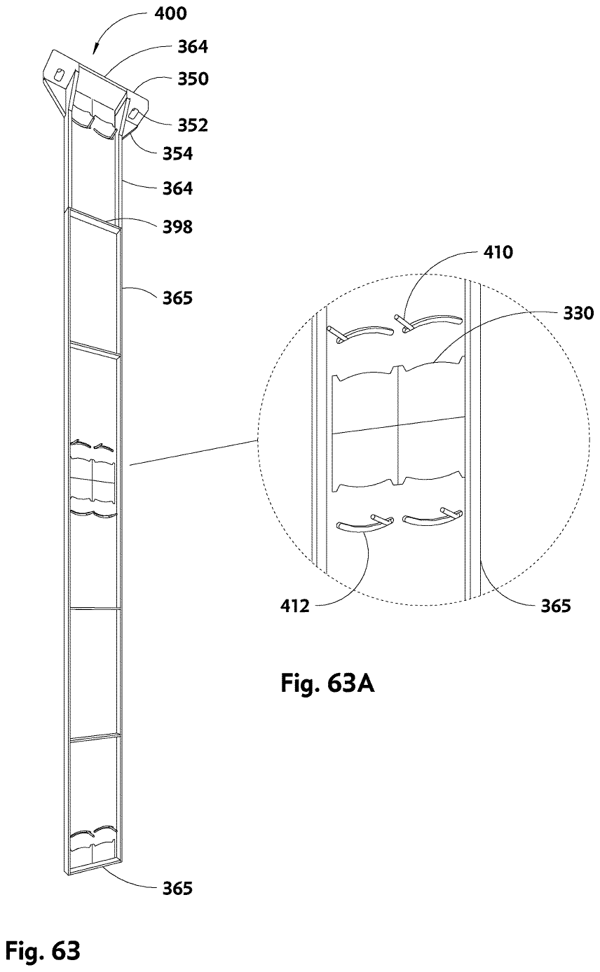

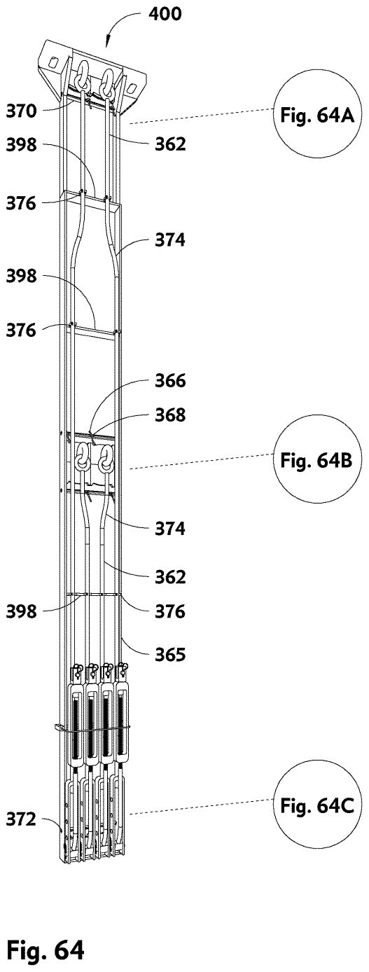

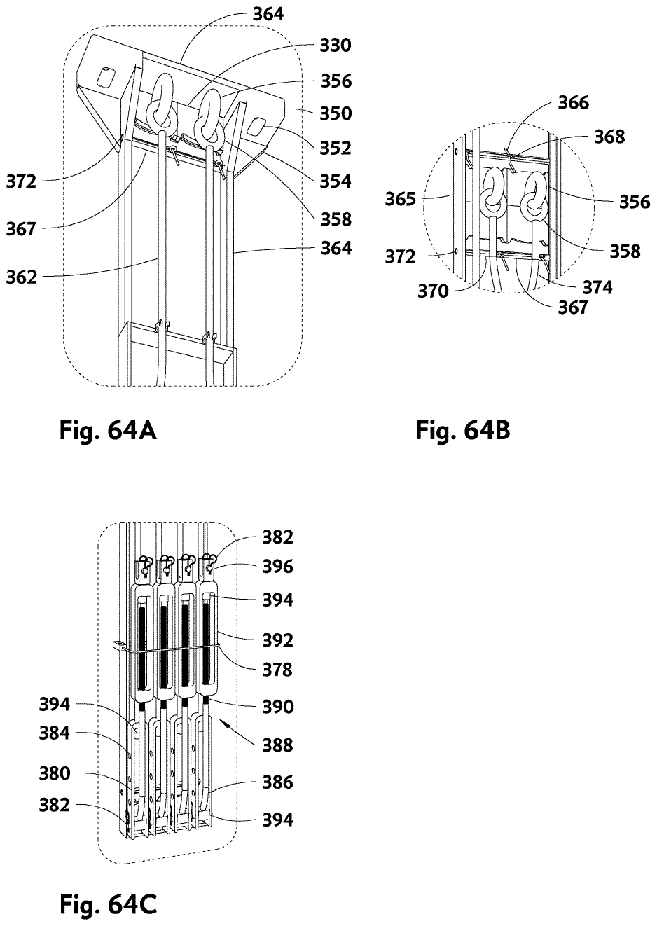

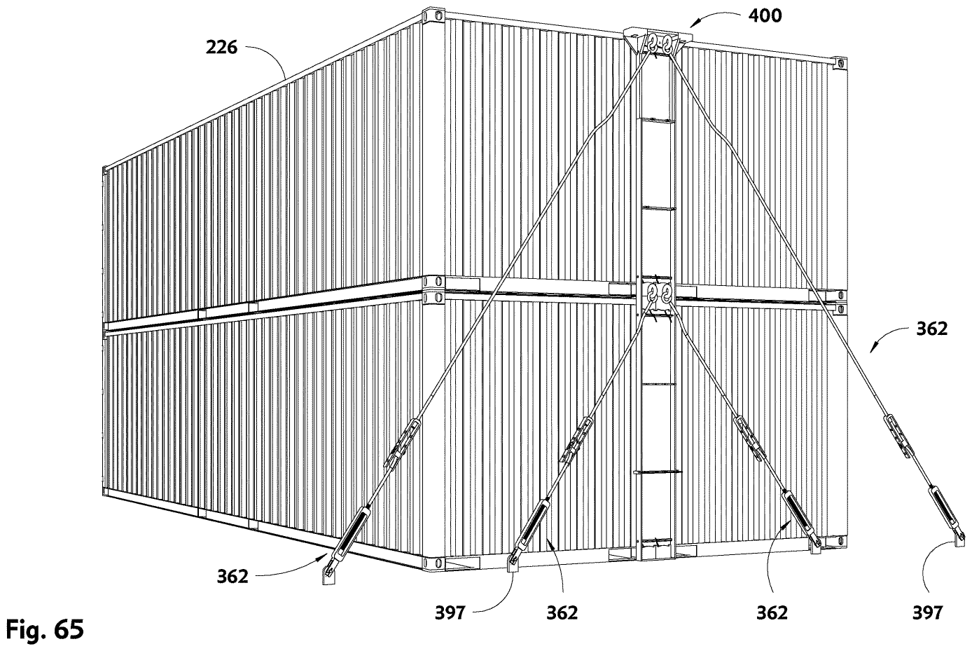

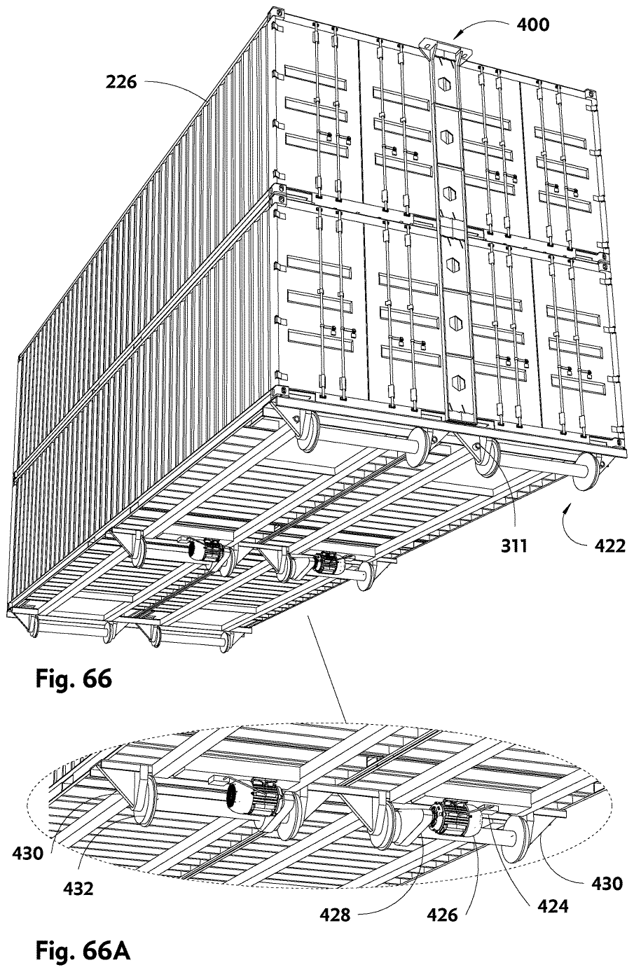

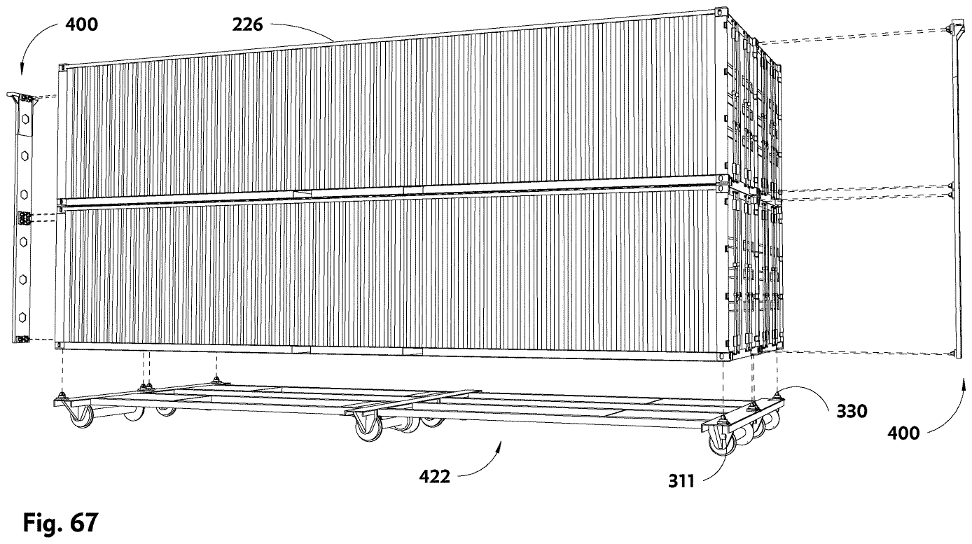

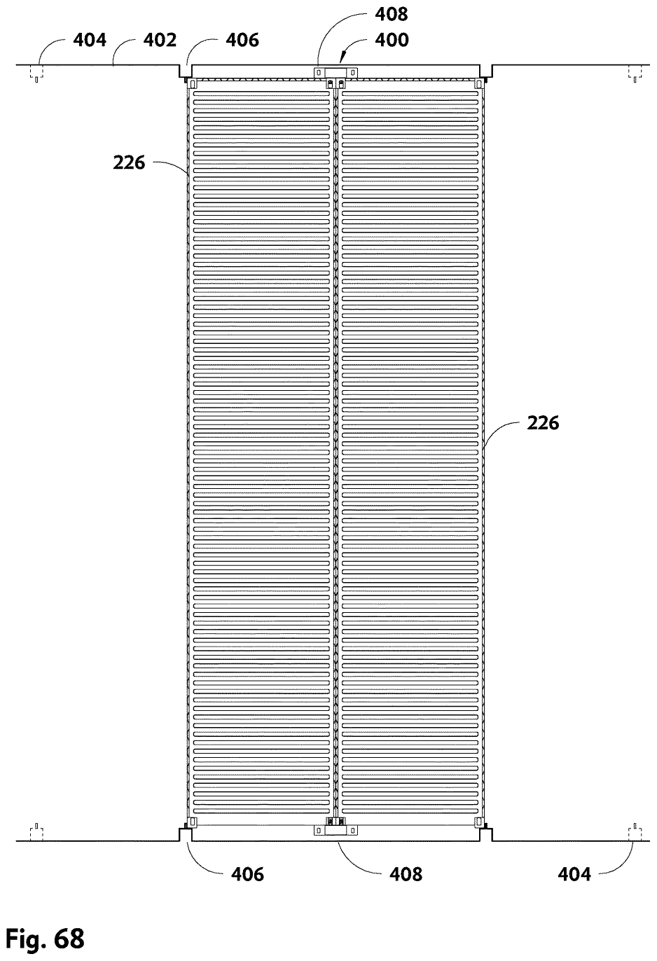

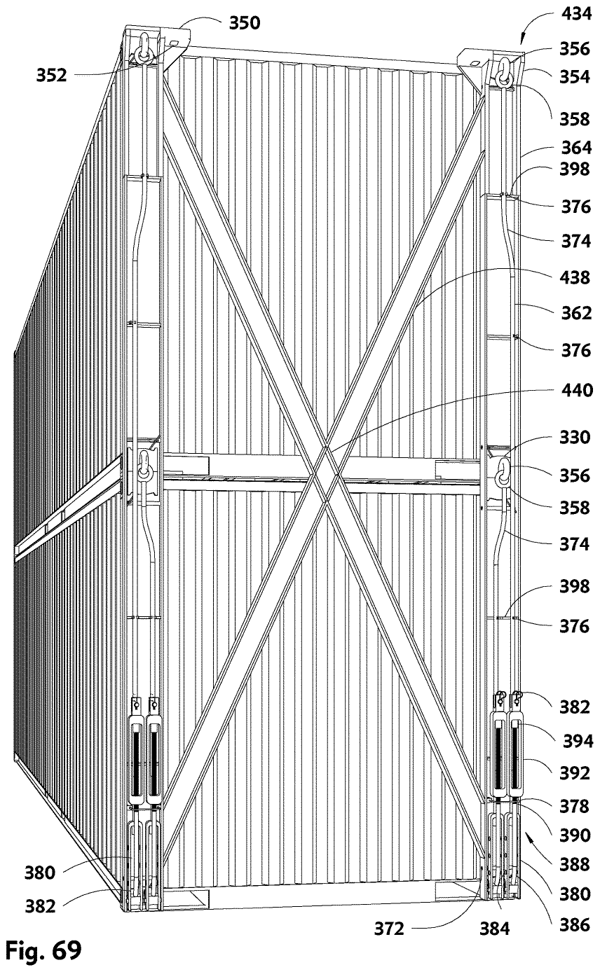

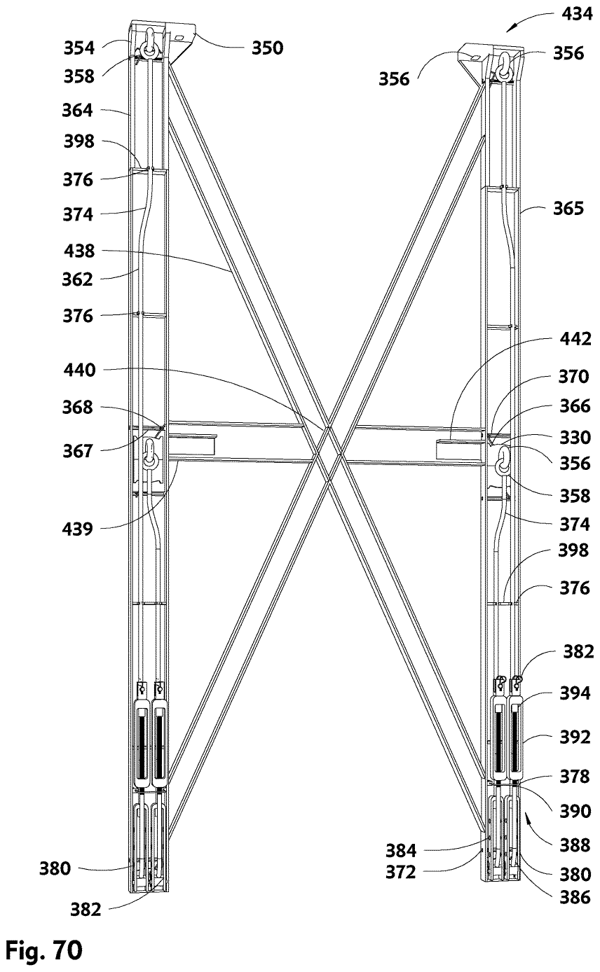

For example, the sea bluff embodiment in FIG. 57 is shown with one bay. If more bays were required, then the counterweight 130 could be moved to either side in that example and allow more bays to be added. A rolling platform 734 such as the one shown in this FIG. 49 could roll along the shoreline 54.

Likewise, on a ship, bays may be added.

Pulleys 754 are shown peeking behind the structural side plates 734 in all four corners of each bay. These pulleys enable the hoist cables 712 to transfer to the spindles 790 in a neat manner.

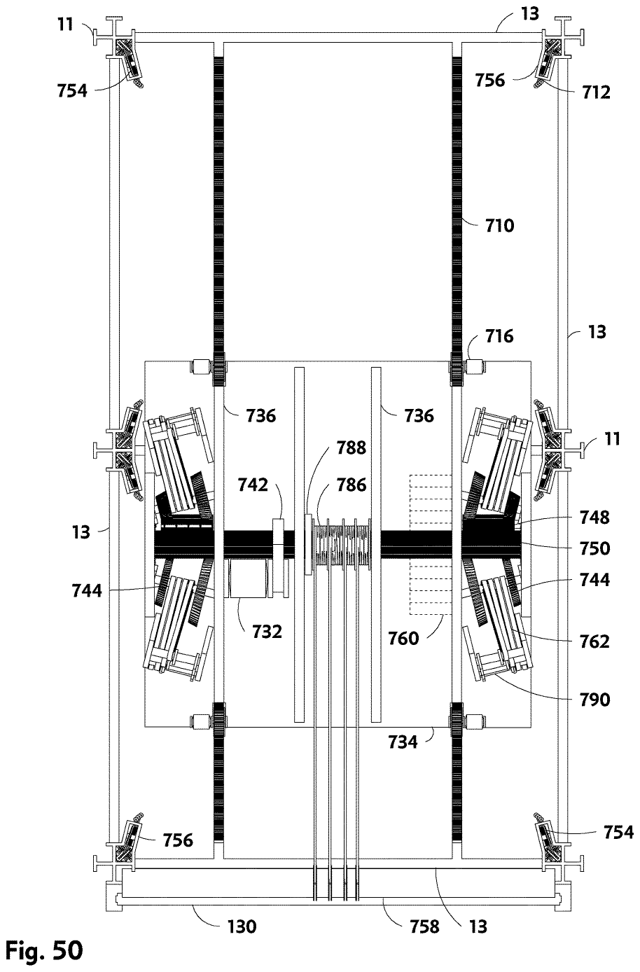

FIG. 50 illustrates an upper plan view of a 3-axis structure and 3-axis hoist 10. The rolling platform 734 is shown in a moving state—that is, it is not connected to four corner hoist mechanisms 714.

Corner hoist cables 712 have thickened ends 792 that prevent the corner hoist lift mechanism from falling after a stevedore unsets the cables from a corresponding spindle 790. Holes for the hoist cables 712 in the structural side plates provide this function. Stevedores may access the rolling platform 734 via a catwalk adjacent to the counterweight 130. An arched ladder 760 enables movement on the platform.

A mechanized setting and unsetting of hoist cables 712 to spindles 790 is perfectly possible.

Similar to the description in FIG. 5 this plan view helps orient you to the apparatus.

From this view, the rack 710 is shown as a means to access each individual bay of the 3-axis structure 23.

Intermediary geared axle 748 enables all four corner hoists 714 to raise or lower in the same direction at the same time. The drive belts 762 are driven by beveled gears 744 which share a common axis. This arrangement enables the corner hoist lift mechanism 714 and corresponding hoist cables 712 to meet perpendicular to a spindle 790. This prevents strange coiling behavior.

The 3-axis structure and 3-axis hoist 10 are comprised of a number of components such as beams 13 and columns 11. This structure provides a means to lift 16 series 1 freight containers with ease.

Because the cargo frames 40 are lifted at the corners of the frame, each bay may be utilized for storage. While cargo frames of this size are contemplated, nothing would prevent the use of this 3-axis structure and 3-axis hoist 10 from use in a warehouse with smaller cargo frames 40 or other apparatus.

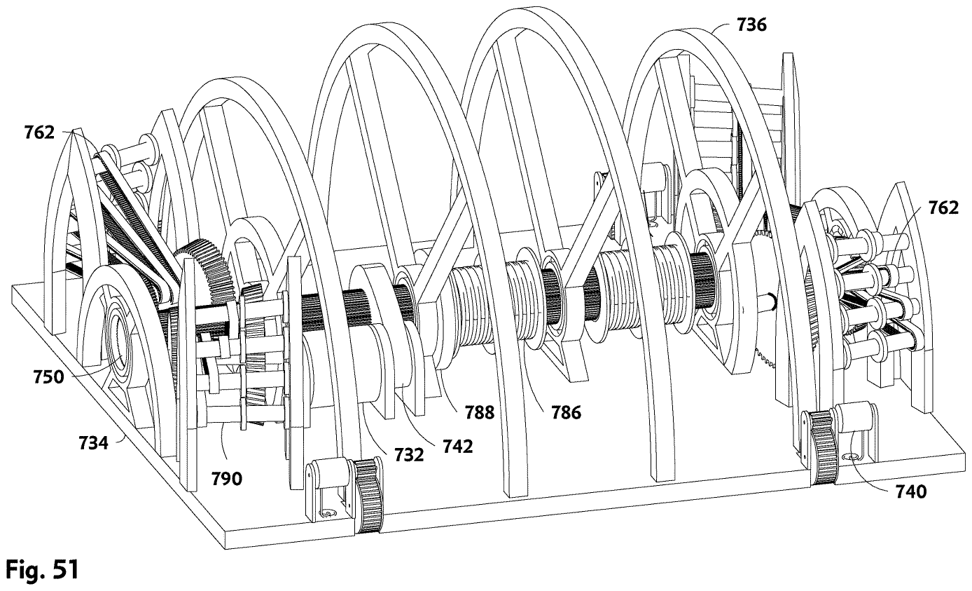

FIG. 51 shows a frontal perspective view of a 3-axis hoist, which is similar in operation to its land-based counterparts shown in FIGS. 1, 45 and 57. The main difference is that this hoist rolls on rolling platform 734.

Electric motor and pinion move back and forth between bays of a 3-axis structure 23 on racks 710 which are mounted on 3-axis structure beams 13. The enables the use of one counterweight 130 for as many bays as there are deep on a cargo frame cargo ship 24 (reference FIG. 42).

Driven by a suitably sized electric motor 732 the drive axle 750 makes rotations through a gear box 742. A governor 788 prevents freefall accidents. The enormous loads of a cargo frame 40 sized for 16 series 1 freight containers is offset by the counterweight 130. To take up slack when the rolling platform 734 moves to a different bay the counterweight spindle and clutch 786 disengage the drive axle 750 and roll up or down as is fit. This feature allows the counterweight 130 to reset according to the bay and level the corner hoist mechanism 714 is located at in the 3-axis structure 23.

To transfer the rotations to the four corner hoist lift mechanisms 714, drive belts 762 turn spindles 790 which are sized to hold the proper length of hoist cable 712 as is required.

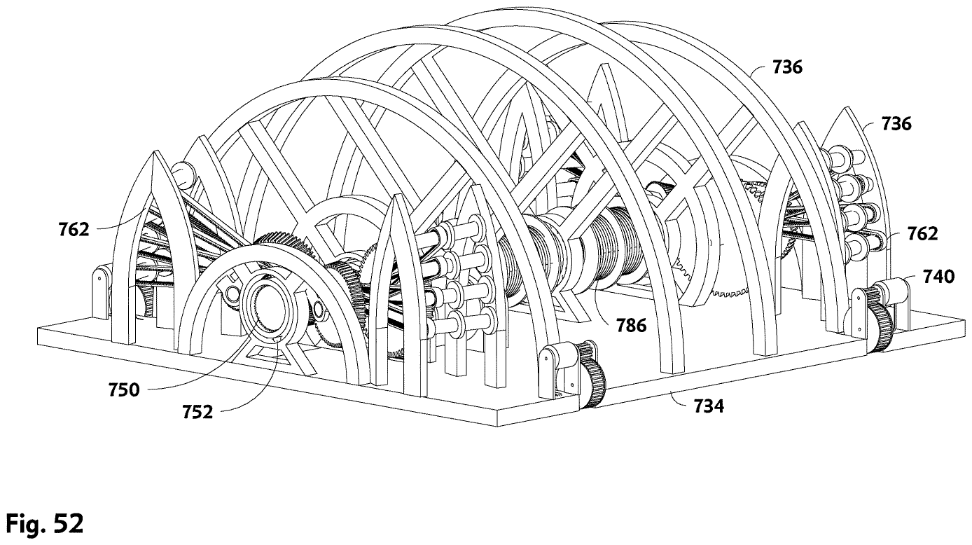

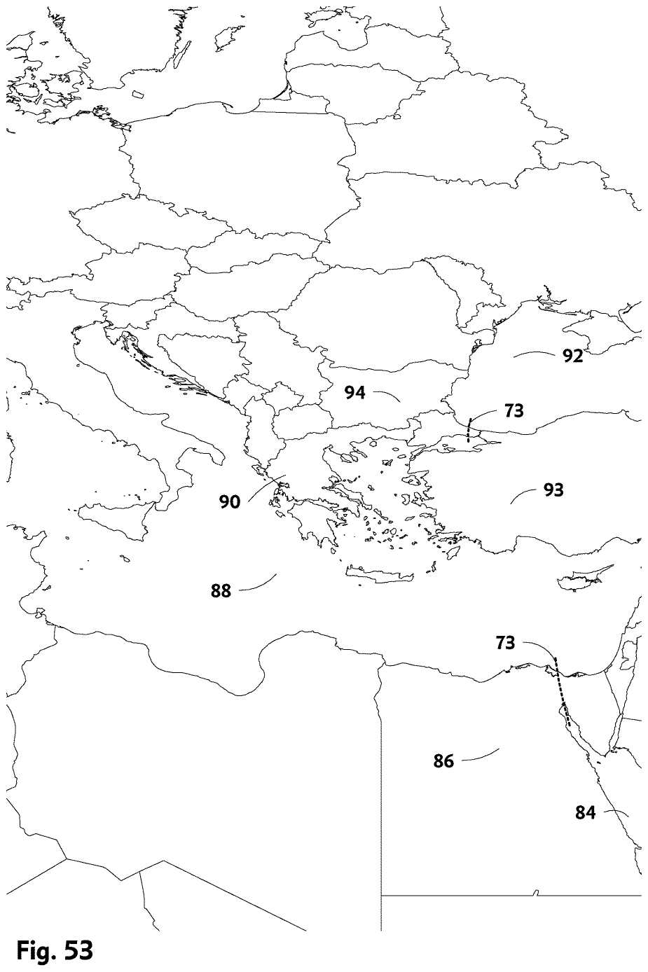

FIG. 52 shows an angled perspective view of a 3-axis hoist substantially similar to FIG. 51, from a different view.

FIG. 53 depicts a world map focusing on Egypt 86 and Türkiye 93. The grounding of the Ever Given in the Suez Canal in 2021 shows the dangers of utilizing the largest class of vessels in a canal.

This would be a perfect application for a proposed two sets of rails 73 utilizing cargo frames. The canal could be straddled to enable large container ships to swiftly decargo and have a matching ship on the other side of Egypt 86.

For Türkiye 93 a currently proposed Istanbul Canal has drawn fierce critics. This would be a perfect application for a proposed two sets of rails 73 utilizing cargo frames because laying railroad rails takes less effort than canals, removes the need to dispose of the earth, removes the ecological danger of mixing two bodies of water. While a draw bridge may need to be installed in some locations this if far more easily accomplished.

Here again the cargo frame shines.

Bulgaria 94, Greece 90, the Mediterranean Sea 88, and the Black Sea 92 are shown for context.

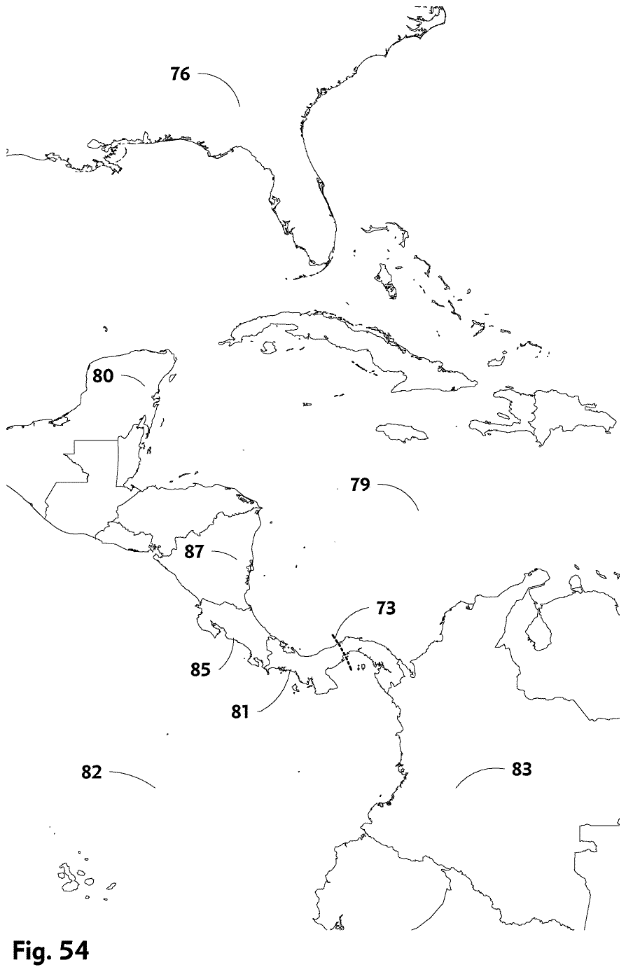

FIG. 54 depicts a world map focusing on Panama 81. Panama recently widened the Panama Canal at great expense. It still does not allow 24,000 TEU ships transit.

This would be a perfect application for a proposed two sets of rails 73 utilizing cargo frames. The canal could be straddled to enable large container ships to swiftly decargoed and have a matching ship on the other side of Panama 81.

Here again the cargo frame shines.

The United States of America 76, Mexico 80, Nicaragua 87, Costa Rica 85, Columbia 83, the Pacific Ocean 82 and the Gulf of Mexico 79 are shown for context.

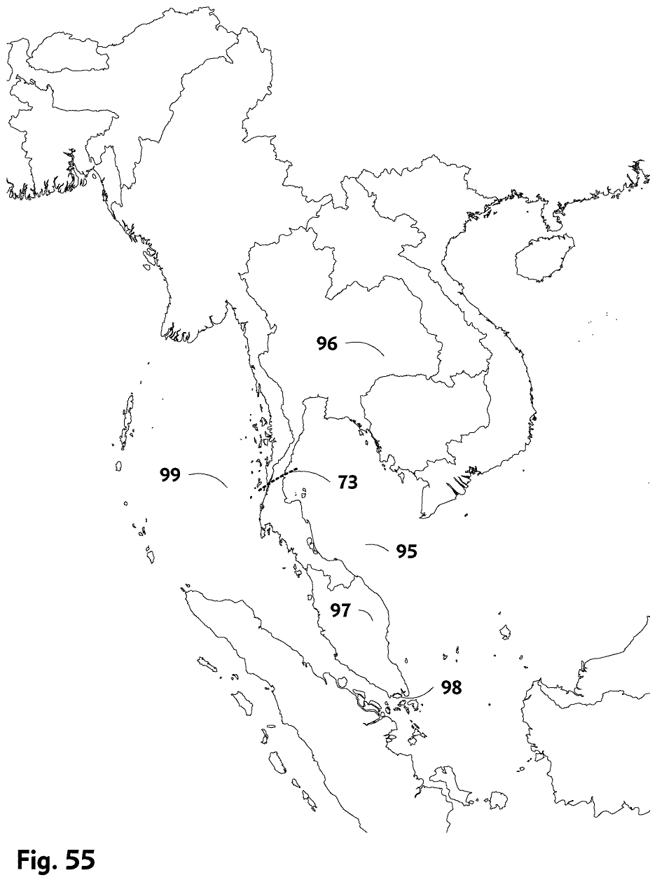

FIG. 55 depicts a world map focusing on Thailand 96. It is currently contemplated by the Thai government to build a railroad at this location to remove two days of ocean transit time. This would be a perfect application for a proposed two sets of rails 73 utilizing cargo frames. As currently proposed a lot of time is lost loading and unloading trains.

Here again the cargo frame shines.

The Andaman Sea 99, Malaysia 97, Singapore 98 and the Gulf of Thailand are shown for context.

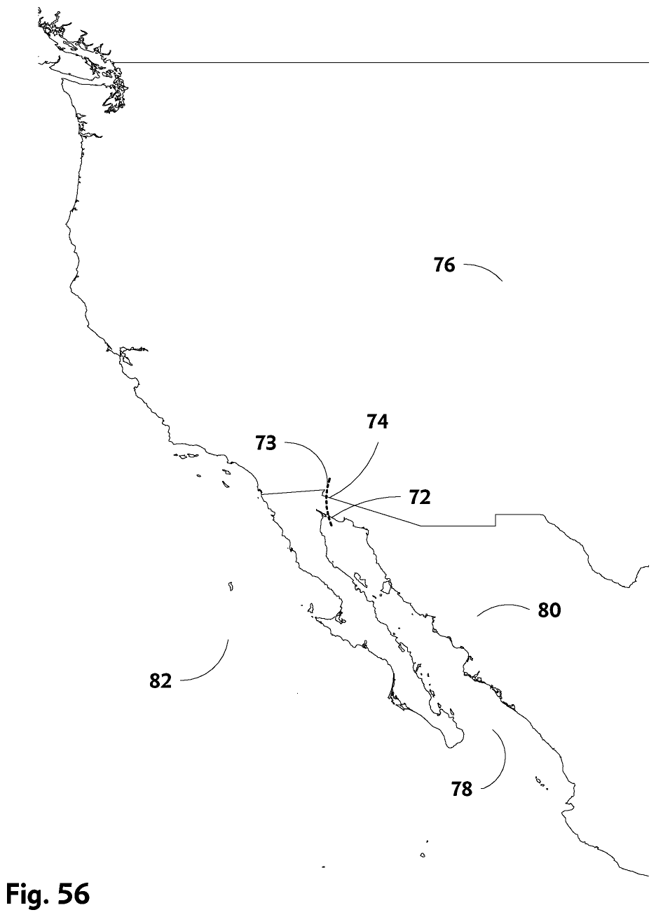

FIG. 56 depicts a world map focusing on Puerto Peñasco, Mexico 72 and Yuma, Arizona 74. The United States of America 76, Mexico 80, Pacific Ocean 82 and the Gulf of California 78 are shown for context.

Here, there is a low sea hill and little infrastructure. Two sets of rails 74 could easily traverse the distance to Yuma, Arizona 74 without building an enormous port. A modest dock such as that shown in FIG. 57 would be ideal.

FIG. 57 depicts a scene where a town or city wishes to build a port but does not have what the prior art would call a good port site. Imagine such a place where there is a large sea bluff 51. The body of water 50 crashes upon the shoreline 54-until now, this would just be a nice thing to look at.

A cargo frame barge 26 motors close to a cargo frame dock 20. Also shown are requisite lobster claw dock pilings 502. A 3-axis hoist structure and 3-axis hoist 10 lift cargo frames 40 with ease up to the top of the sea bluff 51, where the cargo frames 40 motor to an inland port.

Just imagine the unlocked trade!

This is a further example of how the parts of the system for cargo transport may be joined endlessly. Even a reversed 3-axis hoist structure and 3-axis hoist 10 make an old, ugly gravel pit turn into a warehouse of the future.

While it presently seems like a port would determine height required and set the lobster claw 500, at those heights it is conceivable a twist lock rack could be set with a rack and pinion whereby a lobster claw 500 may be adjusted on demand versus manual bolts.

There are two independent, outer hulls 506 and one inner hull 508. Cargos are conveyed onto the inner hull 508 where they are centrally balanced.

The cargo frame barge 26 is shown in both an open and closed state to demonstrate that the outer hulls 506 are retractable, as well as extendable. A motorized platform 518 may slide to either outer hull 506.

### DESCRIPTION OF EMBODIMENTS

FIG. 58 shows an exploded perspective view of a cargo frame sized to house four series 1 freight containers 226 called a port-side bundle wherein two vertical cargo frame bays 303 are formed by a pair of cell guides 305 and a separate autonomous cart for port-side bundle 460 that is used to transport the port-side bundle 460.

At the top of the view is a spreader frame for four series 1 freight containers 478. This frame supports a spreader for one series 1 freight container 209.

The port-side bundle 490 is comprised of cargo frame beams 314, cargo frame columns 315, two cell guides 305, cargo frame braces 318, and a cargo frame bottom beam 320. At the lower portion of the view, the autonomous cart for port-side bundle 460 is comprised of a structural frame for autonomous cart 470, wheels and tires 466, recesses for optical, motion and distance sensors 464, optical, motion and distance sensors 311, electric motor for autonomous cart 472, gear box for autonomous cart 474, battery for autonomous cart 476, guide bumpers for port-side bundle 462, and rotating wheel sets 468.

FIG. 59 shows perspective view of a port-side bundle structure 492 and hydraulic elevator 494 sized to house a plurality of port-side bundles 490 which are further sized to house four series 1 freight containers 226.

The port-side bundle structure 492 is made with columns 495, beams 496, braces 497, and a structural floor platform 498. Safety rails 488 are provided as a precaution. As with all of the structures in the system for cargo transport, adequate foundations are required.

It should be noted there are no tie-downs in this embodiment. It would be perfect for a low seismic site. If a seismic site was required, then adding a twist lock rack lock mechanism would be required. It is expected the autonomous, wheeled carts 460 have a locking mechanism for safety.

Ellipsoid column guide bumpers 484 correct errors from autonomous, wheeled carts 460.

Port-side bundles 492 are wheeled onto the elevator lift platform 486 after receiving instructions from the wireless control bollard and signal lights 33. The autonomous, wheeled cart 460 is equipped with a control box 424.

FIG. 60 depicts a perspective front view of a cargo clip 400 with castellations 399. Thickened structural members 364 transfer forces from the twist lock heads 350 designed to lift four series 1 freight containers 226. Enlarged slots for twist lock and spreader designed to lift four series 1 freight containers 352 are shown adjacent structural gusset plates 354.

An elevator pit 482 is seen at lower right as well as six hydraulic rams 480.

Structural stiffeners for cargo clips 398 are placed at structurally mandated intervals and sized accordingly. Structural flanges 365 are further used to stiffen the cargo clip 400.

Twist locks 330 are mounted at the upper portion of the twist lock base such that the levers do not require bending.

FIG. 61 depicts a perspective rear view of a cargo clip 400 with castellations 399. Thickened structural members 364 transfer forces from the twist lock heads 350 designed to lift four series 1 freight containers 226. Enlarged slots for twist lock and spreader designed to lift four series 1 freight containers 352 are shown adjacent to structural gusset plates 354.

Structural flanges 365 are used to stiffen the cargo clip 400.

Twist locks 330 are mounted at the upper portion of the twist lock base such that the levers do not require bending.

FIG. 61 is a perspective front view of a cargo clip 400 with a plurality of arced slots 412 for modified, bent, and structurally attached twist lock open & closing arms for hand use 410. As can be seen, twist locks 330 are arranged to match the corner castings of a series 1 freight container 226. Holes are scribed in the structural frame of the cargo clip 400, enabling the twist lock 330 to transfer loads to the structural frame and the binding of four series 1 freight containers 226.

At the top of the cargo clip 400 are twist lock heads designed to lift four series 1 freight containers 226. The weight of four containers exceeds the corner casting rating of a series 1 freight container 226. Specialized twist locks are utilized to engage the enlarged slot for twist lock and spreader designed to lift four series 1 freight containers 352 which is cut in a twist lock head 350 designed to lift four series 1 freight containers 226.

To help distribute loads and provide stiffness, two structural gusset plates for cargo clip 354 are structurally attached. These gussets are structurally connected to thickened structural members 364 which then transfer these loads further down the cargo clip 400.

Structural stiffeners for cargo clips 398 are placed at structurally mandated intervals and sized accordingly. Structural flanges 365 are further used to stiffen the cargo clip 400.

FIG. 61A displays an enlarged perspective front view of a middle portion of a cargo clip 400 where arced slots 412 for modified, bent, and structurally attached twist lock open & closing arms for hand use 410 are cut.

Twist lock 330 profiles are shown scribed to fit. Structural flanges 365 run the edges of the cargo clip 400.

FIG. 62 shows a perspective rear view of a cargo clip 400 with a plurality of arced slots 412 for modified, bent, and structurally attached twist lock open & closing arms 410 for hand use. As shown, twist locks 330 are arranged to match the corner castings of a series 1 freight container 226. Holes are scribed in the structural frame of the cargo clip 400, enabling the twist lock 330 to transfer loads to the structural frame and the binding of four series 1 freight containers 226.

At the top of the cargo clip 400 are twist lock heads designed to lift four series 1 freight containers 226. The weight of four containers exceeds the corner casting rating of a series 1 freight container 226. Specialized twist locks are utilized to engage the enlarged slot for twist lock and spreader designed to lift four series 1 freight containers 352. The slot is cut in a twist lock head 350 designed to lift four series 1 freight containers 226.

To help distribute loads and provide stiffness, two structural gusset plates for cargo clip 354 are structurally attached. These gussets are structurally connected to thickened structural members 364 which then transfer these loads further down the cargo clip 400.

FIG. 62A is an enlarged perspective rear view of a cargo clip 400 with a plurality of arced slots 412 for modified, bent, and structurally attached twist lock open & closing arms 410.

It can be seen here that the twist lock's 330 back face is flush with the front face of the cargo clip 400. In this embodiment, it may be desired for the twist locks 330 to protrude further from the rear face of the cargo clip 400. Because of this, the twist locks 330 must have the arced slots for modified, bent, and structurally attached twist lock open & closing arms for hand use 412. Otherwise, the open and closing arms could not be easily reached.

FIG. 63 shows a perspective front view of a cargo clip 400 which is the opposite side of FIG. 62 and FIG. 62A.

As with the other embodiments of the cargo clip 400, thickened structural members 364 provide necessary rigidity and enable the safe transfer of loads imposed upon the clip. Structural gusset plates 354 stiffen up the twist lock head 350. Enlarged slots 352 are designed to lift four series 1 freight containers 226 with a margin of safety.

Purpose-built spreaders are required to lift a cargo clip 400, as mentioned above in the description.

Structural flanges 365 and structural stiffeners 398 further stiffen the clip, and may be welded or bent, depending on the application. For example, some series 1 freight containers 226 are 10 feet long, some are 20 feet long and the most common is 40 feet long, among other sizes. These differences naturally change the structural requirements of the cargo clip 400.

FIG. 63A shows an enlarged perspective rear view of a cargo clip 400 and offers more detail of FIG. 63.

FIG. 64A perspective front view of a cargo clip 400 wherein a plurality of structurally 2610 attached lashing rods 362 are in closed position.

Structurally attached lashing rods 362 may clip into lashing rod tension clips 376 while stowed away in closed position. Bent portion of lashing rod 374 enables neat stowage without interfering with the structurally attached lashing rods 362 in the middle portion of the cargo clip 400.

To maintain structural rigidity, structural stiffeners for cargo clip 398 are placed at structurally mandated intervals and sized accordingly.

It is entirely feasible and likely that electrically actuated twist locks could be employed in this embodiment.

FIG. 64A shows an enlarged perspective front view of a top portion of FIG. 52. Ends of slotted pipes 372 are where a longshoreman may use a tool to push the rods 367 left or right in an open or closed position, thereby unlocking or locking the twist locks 330. Structurally attached structural rings 356 at twist locks 330 enable the free movement of structurally attached lashing rods 362 via a structural ring 358.

Thickened structural members 364 transfer forces from the twist lock heads 350 designed to lift four series 1 freight containers 226. Enlarged slots for twist lock and spreader designed to lift four series 1 freight containers 352 are shown adjacent structural gusset plates 354.

FIG. 64B shows an enlarged perspective front view of a middle portion of FIG. 52. Modified, bent, and structurally attached twist lock open and closing arms for tool use 366 slide left or right and are driven by a ring 368 attached to rod 367 in slotted pipe 370 structurally attached to cargo clip 400 structural flanges 365. Ends of slotted pipes 372 are where longshoreman may use a tool to push the rods 367.

As at the upper portion of FIG. 52, structurally attached structural rings 356 at twist locks 330 enable the free movement of structurally attached lashing rods 362 via a structural ring 358.

Bent portion of lashing rod 374 allows for neat stowage of all structurally attached lashing rods 362.

FIG. 64C shows an enlarged perspective front view of a lower portion of FIG. 52 where a pivoting end of lashing rod 388 is shown. Removable rods and cotter pins 382 enable quick length adjustments via holes 384 in a U-shaped termination of structurally attached lashing rod 380. Anchor shackle screws pins, and/or bolts could be substituted for removable rods and cotter pins 382.

The pivoting end of lashing rod 388 has threads 390 enabling fine-tuned adjustments with the elongated O-shaped, threaded tightening section of pivoting end of lashing rod 392.

The bent portion of pivoting end of lashing rod 386 allows for neat stowage.

Towards the end of the O-shaped, threaded tightening section of pivoting end of lashing rod 392 is a thickened end of rod 394 which enables an O-shaped tightening section to rotate while a U-shaped end of a pivoting end of a lashing rod 396 remains in place on the ship's deck.

Lastly, a wire tie 378 is used to keep pivoting end of lashing rod 388 upright and neatly stowed away when not in use.

FIG. 65 a perspective front view of a cargo clip 400 wherein a plurality of structurally attached lashing rods 362 are in open position structurally attached to ship deck tie downs 397.

Four series 1 freight containers 226 are shown. The reduction in lashing rods went from 12 to 4!

FIG. 66 shows a perspective underside view of a pair of cargo clips 400 with castellations 399 shown locked to series 1 freight containers 226, and an autonomous, motorized rail cart autonomous cargo clip rail cart 422. The optical sensor, motion, and distance sensors 311 allow for traversing without running into things.

FIG. 66A shows an enlarged perspective underside view of FIG. 54. The autonomous cargo clip rail cart 422 boasts six rail wheelsets 432 which enable the cart to use rails. The wheelsets are reinforced with gusset plates 430 and are driven by electric motors 426 which drive a gear box 428. Motors are given instructions via the wireless control bollards & signal lights 33 and a control box 424.

FIG. 67 shows an exploded perspective view of a cargo clip 400 with castellations shown in relation to a set of four series 1 freight containers 226, and an autonomous, motorized, cargo clip rail cart 422. The optical sensor, motion, and distance sensors 311 allow for traversing without running into things.

FIG. 68 depicts plan view of a pair of cargo clips 400 bound to a set of four series 1 freight containers 226 in a prior art ship's modified hold. The outline of cell guide end walls 402 of a prior art cargo ship hold.

Removed cell guide and old position provides space for cargo clip 400.

Cell guides to remain in place 406, enabling the cargo clip 400 to lower into the hold. The dashed outline shows a removed cell guide 404 which provides space for the cargo clip 400

FIG. 69 displays a perspective view of an x-clip 434 with structurally attached lashing rods 362 binding a set of two series 1 freight containers 226.

To help distribute loads and provide stiffness, two structural gusset plates for cargo clip 354 are structurally attached. These gussets are structurally connected to thickened structural members 364 and transfer forces from the twist lock 350 heads designed to 2710 lift four series 1 freight containers 226.

Take note that the twist lock heads are toward the vertical centerline of the x-clip 434. This allows adjacent x-clip 434 bundles to be stacked tightly; the x-clip 434 does not protrude beyond the sides of the series 1 freight containers 226.

To maintain structural rigidity, structural stiffeners for cargo clip 398 are placed at structurally mandated intervals and sized accordingly.

Structurally attached lashing rods 362 may clip into lashing rod tension clips 376 while stowed away in closed position. Bent portion of lashing rod 374 enabling neat stowage without interfering with the structurally attached lashing rods 362 in the middle portion of the x-clip 434.

Modified, bent, and structurally attached twist lock open and closing arms for tool use 366 slide left or right and are driven by a ring 368 attached to rod 367 in slotted pipe 370 structurally attached to x-clip 434 structural flanges 365. Ends of slotted pipes 372 are where longshoreman may use a tool to push the rods 367.

Structurally attached structural rings 356 at twist locks 330 enable the free movement of structurally attached lashing rods 362 via a structural ring 358.

A pivoting end of lashing rod 388 is shown. Removable rods and cotter pins 382 enable quick length adjustments via holes 384 in a U-shaped termination of structurally attached lashing rod 380. Anchor shackle screws pins, and/or bolts could be substituted 2735 for removable rods and cotter pins 382.

The pivoting end of lashing rod 388 has threads 390 that enable fine-tuned adjustments with the elongated O-shaped, threaded tightening section of pivoting end of lashing rod 392.

The bent portion of pivoting end of lashing rod 386 allows for neat stowage.

Towards the end of the O-shaped, threaded tightening section of pivoting end of lashing rod 392 is a thickened end of rod 394 which enables an O-shaped tightening section to rotate while a U-shaped end of a pivoting end of a lashing rod 396 remains in place on the ship's deck.

Lastly, a wire tie 378 is used to keep pivoting end of lashing rod 388 upright and neatly stowed away when not in use.

FIG. 70 displays a perspective view of an x-clip 434 with structurally attached lashing rods 362.

To help distribute loads and provide stiffness two, structural gusset plates for cargo clip 354 are structurally attached. These gussets are structurally connected to thickened structural members 364 and transfer forces from the twist lock heads 350 designed to lift four series 1 freight containers 226.

Take note that the twist lock heads are toward the vertical centerline of the x-clip 434. This allows adjacent x-clip 434 bundles to be stacked tightly; the x-clip 434 does not protrude beyond the sides of the series 1 freight containers 226.

To maintain structural rigidity, structural stiffeners for cargo clip 398 are placed at structurally mandated intervals and sized accordingly.

Structurally attached lashing rods 362 may clip into lashing rod tension clips 376 while stowed away in closed position. Bent portion of lashing rod 374 enables neat stowage without interfering with the structurally attached lashing rods 362 in the middle portion of the x-clip 434.

Modified, bent, and structurally attached twist lock open and closing arms for tool use 366 slide left or right and are driven by a ring 368 attached to rod 367 in slotted pipe 370 structurally attached to x-clip 434 structural flanges 365. Ends of slotted pipes 372 are where longshoreman may use a tool to push the rods 367.

Structurally attached structural rings 356 at twist locks 330 enable the free movement of structurally attached lashing rods 362 via a structural ring 358.

A pivoting end of lashing rod 388 is shown. Removable rods and cotter pins 382 enable quick length adjustments via holes 384 in a U-shaped termination of structurally attached lashing rod 380. Anchor shackle screws pins, and/or bolts could be substituted for removable rods and cotter pins 382.

The pivoting end of lashing rod 388 has threads 390, enabling fine-tuned adjustments with the elongated O-shaped, threaded tightening section of pivoting end of lashing rod 392.

The bent portion of pivoting end of lashing rod 386 allows for neat stowage.

Towards the end of the O-shaped, threaded tightening section of pivoting end of lashing rod 392 is a thickened end of rod 394 which enables an O-shaped tightening section to rotate while a U-shaped end of a pivoting end of a lashing rod 396 remains in place on the ship's deck.

This embodiment utilizes a horizontal structural member 439 with bent tabs 442 which enable a forklift to pick up the x-clip 434 and guide it to two stacked series 1 freight containers 226 to match the two forklift openings at the upper container.

Lastly, a wire tie 378 is used to keep pivoting end of lashing rod 388 upright and neatly stowed away when not in use.

### Send Off to the Universe:

There is no doubt about the experimental and pioneering nature of this work. Prior to filing this disclosure, naturally I could not consult the world's ports for worldwide patent reasons.

Due to the massive capital expenditures and land ownership needed to make even one cargo frame and multi-level encargo and decargo structure, this has been a somewhat intellectual exercise.

However, as an experienced registered architect, I am confident in the structures, teachings, and explicit drawings that depict my inventions. They will no doubt enable skilled persons to new lines of thinking and new dimensions to achieve 21^{st} century global trade.

I fully expect that the ultimate commercial cargo frame, port layout, truck resort, truck tower, barges, and ship structures will all need refinement and feedback from a myriad of users as they begin to be used and abused daily.

Will the ultimate commercial cargo frame hold sixteen series 1 freight containers or will it hold four? Will the cargo frame have wheels affixed as shown in the preferred embodiment or will they be wheel-free to be used with port-side movement means? Will the wheeled embodiment weight outweigh the disadvantages due to a heavier ship? Will the heavier ship be a cost but the immense productivity of a ship that moves 100,000 TEU (roughly a four-fold increase in carrying capacity over the world's largest ships) outweigh those considerations?

Only with my cargo frame, barges, ship hoist structure, docks, and two sets of rails could such a set of ships be used at the Panama Canal, slice through Thailand, bridge Türkiye, or make groundings like the Ever Given a thing of the past. One behemoth vessel on one end of the rails and one on the other end. Can you IMAGINE seeing a train with sixteen series 1 freight containers in my new cargo frame freight car rolling down the tracks? It will be a sight to see!

Will the International Organization for Standardization and International Maritime Organization prefer the X-Clip cargo frame because making tens of thousands of existing ships irrelevant might be too great a cost for the industry to bear? I just cannot say. Or will modifications of existing cargo ships for the cargo clip be a cost worth bearing?

I expect the debate to be lively.

### REFERENCE SIGNS LIST (NUMBERS ARE BOLDED IN DESCRIPTION)

10 3-axis hoist structure and 3-axis hoist
11 columns (for 3-axis hoist structure)
12 bulk silo & 3-axis hoist
13 3-axis hoist structure
14 3-axis hoist
15 cargo frame tower bracing
16 draw bridge
17 ground-level
18 second-level port platform
20 cargo frame dock
22 semi-truck queueing tower
23 3-axis structure
24 cargo frame cargo ship
26 cargo frame barge
28 freight purgatory
30 third-level bulk platform
32 cargo frame maintenance yard
33 wireless control bollard & signal lights
34 freight car transshipment yard
35 freight car spreader frame
36 semi-truck transshipment yard
37 freight well car
38 cargo frame turntable
40 cargo frame
41 cargo frame rail car
42 access road for semi-trucks
43 return loop for semi-trucks
44 exit road for semi-trucks
46 access rails from outside the port
47 freight train
48 port
49 freight train engine
50 body of water

### REFERENCE SIGNS LIST-CONTINUED (NUMBERS ARE BOLDED IN DESCRIPTION)

51 sea bluff
52 land
54 shoreline
56 return loop (for rail carts)
58 brace beams at cargo frame turntable
60 motorized pivot
62 pit rail (for cargo frame turntable)
64 pit wall
66 pit (at cargo frame turntable)
68 bulk drop
70 bridge
72 Puerto Peñasco, Mexico
73 proposed two sets of rails
74 Yuma, Arizona
76 United States of America
78 Gulf of California
79 Caribbean Sea
80 Mexico
81 Panama
82 Pacific Ocean
83 Columbia
84 Great Bitter Lake
85 Costa Rica
86 Egypt
87 Nicaragua
88 Mediterranean Sea
90 Greece
92 Black Sea
93 Türkiye
94 Bulgaria
95 Gulf of Thailand
96 Thailand
97 Malaysia

### REFERENCE SIGNS LIST-CONTINUED (NUMBERS ARE BOLDED IN DESCRIPTION)

98 Singapore
99 Andaman Sea
100 semi-truck tower loading area
102 semi-truck hoist
104 semi-truck tower position
106 rest and recreation floor
108 entry to semi-truck tower
110 semi-truck tower exit area
112 alpha-numeric characters for semi-truck queueing tower designation
114 alpha-numeric characters for semi-truck queueing tower column bays
116 embodiment of a 3-axis hoist
118 semi-truck exit from a semi-truck queueing tower
120 human elevator for semi-truck queueing tower
122 human fire exit stairs for semi-truck queueing tower
124 human safety railing for semi-truck queueing tower
128 bulk-cargo silo cargo frame
130 counterweight
132 semi-truck bays
133 semi-truck guide bumper
200 semi-truck queuing area
202 semi-truck and rail transshipment area
204 painted alpha-numeric characters near semi-truck loading bay
206 one set of rails
208 semi-truck spreader frame
209 spreader for (1) series 1 freight container
210 lane striping
212 rail cart queueing area (free from semi-trucks)
213 alpha-numeric character for terminal designation
214 four sets of rails for rail carts
216 passing lane for semi-trucks
218 two sets of rails for a cargo frame, (an electric third rail is not shown for clarity)

### REFERENCE SIGNS LIST-CONTINUED (NUMBERS ARE BOLDED IN DESCRIPTION)

220 semi-truck
221 vehicle
222 rail cart loaded with series 1 freight container
224 painted alpha-numeric characters at semi-truck loading bay
226 series 1 freight container
300 motorized twist lock flap
302 electric motor for twist lock flaps
303 cargo frame bay
304 one set of rails in cargo frame bay
306 rail cart
305 cell guide
308 pivoting rail bogie
309 shortened axle rail bogie
310 Extent of radius for pivoting rail bogie
311 optical, motion & distance sensor
313 motorized shortened axle rail bogie
314 cargo frame beam
315 cargo frame enlarged corner column
316 cargo frame column
317 specialized corner castings with corner twist lock rack slots
318 cargo frame brace
319 cargo frame joist
320 cargo frame bottom beam
321 enlarged cargo frame column (for twist lock mechanism)
322 stationary twist lock flap
323 gusset plates at stationary twist lock flap
324 structural gusset plate
326 M1A1 Abrams tank
327 rail coupling
328 corner casting of series 1 freight container
330 twist lock
332 motorized twist lock flap in open position

### REFERENCE SIGNS LIST-CONTINUED (NUMBERS ARE BOLDED IN DESCRIPTION)

334 vertical hinge and integral gear at twist lock flap
336 motor driven vertical axle that drives twist lock flaps at that particular column
338 drive shaft (for twist lock flap electric motor)
340 bevel gear
342 counter rotating gear (so both flaps open in opposite direction towards the centerline of the column)
344 clearance of twist lock and series 1 freight container
346 notch at larger entry columns and filler steel plates
350 twist lock head (designed to lift four series 1 freight containers when 2 cargo clips are employed)
352 enlarged slot (for twist lock & spreader designed to lift 4 series 1 freight containers when two cargo clips are employed)
354 structural gusset plate (for cargo clip)
356 structurally attached ring (at twist lock)
358 structural ring (to enable movement of lashing rod)
362 structurally attached lashing rod
364 thickened structural member (as required)
365 structural flanges
366 modified, bent and structurally attached twist lock open & closing arm for tool use
367 rod
368 ring attached to rod in slotted pipe to enable twist lock open & closing arms to maneuver while twist lock is fixed
370 slotted pipe structurally attached to cargo clip side walls
372 end of slotted pipe (to allow a rod to push left or right, enabling open & closing arms to maneuver)
374 bent portion of lashing rod
376 lashing rod tension clip
378 lashing rod wire tie to keep bent portion of lashing rod upright and neatly stowed away
380 u-shaped termination of lashing rod where holes enable the pivoting portion to adjust to length

### REFERENCE SIGNS LIST-CONTINUED (NUMBERS ARE BOLDED IN DESCRIPTION)

382 removable rods and cotter pins
384 holes (in U-shaped termination of lashing rod)
386 bent portion of pivoting end of lashing rod
388 pivoting end of lashing rod
390 threaded end of lashing rod
392 elongated O-shaped, threaded tightening section (of pivoting end of lashing rod)
394 thickened end of rod (which enables a tightening O-shaped tightening section to pivot while a U-shaped end of a pivoting end of a lashing rod remains in place on the ship's deck)
396 U-shaped portion of pivoting end of lashing rod
398 structural stiffener (for cargo clip)
399 castellations for (cargo clip)
400 cargo clip
402 outline of cell guide end walls of prior art cargo ship hold
404 dashed outline shows a removed cell guide (which provides space for the cargo clip)
406 cell guide to remain in place
408 removed cell guide & old position provides space for cargo clip
410 modified, bent and structurally attached twist lock open & closing arm for hand use
412 arced slot (for modified & bent, structurally attached twist lock open & closing arm for hand use)
414 enlarged twist lock heads ensure positive connection at “shield” opening in series 1 freight container corner casting
416 cut profile opening in cargo clip enables tight fitting twist locks which are welded in place
418 bent edge of cargo clip
420 twist lock flush with series 1 freight container face enables prior art opening & closing arms to remain
422 autonomous cargo clip rail cart

### REFERENCE SIGNS LIST-CONTINUED (NUMBERS ARE BOLDED IN DESCRIPTION)

424 control box (comprising: wireless receiver, microcontroller further comprising: a central processing unit, random access memory, read only memory, internal oscillator, i/o ports, peripheral controller chips, analogue to digital converters, digital to analogue converters, numerous data capture & modules, flash program memory, program code, and more)
426 electric motor for cargo clip rail cart gear box
428 gear box for cargo clip rail cart
430 gusset plate at cargo clip rail cart
432 rail wheelset
434 x-clip
436 modified twist lock head designed to lift 2 series 1 freight containers (when 2x-clips are used)
438 structurally attached x-bracing
439 horizontal structural member
440 structural stiffener for x-clip
442 bent tab (for opening forklift at x-clip)
460 autonomous, wheeled cart (for port-side bundle)
462 guide bumpers (for cargo frame)
464 recess for motion & distance sensor
466 wheel & tire
468 rotating wheel sets
470 structural frame for autonomous cart
472 electric motor for autonomous cart
474 gear box for autonomous cart
476 battery for autonomous cart
478 spreader frame for 4 series 1 freight container cargo frame
480 hydraulic ram
482 elevator pit
484 ellipsoid column guide bumper
486 elevator lift platform
488 safety rail
490 port-side bundle
492 port-side bundle structure

### REFERENCE SIGNS LIST-CONTINUED (NUMBERS ARE BOLDED IN DESCRIPTION)

494 hydraulic elevator
495 column
496 beam
497 brace
498 structural floor platform
500 lobster claw
502 lobster claw dock piling
504 lobster claw clamping rod
505 lobster claw clamping rod recess
506 outer hull of three-hull cargo frame barge
508 inner hull of three-hull cargo frame barge
510 barge bumper
511 ellipsoid outrigger
512 lifting deck for cargo frame barge
514 cargo frame cargo ship structure
516 cargo frame cargo ship hull shown underwater
518 motorized platform
520 cargo frame barge bracing
522 adjustment holes
524 cargo frame barge column
526 extendable and retractable structural outrigger
528 geared rollers
530 rack
532 electric motor and pinion
534 structural guide beam
536 lobster claw thumb
538 lobster claw finger
540 hydraulic piston
542 lobster claw pivot section
544 armature with pivot rod
546 bearings and pin
548 structural flange with pin hole

### REFERENCE SIGNS LIST-CONTINUED (NUMBERS ARE BOLDED IN DESCRIPTION)

600 radiused guide plate
602 electric motor for pivoting rail bogie
604 bearings in radiused configuration
606 orange slice chassis upper portion
608 orange slice chassis lower portion
610 spring and guide rods
612 central structural pin with threaded end
614 locking nut
616 suspension springs
618 rail wheel set
620 side frame
622 main crossbeam
624 guide rollers
626 angled crossbeam bearing plates
628 semi-geared ring
630 gear
632 slot for gear bolt
634 drive gear
636 electric motor and driveshaft
638 radiused slots
640 roller plate
642 semi-geared ring cutout
644 filler steel
646 rail
648 rail tie
650 upper ballast
652 lower ballast
654 earth
656 outline of additional steel
700 electric cable track
702 collapsible braces and bearings
704 structural guide for collapsible braces & bearings beams

### REFERENCE SIGNS LIST-CONTINUED (NUMBERS ARE BOLDED IN DESCRIPTION)

706 retracting, extending roller beams
708 structural outriggers
710 rack
712 hoist cables
714 corner hoist lift mechanism
716 electric motor, and pinion
718 structural rolling plate
720 structural stiffeners (shown dashed)
722 c-shaped structural channel, and roller bearings
724 guide track for c-shaped structural channel
726 hydraulic piston
727 sliding structural arms (for electrically actuated twist locks)
728 electrically actuated twist lock
729 structural mounting plate for electrically actuated twist locks
730 corner guide rail rollers
731 corner guide rail
732 electric motor for cargo frame hoist
734 rolling platform for cargo frame hoist
736 structural arched framing members
738 notch in structural rolling plates for corner hoist lift mechanism to extend to
739 notch in chassis for sliding structural arms for electrically actuated twist locks
740 electric motor and pinion for rolling platform for cargo hoist
742 gear box for cargo frame hoist drive axle
744 beveled gears which drive the corner hoist lift mechanism
748 intermediary geared axle to reverse gear direction so all four corner hoist lift mechanisms lift in same direction
750 drive axle for main cargo frame hoist
752 bearings for cargo frame hoist drive axle
754 pulleys at top of cargo frame hoist column
756 structural side plates for pulleys at cargo frame hoist column
758 counterweight roller axle for cargo frame hoist
760 arched ladder for stevedores (not shown for clarity)
762 drive belts at corner arched cargo frame hoist rolling platform

### REFERENCE SIGNS LIST-CONTINUED (NUMBERS ARE BOLDED IN DESCRIPTION)

764 reserve structural length of sliding structural arms for electrically actuated twist locks
766 gear housing, and motor for electrically actuated twist locks
768 structural guide plate for sliding structural arms
770 structural plates for corner guide rail rollers
772 chassis for corner hoist lift mechanism
774 guide structure for counterweight
778 electric power rail
780 insulated electric power line
782 roller pins in notch in chassis for sliding structural arms for electrically actuated twist locks
784 twist lock rack
786 counterweight spindle and clutch
788 governor
790 spindle
794 adjust to fit slot
796 hoist cable stops

### CLAIMS GLOSSARY

(Specific claim terms are in italics throughout this disclosure. These claim terms represent an overview: for a richer understanding of these consistent terms consult the description and drawings.)

| | |
|---|---|
| autonomous | A cart for conveying series 1 freight containers, and/or cargo |
| rail cart | frames via rail. The cart is mechanized with an electric motor and |
| | wireless control box. The cart is sized so that it does not protrude |
| | beyond the container or cargo frame in plan view such that it |
| | does not consume space beyond that which it carries. |
| | It may utilize an electric third rail, or be battery operated. |
| | The cart may have twist locks in corresponding places to the |
| | containers, or utilize guide bumpers for cargo frames. |
| bundle (ed, ing) | A fully loaded cargo frame. |
| | The act of binding a plurality of cargo together wherein the |
| | bundle can be moved in one action versus the equivalent number |
| | of actions required to move the bound cargoes individually. |
| bulk-cargo (es) | A species of cargo frame which houses a vessel suitable for |
| | cargo frames holding dry-bulk or liquid bulk cargoes |
| cargo frame (s) | A structural frame with means for bundling a plurality of cargo |
| | greater than what is contained in one series 1 freight container to |
| | said structural frame wherein the frame resists gravity, uplift, |
| | lateral, tension, and compression loads. The cargo frame is a |
| | genus. |
| cargo frame | A railroad turntable with two sets of rails to accommodate a |
| turntable (s) | cargo frame outfitted with rail bogies. The two sets of rails are |
| | structurally connected with bracing to ensure the two sets of rails |
| | remain parallel. |
| cargo clip (s) | A species of cargo frame that binds four series 1 freight |
| | containers along a central axis, at each end, and provides a |
| | plurality of slots at the top of the cargo clip for specialized crane |
| | attachments to lift the bundle of cargo. The lifting slots are |
| | separate from the corner castings and together are designed to lift |
| | the equivalent of four fully loaded series 1 freight containers |
| | along with a reasonable margin of safety. |
| control box (es) | An encased receiver which may be wired, and/or wireless, a |
| | microcontroller further comprising: a central processing unit, |
| | random access memory, read only memory, internal oscillator, i/o |
| | ports, peripheral controller chips, analogue to digital converters, |
| | digital to analogue converters, numerous data capture & modules, |
| | flash program memory, program code, and more. |
| | The control box is used to coordinate the movements of the |
| | following, but not limited to: cargo frames, autonomous rail |
| | carts, cargo frame barges, cargo frame cargo ships, hand-held |
| | devices, smart phones, 3-axis hoists, cargo frame towers, cargo |
| | frame turntables, independent three-hull barges and other |
| | apparatus part of the system for cargo transport. |
| encargo (ed, ing) | To load cargo. |
| decargo (ed, ing) | To unload cargo. |
| guide bumper (s) | A structural angled guide which is used to accommodate error |
| | when aligning a cargo frame to an autonomous cart, or an |
| | autonomous cart to a port-side bundle structure, or a semi-truck |
| | bulk-cargo trailer to a bulk-cargo deposit hole. |
| independent | A barge with three independent hulls. The larger, wider center |
| three-hull | hull is where cargoes are carried. The two outer hulls are |
| barge (s) | extendable and retractable. The barge has two states, extended |
| | and retracted, which allow the barge to get close to vessels, |
| | and/or docks, convey cargoes to the center hull and then extend |
| | the hull from retracted state to extended state. In this manner, a |
| | barge can achieve higher stability for heavy loads of cargo where |
| | a single hull would prove less stable. |
| | This barge may be outfitted with columns, bracing, and lobster |
| | claws. |
| lobster claw (s) | An extendable and retractable mechanical arm with two curved |
| | opposing claws which mechanically grip vertically disposed |
| | lobster claw clamping rods or lobster claw dock pilings and |
| | enable a vessel to lock to a dock or other vessel, convey cargoes |
| | to a dock, and/or from one vessel to another and when the time is |
| | appropriate begin loosening the grip of the claws, similar to a |
| | firefighter descending a firefighter's pole, where the loaded |
| | vessel may be lowered into the water to smoothly find its final |
| | displacement. The arm may be structurally attached to an outer |
| | hull of an independent three-hull barge. |
| | There are two currently contemplated scenarios for the |
| | extendable, and retractable mechanical arm: |
| | First, the extendable, and retractable mechanical arm pushes one |
| | vessel apart from the other such that an independent three-hull |
| | barge may transition from a retracted state to an extended state |
| | thereby providing equal stabilization from the opposing outer |
| | hull. The in-use lobster claw may then release as mentioned |
| | above. In this manner, the outer hulls may provide a wider area |
| | of stability but also retract and enable close conveyance of cargo. |
| | This is useful for in-water transfers where the barge does not |
| | have stability from the opposing side of vessel it clamps to. |
| | Second, the extendable and retractable mechanical arms may grip |
| | lobster claw dock pilings on both sides of the independent three- |
| | hull barge for conveyance of cargoes. This is useful for in-water |
| | transfers where the dock does not have a lobster claw clamping |
| | rod at the upper portion of the independent three-hull barge |
| | where a lobster claw may be placed. |
| | Lobster claws are mounted to columns on the independent three- |
| | hull barge and may be manually adjusted vertically with slotted |
| | holes and bolts, or through mechanized means using rack and |
| | pinion, or 3-axis hoists. |
| lobster claw | A vertically disposed structural rod meant to be clamped by a |
| clamping rod (s) | lobster claw. The rod is designed to withstand moment loads, |
| | torsion and other forces related to wave events acting on two |
| | vessels attached to each other in a body of water. |
| | The lobster claw clamping rod may be attached to a vessel, or a |
| | dock piling, quay or other structure capable of withstanding the |
| | forces contemplated. |
| lobster claw dock | A species of lobster claw clamping rods which are structurally |
| piling (s) | attached to the dock piling and form an integral part of the dock |
| | piling. |
| orange slice | A structural chassis for a pivoting rail bogie that has a circular |
| chassis | exterior plan profile and is divided in pie slice-like parts, similar |
| | to an orange slice. These slices are structural and provide areas |
| | for motors and other apparatus. |
| pivoting rail | A rail bogie comprising a control box, a mechanized means for |
| bogie (s) | rotation, a pair of wheelsets and a pivoting means wherein, when |
| | lifting by a 3-axis hoist the rail bogie may pivot to change |
| | direction when conveying in a cargo frame cargo ship or a cargo |
| | frame dock or other situations where a cargo frame turntable is |
| | too large for practicality. |
| plurality | Two or more. |
| semi-truck | A structural tower with hoists and platforms capable of lifting a |
| queueing tower(s) | fully loaded semi-truck. The tower is arranged in a fashion that |
| | flows with traffic and may have two-level connections such that a |
| | ground floor and a second floor may service the tower. This |
| | enables rapid deployment of semi-trucks. The exit for the semi- |
| | trucks is in the same direction as the semi-truck entered, thereby |
| | eliminating the space required to back up. |
| | The tower may have a rest and recreation floor including but not |
| | limited to: a café, a convenience store, a bathroom, a medical |
| | professional, a game room, a reading area, a work-out area, a |
| | dental professional, a laundromat, and a massage therapist. |
| x-clip(s) | A species of cargo frame that binds two series 1 freight |
| | containers, at each end, and provides a plurality of slots at the top |
| | of the x-clip for specialized crane attachments to lift the bundle of |
| | cargo. Having an “x” shape in elevation view and outfitted with |
| | lifting slots that are separate from the corner castings of the |
| | containers and together are designed to withstand the equivalent |
| | of two fully loaded series 1 freight containers along with a |
| | reasonable margin of safety. |
| 3-axis hoist (s) | A means to lift or descend cargo frames in the z-axis in a 3-axis |
| | hoist structure. |
| | Starting at the top the hoist utilizes a central motorized axle that |
| | drives four corner hoist lift mechanisms. Pulleys and gears are |
| | used to transfer the axle rotation to the corners of the 3-axis hoist |
| | structure so that a cargo frame may be moved from one level to |
| | the another. The corner hoist lift mechanism utilizes a motion, |
| | optical, and distance sensor to communicate with the motorized |
| | axle so that the motor stops at the appropriate bay in the 3-axis |
| | hoist. Then the corner hoist lift mechanism deploys the twist lock |
| | rack to engage the corner twist lock rack slots. |
| | Once engaged and locked the hoist continues with its instructions |
| | to move up or down in a given column bay. |
| 3-axis hoist | A structure that enables 3-axis movements of cargo frames. |
| structure | It comprises structural beams, columns, collapsible beams, rack |
| | and pinion, an orthogonal layout of two sets or rails. |
| | The x and y axis movements are achieved by the motorized rail |
| | bogies of the cargo frame. Batteries may be onboard the cargo |
| | frame, or an electric third rail may be employed for power |
| | requirements. |
| | If it is desired to change from the x to the y, or vice versa |
| | direction, a corner hoist lift mechanism engages, locks and lifts a |
| | cargo frame up off the rails, and the pivoting rail bogies turn to |
| | the desired axis. |
| | These instructions may be set in pre-coded software or a |
| | stevedore may direct the cargo frame. Both the cargo frame and |
| | corner hoist lift mechanism communicate via a control box on |
| | each device. |

### CITATION LIST

following is a tabulation of some prior art that presently appears relevant.

| | | | |
|---|---|---|---|
| | Kind | Issue | |
| Patent Number | Code | Date | Patentee |

U.S. Patents
(Cargo Frames)

| | | | |
|---|---|---|---|
| U.S. Pat. No. 9,637,305 | B2 | 2017 May 2 | Fredette et al. |
| U.S. Pat. No. 9,359,129 | B1 | 2016 Jun. 7 | Royt |
| U.S. Pat. No. 6,363,586 | B1 | 2002 Apr. 2 | Neufingerl |

(Cranes, Barges & Ships)

| | | | |
|---|---|---|---|
| U.S. Pat. No. 9,359,047 | B2 | 2016 Jun. 7 | Steven et al. |
| U.S. Pat. No. 10,308,327 | B1 | 2019 Jun. 4 | Van Loon et al. |
| U.S. Pat. No. 5,8332,856 | | 1998 Nov. 10 | Giles |
| U.S. Pat. No. 6,537,009 | B1 | 2003 Mar. 25 | Le Lan et al. |
| U.S. Pat. No. 7,665,945 | B2 | 2010 Feb. 23 | Di Rosa |
| U.S. Pat. No. 7,686,558 | B2 | 2010 Mar. 30 | Tian et al. |
| U.S. Pat. No. 7,004,707 | B2 | 2006 Feb. 28 | Suksi |
| U.S. Pat. No. 8,523,490 | B2 | 2013 Sep. 3 | Wilkinson, Jr. |

(Cargo Hoist)

| | | | |
|---|---|---|---|
| U.S. Pat. No. 11,273,984 | B2 | 2022 Mar. 15 | Heide et al. |
| U.S. Pat. No. 10,913,641 | B2 | 2021 Feb. 9 | Gravelle et al. |
| U.S. Pat. No. 5,707,199 | | 1998 Jan. 13 | Faller |
| U.S. Pat. No. 7,729,797 | B2 | 2010 Jun. 1 | Akamatsu et al. |
| U.S. Pat. No. 10,597,229 | B2 | 2020 Mar. 24 | Pedrazzini |
| U.S. Pat. No. 10,926,950 | B2 | 2021 Feb. 23 | Goetz |
| U.S. Pat. No. 9,181,067 | B1 | 2015 Nov. 15 | Nyren et al. |
| U.S. Pat. No. 2,456,104 | | 1948 Dec. 14 | Andersen |

U.S. Patent Application Publications
(Cargo Frames)

| | | | |
|---|---|---|---|
| US 2021/0380339 | A1 | 2021 Dec. 4 | Austrheim et al. |
| US 2021/0339943 | A1 | 2021 Nov. 4 | Austrheim |
| U.S. Pat. No. 4,599,829 | | 1986 Jul. 15 | DiMartino, Sr. |
| US 2010/0116932 | A1 | 2010 May 13 | Helou, Jr. |

(Cranes, Barges & Ships)

| | | | |
|---|---|---|---|
| US 2006/0104748 | A1 | 2006 May 18 | Jeong |
| US 2008/0213067 | A1 | 2008 Sep. 4 | Jegers |

(Cargo Hoist)

| | | | |
|---|---|---|---|
| US 2022/0041374 | A1 | 2022 Feb. 10 | Schauer et al. |
| U.S. Pat. No. 6,276,550 | B1 | 2001 Aug. 21 | Cherrington |

Foreign Patent Documents

| | | | |
|---|---|---|---|
| | Kind | | App or |
| Foreign Doc. Num. | Code | Issue Date | Patentee |

(Cargo frames)

| | | | |
|---|---|---|---|
| WO 2011/094835 | A1 | 2011 Aug. 11 | Wiebe |
| CN 112027378 | A | 2020 Dec. 4 | [symbol] et al. |
| DE 2154274 | A1 | 1980 Sep. 25 | Giese |

(Cranes, Barges & Ships)

| | | | |
|---|---|---|---|
| WO 2017/015385 | A1 | 2014 Jan. 30 | Condon |
| WO 01/54968 | A1 | 2001 Aug. 2 | Landa |
| CN 107776829 | A | 2018 Mar. 9 | [symbol] |
| CN 207617921 | U | 2018 Jul. 17 | [symbol] |
| CN 113525601 | A | 2021 Oct. 22 | [symbol] et al. |
| CN 108466676 | A | 2018 Aug. 31 | [symbol] et al. |
| CN 111252693 | A | 2020 Jun. 9 | [symbol] et al. |
| WO 2022/069087 | A1 | 2022 Apr. 7 | Praest |

(Cargo Hoist)

| | | | |
|---|---|---|---|
| WO 98/35891 | | 1998 Aug. 20 | Carder et al. |
| WO 2021/148657 | A1 | 2021 Jul. 29 | Benfold et al. |
| EP 0 898 033 | B1 | 2003 Jun. 11 | Nussbaum |

### Nonpatent Literature Documents

(Cargo frames)
https://www.vsnb.com/container-twist-lock
https://www.claimsjournal.com/news/international/2021/04/27/303404.htm

### (Cranes, Barges & Ships)

Tom Bebbington, Nov. 9, 2017, “50,000 TEU . . . the Future or Not?” https://www.maritime-executive.com/editorials/50000-teu-the-future-or-not
https://www.maritime-executive.com/article/video-china-s-first-24-000-teu-containership-delivered-to-evergreen
https://www.wsj.com/articles/suez-canal-traffic-resumes-slowly-as-some-ships-weigh-anchor-others-wait-11617100102
Levinson, Marc, The Box: How the Shipping Container Made the World Smaller and the World Economy Bigger, (Princeton, NJ), pp. 68, 191.
https://www.wsj.com/articles/with-container-ships-getting-bigger-maersk-focuses-on-getting-faster-11545301800
https://www.cnbc.com/2021/12/04/how-amazon-beats-supply-chain-chaos-with-ships-and-long-haul-planes.html
https://theconversation.com/mystery-of-the-cargo-ships-that-sink-when-their-cargo-suddenly-liquefies-101158 https://www.nber.org/system/files/working_papers/w23581/w23581.pdf

### (Cargo Hoist)

https://morallift.en.made-in-china.com/product/dMZQpyYPfjak/China-Vertical-3-Axis-Movement-Man-Lift.html

### (Autonomous Vehicles)

https://autonomous-driving.org/2019/01/25/positioning-sensors-for-autonomous-vehicles/

### (General Trade)

https://ustr.gov/countries-regions/china-mongolia-taiwan/peoples-republic-china

### (Lashing Rods)

https://www.youtube.com/watch?v=jlF5fJKcigQ

### (Ports)

https://www.cbsnews.com/losangeles/news/long-beach-eases-rules-on-container-stacking-to-ease-the-backlog-of-cargo-ships-waiting-to-unload/
Notteboom, Theo and Pallis, Athanasios and Rodrigue, Jean-Paul (2022). Port Economics, Management and Policy, Abingdon, United Kingdom: Routledge, pp. 119.
https://www.bloomberg.com/news/articles/2021-09-23/containers-piling-up-at-u-s-rail-yards-add-to-port-strains
https://www.seanews.com.tr/24-000-teu-boxships-would-weigh-heavily-on-infrastructure-costs/136140/https://www.ars.usda.gov/research/publications/publication/?seqNo115=328459
https://kentico.portoflosangeles.org/getmedia/07e1377d-b452-4ecb-a629-9a0c69410805/pola-facilities-map
https://www.freightwaves.com/news/city-of-long-beach-allows-logistics-companies-to-stack-containers-higher
https://www.reuters.com/business/autos-transportation/railroad-cargo-backups-threaten-new-logjam-los-angeles-port-chief-2022-07-13/(Freight trains)
https://onlinepubs.trb.org/onlinepubs/trnews/trnews246.pdf

1-171. (canceled)

172. A system for cargo transport comprising:
a plurality of mobile intermodal cargo frames wherein each comprises a structural frame sized to stow a plurality of series 1 freight containers fully loaded to their maximum rated weight, and including a healthy factor of safety, wherein when stacked each said container having a weight is substantially isolated with the frame, and wherein the weight of upper containers is substantially isolated from lower containers and the upper container corner castings do not substantially bear the loads of the lower containers when lifted;
at least one set of twist lock rack slots comprising the structural frame having at least two twist lock rack slots at an upper portion and a lower portion of said structural frame comprising the slots having a close linear spacing of about 1 to 12 inches between each of said plurality of twist lock rack slots, wherein a balance of weight from the plurality of series 1 freight containers may be lifted in the frame, as opposed to the corner castings of each said container themselves;
a plurality of rail bogies wherein each comprises a pivot point, wherein arranged in this manner, a pivoting rail bogie is formed, and wherein arranged in this manner, a mobile intermodal cargo frame is formed;
a plurality of 3-axis hoists, wherein each comprise:
a hoist that has an integral connection to at least one conveyance shaft in said 3-axis hoist structures and lifts from the periphery thereof, wherein said hoist may traverse from said conveyance shaft to a second conveyance shaft, when viewed in plan view;
a plurality of corner hoist lift mechanisms wherein each comprises a plurality of roller guides that stabilize vertical movement of said corner hoist lift mechanism in a quadrant of a 3-axis column for conveying cargoes,
wherein arranged in this manner, a corner hoist lift mechanism is formed,
wherein said hoist lifts one of said cargo frames from the corners of each said conveyance shaft with a portion of the corner hoist lift mechanisms, such that the cargo frames may exit the shaft at a predetermined level, and
wherein arranged in this manner, a 3-axis hoist is formed;
a plurality of 3-axis hoist structures wherein each comprises a plurality of 3-axis columns wherein each comprises a plus shape with transverse ends, where it could be said the column appears to have merged two wide flange columns, leaving four quadrants with open corners, where said column with open corners is used to enable at least one of said 3-axis hoists to operate a corner hoist lift mechanism,
wherein said quadrants have a plurality of corner guide rails,
wherein arranged as such, a 3-axis column is formed;
a plurality of 3-axis beams, wherein each further comprise a structural beam having a pair of ends wherein each forms a portion of a reentrant corner when a 3-axis hoist structure is fully assembled, wherein when connected to a 3-axis column said beam shape does not interfere with a notch occurring at said end, wherein enabling an extended corner hoist lift mechanism to traverse in the z-axis without interference;
a plurality of mechanized structural sliding wherein each comprises:
a rack;
a plurality of roller pins, wherein said pins may roll on a top side of a rolling plate having a plurality of guide rails;
a mechanized structural roller beam having a top side wherein the rack is mounted to one of said 3-axis beams enabling the rolling pinion of retractable, extendable rolling beams to operate,
wherein said structural beam has a guide slot corresponding to a guide mounted to the rolling plate, and
wherein said plurality of roller pins are prevented from rolling off said rolling plate;
a hydraulic piston that moves said mechanized structural roller beam along a rolling plate,
wherein said plurality of 3-axis columns are structurally affixed to said plurality of 3-axis beams forming an orthogonal structure sized, shaped, adapted and spaced to enable said cargo frames to traverse in the x, y, and z axes, and wherein arranged in this manner, a 3-axis hoist structure is formed;
at least one cargo frame cargo ship comprising:
at least one of said 3-axis hoist structures; and
a plurality of openings that substantially utilize at least one side of a vessel, allowing for internal vessel structural elements, that match an external cargo conveyance platform of other apparatus, such that said internal vessel structural elements and a plurality of structural elements of said platform are in alignment, wherein arranged in this manner, a cargo frame cargo ship is formed;
at least one cargo frame dock comprising;
a cargo conveyance platform;
a plurality of dock pilings to support said platform having a spacing at predetermined intervals to withstand wind, cargo movements, and vessel docking, wherein support the plurality of dock pilings allows the platform to remain affixed to both the earth below sea, and earth on shore such that the platform may safely convey cargoes as intended;
a plurality of lobster claw clamping rods formed as cylindrical steel rods, each structurally mounted to one of said plurality of dock pilings for releasably attaching to a vessel equipped with a plurality of mating lobster claws that match the predetermined intervals of said plurality of dock pilings further forming a matching bay between each said plurality of dock pilings,
wherein said vessel may temporarily dock in a rigid state that enables both loading, and unloading of cargo frames at each said matching bay, and
wherein arranged in this manner, a cargo frame dock is formed;
a plurality of cargo frame barges wherein each comprises:
a plurality of structural columns protruding from a deck in a regular linear arrangement forming a plurality of bays that match structure on other cargo conveyance platforms; and
at least one structural armature with a pivot point mounted to a structural outrigger that aligns with a matching structure such that a mating relationship is established, wherein arranged in this manner, a pivoting lobster claw armature is formed,
wherein arranged in this manner, a cargo frame barge is formed;
a plurality of rail freight carts wherein each comprises at least one pair of parallel rail bogies reduced in size to have a lower elevation view profile than a standard rail bogie, and separated by a distance that run on a pair of parallel rail tracks similarly spaced, wherein arranged in this manner, a rail freight cart is formed;
a guide bumper for preventing semi-truck truck tires from falling into a bulk drop opening comprising a structural guide bumper formed on a floor wherein bulk cargo is dropped from, preventing semi-truck tires from driving into a bulk drop opening, wherein arranged in this manner, a guide bumper is formed;
a plurality of wireless control bollard and signal light wherein each comprises:
a bollard;
a control box; and
a signal light,
wherein arranged in this manner, a wireless control bollard and signal light is formed;
a plurality of strengthened railroad rails wherein each comprises a railroad rail having a wider base flange than a railroad rail base flange as required to enhance the strength and bearing capacity of said railroad rail, wherein arranged in this manner, a strengthened railroad rail is formed;
at least one set of two pairs of parallel rails and supporting frame comprising a structural frame supporting said set of two pairs of parallel rails connected to the earth that conforms to terrain and keeps the two pairs of rails as horizontal as safe rail freight movement requires, wherein arranged in this manner, a set of two pairs of parallel rails and supporting frame is formed;
at least one multi-floor semi-truck queueing tower having a plurality of bays on each said floor wherein semi-trucks may be slotted and stored temporarily and is served by at least one semi-truck elevator that has access to at least two floors, wherein arranged in this manner, a multi-floor semi-truck queueing tower is formed;
a plurality of semi-truck transshipment yards, wherein each comprises:
a semi-truck lane;
at least one pair of rails; and
a floor capable of supporting a plurality of semi-trucks and their cargoes when fully loaded to their maximum rated weight, and including a healthy factor of safety,
wherein both said semi-truck lane, and said at least one pair of rails are located on, and structurally supported by said floor,
wherein a plan view orientation of said at least one pair of rails are arranged to be served from at least one of said 3-axis hoist structures at said floor to offload a plurality of series 1 freight containers on a portion of said rail carts from one of said cargo frames having a plurality of bays,
wherein said at least one pair of rails merge, where more than one pair occurs, to a single second pair of rails that serves said semi-truck lane wherein said plurality of series 1 freight containers on the rail carts may each convey their cargoes to a semi-truck, and vice versa, and wherein at this location a semi-truck bay is formed, and
wherein arranged in this manner, and when taken in full view, said plan view orientation of said semi-truck lane, said at least one of pair of rails, said semi-truck bay, and said floor form a semi-truck transshipment yard;
at least one freight car transshipment yard, wherein each comprises:
at least one set of feeder rails for conveying rail carts and, having no limit to the number of feeder rails in number;
a first plurality of freight car rail sets which connect to at least one set of access rails from outside a port which convey freight trains and their cargoes, wherein said first plurality of freight car rail sets branch off from said at least one set of access rails enabling freight well cars to queue and align with spreaders that convey freight both from, and to rail carts;
a second plurality of freight car rail sets branch off from said at least one set of feeder rails and align alongside said first plurality of freight car rail sets so that spreaders may convey both from, and to freight well cars;
at least one structural frame that provides clearance for freight well cars and rails carts so that cargoes may be safely transferred;
at least one spreader mounted and spaced to said structural frame such that they may convey cargoes from freight well cars to rail carts, and vice versa in a convenient, efficient manner; and
at least one set of return rails for conveying rail carts, and cargoes, having Ser. No. limit to the number of return rails in number,
wherein when said at least one set of return rails consolidate said second plurality of freight car rail sets in a length that enables a batch of rail carts to fully queue without disturbing, or preventing a following batch of rail carts to approach respective said at least one spreader, when said at least one set of feeder rails, said first plurality of freight car rail sets, said second plurality of freight car rail sets, said at least one structural frame that, said at least one spreader, said at least one set of return rails are fully assembled a freight car transshipment yard is formed;
a plurality of cargo frame turntables, wherein each comprises a pair of parallel bridges each supporting a pair of rails with structural bracing between the bridges, wherein arranged in this manner, a cargo frame turntable is formed;
a plurality of bulk siloes wherein each are respectively in combination with one of said 3-axis hoist structures and one of said 3-axis hoists; and
at least one computer that communicates with at least a portion of the above listed apparatus,
wherein arranged as such, a system for cargo transport is formed.

173. The system for cargo transport of claim 172, further comprising a multi-floor port comprising a plurality of floors arranged with at least one architectural organizational axis.

174. The system for cargo transport of claim 172, in further combination with a plurality of series 1 freight containers.

175. The system for cargo transport of claim 172, in combination with a port.

176. The system for cargo transport of claim 175, in further combination with a cargo ship comprising a plurality of cell guides sized, shaped and adapted to accept bundles of series 1 freight containers with end clips to be lowered and stowed in such a way that an unmodified cell guide would not accept said end clip as the cell guide was not designed to accept end clips.

177. The system for cargo transport of claim 175, in further combination with a plurality of ends clips wherein each comprises a structural frame that isolates its portion of a weight of a plurality of series 1 freight containers when each are fully loaded to a maximum rated weight, and including a healthy factor of safety within the frame and is sized, shaped, and adapted to not adversely affect stacking both vertically, and adjacently, wherein, they may be lowered into a ship's hold having cell guides, where at least some cells guides have been modified to accept the structural frame.

178. The system for cargo transport of claim 177, in further combination with a spreader for lifting freight containers comprising:
from a plan view perspective, the spreader is sized and adapted to not interfere with lowering a plurality of series 1 freight containers fully loaded to their maximum rated weight, and including a healthy factor of safety and bound by a pair of end clips into a cargo container ship hold wherein cell guides are further adapted to accept said end clips without snagging;
a plurality of enlarged twist locks engineered to safely lift a portion of said containers, such that the end clips have matching twist lock slots and work in unison, and
wherein the spreader having two opposing ends is longer than said freight containers and said plurality of enlarged twist locks are located near said opposing ends such that lifting capability is directed to the end clips.

179. The system for cargo transport of claim 178, in further combination with an improved shipping container gantry crane comprising:
at least one engineered foundation capable of withstanding the structural forces caused by lifting a set of at least three series 1 freight containers fully loaded to their maximum rated weight, plus a healthy factor of safety;
a structural frame engineered to withstand the structural forces caused by lifting a set of at least three series 1 freight containers fully loaded to their maximum rated weight, plus a healthy factor of safety; and
a set of cables and pulleys rated to lift a set of at least three series 1 freight containers fully loaded to their maximum rated weight, plus a healthy factor of safety.

180. A system for cargo transport comprising:
a plurality of mobile intermodal cargo frames wherein each comprises a structural frame sized to stow a plurality of series 1 freight containers fully loaded to their maximum rated weight, and including a healthy factor of safety, such that when stacked each said container having a weight is substantially isolated with the frame, wherein the weight of upper containers is substantially isolated from lower containers and the upper container corner castings do not substantially bear the loads of the lower containers when lifted;
means for lifting a portion of weight from the plurality of series 1 freight containers in the frame, as opposed to the corner castings themselves;
means for conveyance attached to said structural frame such that x axis and y axis movements are made possible,
wherein in this arrangement, a mobile intermodal cargo frame is formed;
a plurality of 3-axis hoists, wherein each comprise:
at least one 3-axis hoist mounted to a 3-axis hoist structure and is sized, shaped and adapted to suitably hoist said cargo frames;
means for transmitting rotational motion to a corresponding corner hoist lift mechanism at the periphery of a hoist shaft,
wherein when said means for transmitting rotational motion rotates left and right said corner hoist lift mechanism correspondingly moves up or down, or vice versa, said means is integrally connected to said hoist shaft;
a plurality of corner hoist lift mechanisms, wherein each comprises:
a structural chassis;
means for securing hoist cables to said structural chassis so they do not slip or become disconnected;
means for stabilizing vertical movement of said structural chassis in a quadrant of a 3-axis column for conveying cargoes;
means for securing a corner hoist lift mechanism to a freight conveyance device that may be used for both lifting and lowering; and
a control box having a plurality of sets of instructions, a plurality of retrievable stored locations,
wherein in this manner, a corner hoist lift mechanism is formed, arranged in this manner, a 3-axis hoist is formed;
a plurality of 3-axis hoist structures sized and adapted to suitably convey cargo frames wherein each comprises:
a plurality of 3-axis columns having a means for z-axis movements of a freight conveyance device;
a plurality of 3-axis beams having a means for both x-axis, and y-axis movements of a freight conveyance device;
a plurality of retractable, extendable mechanized roller beams mounted to said plurality of 3-axis beams;
means for supporting said plurality of retractable, extendable mechanized roller beams,
wherein said plurality of 3-axis columns are structurally affixed to said plurality of 3-axis beams forming an orthogonal structure sized, shaped, spaced and adapted and to enable freight conveyance devices to traverse in the x, y, and z axes;
at least one of said 3-axis hoists,
wherein arranged in this manner, a 3-axis hoist structure is formed;
at least one cargo frame cargo ship comprising:
a cargo ship;
means for releasable attachment structure arranged along, and substantially covering at least one side of said cargo ship that match releasable attaching structures of other vessels, wherein said cargo ship and a second vessel are locked together, as opposed being tied together;
a plurality of openings that substantially cover at least one side of said cargo ship, allowing for internal structural elements of said cargo ship, that each match a cargo conveyance platform of said second vessel; and
at least one of said 3-axis hoist structures sized and adapted to suitably convey cargo frames and mounted in said cargo ship,
wherein arranged as such, a cargo frame cargo ship is formed;
at least one cargo frame dock wherein each comprises:
means for structural support of cargo conveyance having a spacing at predetermined intervals to withstand wind, cargo movements, and vessel docking,
wherein to remain affixed to both the earth below sea, and earth on shore such that a platform may safely convey cargoes as intended;
a plurality of means for releasably attaching to a vessel equipped with a mating plurality of releasable attachment means that match the predetermined intervals of said plurality of means for structural support of said platform further forming a matching bay between each said plurality of means for structural support of said platform,
wherein both said plurality of means for structural support of said platform and said vessel may temporarily dock in a rigid state that enables both loading, and unloading of mobile, cargo frames at each said matching bay;
at least one of said 3-axis hoists;
at least one of said 3-axis hoist structures,
wherein arranged in this manner, a cargo frame dock is formed;
a plurality of cargo frame barges, wherein each comprise:
a hull;
a plurality of columns mounted to said hull in a regular linear arrangement forming a plurality of bays wherein each are sized, spaced and adapted to stow one of said cargo frames;
at least one structural armature with a means for pivoting mounted to a structural outrigger;
said means for pivoting enables said armature to mechanically align with a matching structure on a separate apparatus;
means for releasably attaching to said plurality of columns is mounted to said structural armature;
means for conveyance of said plurality of cargo frames on, off and about each said hull,
wherein arranged in this manner, a cargo frame barge is formed;
a plurality of rail freight carts, wherein each comprises at least one pair of parallel rail bogies reduced in size to have a lower elevation view profile than a standard rail bogie, and separated by a distance that run on a pair of parallel rail tracks similarly spaced, wherein arranged in this manner, a rail freight cart is formed;
at least one guide bumper for preventing semi-truck truck tires from falling into a bulk drop opening comprising a structural guide bumper formed on a level wherein bulk cargo is dropped from, preventing semi-truck tires from driving into a bulk drop opening, wherein arranged in this manner, a guide bumper is formed;
a plurality of wireless control bollard and signal light wherein each comprises:
a bollard;
a control box; and
a signal light,
wherein arranged in this manner, a wireless control bollard and signal light is formed;
a plurality of strengthened railroad rails wherein each comprises a railroad rail having a wider base flange than a railroad rail base flange as required to enhance the strength and bearing capacity of said railroad rail, wherein arranged in this manner, a strengthened railroad rail is formed;
at least one set of two pairs of parallel rails and supporting frame comprising means for supporting a set of two pairs of parallel rails connected to the earth that conforms to terrain and keeps the two pairs of rails as horizontal as safe rail freight movement requires, wherein arranged in this manner, a set of two pairs of parallel rails and supporting frame is formed;
at least one multi-floor semi-truck queueing tower having a plurality of bays on each said floor wherein semi-trucks may be slotted and stored temporarily and is served by at least one semi-truck elevator that has access to at least two floors, wherein arranged in this manner, a multi-floor semi-truck queueing tower is formed;
a plurality of semi-truck transshipment yards wherein each comprises:
a semi-truck lane;
at least one pair of rails; and
a floor capable of supporting a plurality of semi-trucks and their cargoes when fully loaded to their maximum rated weight, and including a healthy factor of safety,
wherein both said semi-truck lane, and said at least one pair of rails are located on, and structurally supported by said floor,
wherein a plan view orientation of said at least one pair of rails are arranged to be served from at least one of said 3-axis hoist structures at said floor to offload a plurality of series 1 freight containers on a portion of said rail carts from one of said cargo frames having a plurality of bays, wherein said at least one pair of rails merge, where more than one pair occurs, to a single second pair of rails that serves said semi-truck lane wherein said plurality of series 1 freight containers on the rail carts may each convey their cargoes to a semi-truck, and vice versa, and wherein at this location a semi-truck bay is formed, and
wherein arranged in this manner, and when taken in full view, said plan view orientation of said semi-truck lane, said at least one of pair of rails, said semi-truck bay, and said floor form a semi-truck transshipment yard;
at least one freight car transshipment yard, wherein each comprises:
at least one set of feeder rails for conveying rail carts and, having no limit to the number of feeder rails in number;
a first plurality of freight car rail sets which connect to at least one set of access rails from outside a port which convey freight trains and their cargoes;
wherein said first plurality of freight car rail sets branch off from said at least one set of access rails enabling freight well cars to queue and align with spreaders that convey freight both from, and to rail carts;
a second plurality of freight car rail sets branch off from said at least one set of feeder rails and align alongside said first plurality of freight car rail sets so that spreaders may convey both from, and to freight well cars;
at least one structural frame that provides clearance for freight well cars and rails carts so that cargoes may be safely transferred;
at least one spreader mounted and spaced to said structural frame such that they may convey cargoes from freight well cars to rail carts, and vice versa in a convenient, efficient manner; and
at least one set of return rails for conveying rail carts, and cargoes, having no limit to the number of return rails in number,
wherein when said at least one set of return rails consolidate said second plurality of freight car rail sets in a length that enables a batch of rail carts to fully queue without disturbing, or preventing a following batch of rail carts to approach respective said at least one spreader, when said at least one set of feeder rails, said first plurality of freight car rail sets, said second plurality of freight car rail sets, said at least one structural frame that, said at least one spreader, said at least one set of return rails are fully assembled a freight car transshipment yard is formed;
a plurality of a cargo frame turntables comprising a pair of parallel bridges each supporting a pair of rails with structural bracing between the bridges, wherein arranged in this manner, a cargo frame turntable is formed;
a plurality of bulk siloes wherein each are respectively in combination with one of said 3-axis hoist structures and one of said 3-axis hoists; and
at least one computer that communicates with at least a portion of the above listed apparatus,
wherein arranged thusly, a system for cargo transport is formed.

181. The system for cargo transport of claim 180, further comprising a multi-floor port comprising a plurality of floors arranged with at least one architectural organizational axis.

182. The system for cargo transport of claim 180, in further combination with a plurality of series 1 freight containers.

183. The system for cargo transport of claim 180, in combination with a port.

184. The system for cargo transport of claim 183, in further combination with a cargo ship comprising a plurality of cell guides sized, shaped and adapted to accept bundles of series 1 freight containers with end clips to be lowered and stowed in such a way that an unmodified cell guide would not accept said end clip as the cell guide was not designed to accept end clips.

185. The system for cargo transport of claim 183, in further combination with a plurality of mobile intermodal ends clips, wherein each comprises:
a structural frame having a profile that does not protrude beyond a plurality of ends of a plurality of series 1 freight containers in elevation view such that when stacking adjacently the frame does not protrude or hinder close stacking;
means for isolating the weight of a plurality of series 1 freight containers attached to said structural frame; and
means for lifting the frame's portion of said plurality of series 1 freight containers when each are fully loaded to their maximum rated weight, and including a healthy factor of safety, attached to said frame,
wherein the frame is sized and adapted to fit when lowered in a cargo container ship wherein the cell guides have been modified to accept the end clip.

186. The system for cargo transport of claim 185, in further combination with a spreader for lifting freight container comprising:
wherein from a plan view perspective, the spreader is sized and adapted to not interfere with lowering a plurality of series 1 freight containers fully loaded to their maximum rated weight, and including a healthy factor of safety and bound by a pair of end clips into a cargo container ship hold wherein cell guides are further adapted to accept said end clips without snagging;
a plurality of enlarged twist locks engineered to safely lift a portion of said containers, wherein the end clips have matching twist lock slots and work in unison,
wherein the spreader having two opposing ends is longer than said freight containers and said plurality of enlarged twist locks are located near said opposing ends such that lifting capability is directed to the end clips.

187. The system for cargo transport of claim 186, in further combination with an improved shipping container gantry crane comprising:
at least one engineered foundation capable of withstanding the structural forces caused by lifting a set of at least three series 1 freight containers fully loaded to their maximum rated weight, plus a healthy factor of safety;
a structural frame engineered to withstand the structural forces caused by lifting a set of at least three series 1 freight containers fully loaded to their maximum rated weight, plus a healthy factor of safety; and
a set of cables and pulleys rated to lift a set of at least three series 1 freight containers fully loaded to their maximum rated weight, plus a healthy factor of safety.
